(19) United States
(12) Patent Application Publication
(10) Pub. No.: US 2026/0143313 A1
(43) Pub. Date: May 21, 2026

(54) METHOD, APPARATUS, AND SYSTEM FOR SEMANTIC COMMUNICATIONS

(71) Applicant: Huawei Technologies Co., Ltd., Shenzhen (CN)

(72) Inventors: Mengyao Ma, Shenzhen (CN); Yiqun Ge, Ottawa (CA); Jianglei Ma, Ottawa (CA); Qifan Zhang, Kanata (CA)

(21) Appl. No.: 19/427,564

(22) Filed: Dec. 19, 2025

Related U.S. Application Data
(63) Continuation of application No. PCT/CN2023/128880, filed on Oct. 31, 2023.
(60) Provisional application No. 63/509,400, filed on Jun. 21, 2023.

(51) Int. Cl. H04W 4/38; H04W 48/14

(52) U.S. Cl. CPC H04W 4/38; H04W 48/14

(57) ABSTRACT

Provided are sensing communication method, apparatus, and system. An apparatus such as a central device can broadcast or multi-cast or unicast query message(s), so that other apparatus(es) such as one or more sensing devices can obtain the query message(s) and respond with sensing result(s) in response to the obtained query message(s). Query may be conducted for one or more rounds. In a round, the query messages can be of different levels, and as a result, more flexible and detailed query would be achieved. Moreover, query may be conducted for several rounds, and the apparatus may broadcast or multi-cast or unicast query messages of different levels in several rounds, so that other apparatus(es) can respond with sensing result(s) in response to the obtained query messages in several rounds, where a low level/coarse level query message is for initial query, and a high level query message is for subsequent fine grained query.

### CROSS-REFERENCE TO RELATED APPLICATIONS

This application is a continuation of International Application No. PCT/CN2023/128880, filed on Oct. 31, 2023, which claims priority to U.S. Provisional Patent Application No. 63/509,400, filed on Jun. 21, 2023, applications of which are hereby incorporated by reference in their entireties.

### TECHNICAL FIELD

The present disclosure relates generally to the field of sensing communication technologies and, in particular, to a sensing communication method, apparatus, and system.

### BACKGROUND

A sensing function will be integrated into the 6th generation (6G) system. A large number of the sensing user equipments (UEs) or sensing devices will be densely deployed in cities, factories, farms and so on. In addition to mobile phones, sensing devices will become an important type of UEs or devices that claim an arrival of IoT time.

Like internet searching engines, 6G will come up with the counterpart, an internet of thing (IoT) searching engine, in a true physical world. In fact, billions of IoT-based applications such as driverless cars, automation factories, smart cities, and autonomous farms, will heavily depend on an efficient and real-time searching engine in our physical world.

Recently, artificial intelligence (AI) has conquered various intellectual and cognitive domains. Some AI is exploring the cutting edge of our intellectual knowledge in chemistry, gaming, mathematic, gene engineering. Some other AI is providing a human-level Q&A platform in the digital world; the domain that AI hasn't conquered is real-time physical world. Physical-world AI, in which AI technologies are to penetrate into all the aspects of our society and life, may be built on omnipresent IoT connections thanks to 6G.

More challenging than internet searching engine, real-world searching engine would have to search the physical world in real time over a large scale of physical areas and to deal with a multitude of types of data and information (some may be novel and some may not have been invented yet). Furthermore, green technology, low-energy and low-emission, are also raised as key feature of 6G. A sensing device may be battery powered and/or completely powered by solar and wind. It would be costly and impracticable to ask all the sensing devices in a large scale to feedback what they are sensing at the same time. On one hand, the frequent sensing and transmission consumes a sensing device much energy and reduce their battery life time; on other hand, such a high density of the IoT deployment may block the uplink channels, especially the uplink (UL) bandwidth is more expensive than the downlink (DL) one.

This background information is provided to reveal information believed by the applicant to be of possible relevance to the present disclosure. No admission is necessarily intended, nor should be construed, that any of the preceding information constitutes prior art against the present disclosure.

### SUMMARY

In a first aspect, the present disclosure provides a sensing communication method, where the method includes:
obtaining at least one first query message based on at least one first level, where each of the at least one first query message corresponds to one of the at least one first level; and
sending a first sensing result, where the first sensing result includes at least one piece of first sensed data and/or at least one first sensing semantic.

Because the at least one first query message is obtained based on the at least one first level, more flexible and detailed query would be achieved.

In a possible implementation of the first aspect, there is a correspondence between each of the at least one first level and a first piece of query message length information respectively, where the first piece of query message length information includes at least one of a first query message length or a first compression ratio of query message.

Because there is a correspondence between the levels and the pieces of query message length information, which may include the query message length and/or the compression ratio of query message, the query message could be obtained based on its respective piece of query message length information, in particular, its corresponding length and/or compression ratio, thereby increasing the flexibility of obtaining the query message and expanding the range of application.

In a possible implementation of the first aspect, the correspondence between levels and pieces of query message length information is stored in a table.

In a possible implementation of the first aspect, the correspondence is predefined in a protocol or is obtained from a second apparatus.

Because there is the table storing the correspondence between levels and pieces of query message length information, which is predefined in the protocol or is obtained from an apparatus, it would be convenient to obtain the correspondence between levels and pieces of query message length information.

In a possible implementation of the first aspect, each of the at least one first query message corresponds to a task, a modality, or a combination of a task and a modality, and each of the at least one task, each of the at least one modality, or each of at least one combination of the task and the modality has a respective correspondence between levels and pieces of query message length information.

Because each first query message may correspond to a task, a modality, or a combination of a task and a modality, and each task, modality or combination of task and modality may have its respective correspondence between levels and pieces of query message length information, different first query messages corresponding to different tasks, different modalities, or different combinations of task and modality may be obtained based on different pieces of query message length information even if they correspond to the same first level, and thus the flexibility of obtaining the first query message may be further improved, and query may be conducted more flexibly and reasonably according to the task and/or modality.

In a possible implementation of the first aspect, the at least one first query message includes multiple first query messages, and first levels for at least two first query messages of the multiple first query messages are different.

Because at least two first query messages may correspond to different levels, the first query messages may be obtained based on different first levels, and thus, the flexibility of query would be further improved, and query could be conducted more efficiently.

In a possible implementation of the first aspect, after the sending, a first sensing result, the method further includes:
obtaining at least one second query message based on at least one second level, where each of the at least one second query message corresponds to one of the at least one second level, and for each of one or more second query messages of the at least one second query message, a second level is higher than a first level for a corresponding first query message in the at least one first query message; and
sending a second sensing result, where the second sensing result includes at least one piece of second sensed data and/or at least one second sensing semantic.

In a possible implementation of the first aspect, the each of one or more second query messages is a fine grained query of the corresponding one in the at least one first query message.

In a possible implementation of the first aspect, each of one or more pieces of second sensed data of the at least one piece of second sensed data is a piece of fine grained sensed data of a corresponding piece of first sensed data in the at least one piece of first sensed data or a piece of fine grained sensed data of a corresponding first sensing semantic in the at least one first sensing semantic, and/or each of one or more second sensing semantics of the at least one second sensing semantic is a fine grained sensing semantic of a corresponding piece of first sensed data in the at least one piece of first sensed data or a fine grained sensing semantic of a corresponding first sensing semantic in the at least one first sensing semantic.

Because the sensing communication would go through several rounds, from low levels to high levels, where after a sensing result is sent in response to a query message of a low level, a query message of a high level may be further obtained and a sensing result in response to the query message of the high level would be sent, query could be conducted progressively based on hierarchical levels of queries, and sensing results would become finer and finer.

In a possible implementation of the first aspect, the method further includes:
determining a respective first level for each of the at least one first query message.

Because the first level may be determined for each first query message, the first query message could be obtained based on the first level corresponding thereto.

In a possible implementation of the first aspect, the method further includes:
determining, for each of the at least one first query message, according to the respective first level for each of the at least one first query message, a respective first piece of query message length information corresponding to the each of the at least one first query message, where the respective first piece of query message length information includes at least one of a first query message length or a first compression ratio of query message.

Because the query message length information may be determined for each first query message according to the first level corresponding thereto, the first query message could be obtained based on the query message length information.

In a possible implementation of the first aspect, the method further includes:
obtaining a correspondence between levels and pieces of query message length information, where each of the pieces of query message length information includes at least one of query message length or the compression ratio of query message and the pieces of query message length information includes the first piece of query message length information; and
where the determining, for each of the at least one first query message, according to the respective first level for each of the at least one first query message, a respective first piece of query message length information corresponding to the each of the at least one first query message includes:
determining, for each of the at least one first query message, according to the respective first level for each of the at least one first query message and the correspondence, the respective first piece of query message length information corresponding to the each of the at least one first query message.

Because a correspondence between levels and pieces of query message length information could be obtained, the query message length information could be determined for each first query message according to its first level and the obtained correspondence.

In a possible implementation of the first aspect, the at least one first level includes a first query semantic level and/or a first query token level.

Because the at least one first level includes the first query semantic level and/or the first query token level, different types of query would be conducted.

In a possible implementation of the first aspect, when the at least one first query message includes at least one first query semantic, the at least one first level includes at least one first query semantic level.

In a possible implementation of the first aspect, the method further includes:
determining, for each of the at least one first query semantic, according to the respective first query semantic level for each of the at least one first query semantic, a respective first piece of query semantic length information corresponding to the each of the at least one first query semantic, where the respective first piece of query semantic length information includes at least one of a first query semantic length or a first compression ratio of query semantic.

Because the at least one first query message may include at least one first query semantic, and query semantic length information may be determined for each first query semantic according to its query semantic level, semantic query may be conducted more flexibly and reasonably.

In a possible implementation of the first aspect, the first query semantic length is represented by a value or a range.

Because the first query semantic length may be represented by a value or a range, the query could be conducted more flexibly according to actual demands.

In a possible implementation of the first aspect, the method further includes:
obtaining a correspondence between query semantic levels and pieces of query semantic length information, where each of the pieces of query semantic length information includes at least one of query semantic length or the compression ratio of query semantic, and the pieces of query semantic length information includes the first piece of query semantic length information, and
where the determining, for each of the at least one first query semantic, according to the respective first query semantic level for each of the at least one first query semantic, a respective first piece of query semantic length information corresponding to the each of the at least one first query semantic includes:
determining, for each of the at least one first query semantic, according to the respective first query semantic level for each of the at least one first query semantic and the correspondence, the respective first piece of query semantic length information corresponding to the each of the at least one first query semantic.

Because there is a correspondence between the query semantic levels and the pieces of query semantic length information, which may include the query semantic length and/or the compression ratio of query semantic, the query semantic could be obtained based on its respective piece of query semantic length information, in particular, its corresponding length and compression ratio, thereby increasing the flexibility of obtaining the query semantic and expanding the range of application.

In a possible implementation of the first aspect, when the at least one first query message includes at least one first query token, the at least one first level includes at least one first query token level.

In a possible implementation of the first aspect, the method further includes:
determining, for each of the at least one first query token, according to the respective first query token level for each of the at least one first query token, a respective first piece of query token length information corresponding to the each of the at least one first query token, where the respective first piece of query token length information includes at least one of a first query token length or a first compression ratio of query token.

Because the at least one first query message may include at least one first query token, and query token length information may be determined for each first query token according to its query token level, token query may be conducted more flexibly and reasonably. Moreover, because the at least one query message may include the at least one query token, and the at least one level may include the at least one query token level, the privacy would be protected.

In a possible implementation of the first aspect, the first query token length is represented by a value or a range.

Because the first query token length may be represented by a value or a range, the query could be conducted more flexibly according to actual demands.

In a possible implementation of the first aspect, the method further includes:
obtaining a correspondence between query token levels and pieces of query token length information, where each of the pieces of query token length information includes at least one of query token length or the compression ratio of query token, and the pieces of query token length information includes the first piece of query token length information, and
where the determining, for each of the at least one first query token, according to the respective first query token level for each of the at least one first query token, a respective first piece of query token length information corresponding to the each of the at least one first query token includes:
determining, for each of the at least one first query token, according to the respective first query token level for each of the at least one first query token and the correspondence, the respective first piece of query token length information corresponding to the each of the at least one first query token.

Because there is a correspondence between the query token levels and the pieces of query token length information, which may include the query token length and/or the compression ratio of query token, the query token could be obtained based on its respective piece of query token length information, in particular, its corresponding length and compression ratio, thereby increasing the flexibility of obtaining the query token and expanding the range of application. Moreover, because the at least one query message may include the at least one query token, and the at least one level may include the at least one query token level, the privacy would be protected.

In a possible implementation of the first aspect, the obtaining at least one first query message includes:
obtaining the at least one first query message via a broadcast message;
obtaining the at least one first query message via a multicast message targeted to a group of first apparatuses; or
obtaining the at least one first query message via a dedicated message to a first apparatus.

By means of broadcasting or multicasting, a large number of apparatuses may be scheduled rather than one-to-one individual scheduling, the resource consumption can be reduced. By means of unicasting, one-to-one individual scheduling can be achieved for special query dedicated to a specific apparatus.

In a possible implementation of the first aspect, the at least one piece of first sensed data includes at least one piece of first raw sensed data, first half raw sensed data, or first compressed sensed data.

Because the at least one piece of first sensed data may include at least one piece of first raw sensed data, first half raw sensed data, or first compressed sensed data, diversity of sensed data would be obtained.

In a second aspect, the present disclosure provides a sensing communication method, where the method includes:
sending at least one first query message based on at least one first level, where each of the at least one first query message corresponds to one of the at least one first level; and
obtaining one or more first sensing results, where the each of the one or more first sensing results includes at least one piece of first sensed data and/or at least one first sensing semantic.

Because the at least one first query message is sent based on the at least one first level, more flexible and detailed query would be achieved.

In a possible implementation of the second aspect, there is a correspondence between each of the at least one first level and a first piece of query message length information respectively, where the first piece of query message length information includes at least one of a first query message length or a first compression ratio of query message.

Because there is a correspondence between the levels and the pieces of query message length information, which may include the query message length and/or the compression ratio of query message, the query message could be sent based on its respective piece of query message length information, in particular, its corresponding length and/or compression ratio, thereby increasing the flexibility of sending the query message and expanding the range of application.

In a possible implementation of the second aspect, the correspondence between levels and pieces of query message length information is stored in a table.

In a possible implementation of the second aspect, the correspondence is predefined in a protocol or is obtained from a core network, and/or the correspondence is sent to a first apparatus.

Because there is the table storing the correspondence between levels and pieces of query message length information, which is predefined in the protocol or is obtained from a core network, and/or the correspondence is sent to an apparatus, it would be convenient to obtain the correspondence between levels and pieces of query message length information.

In a possible implementation of the second aspect, each of the at least one first query message corresponds to a task, a modality, or a combination of a task and a modality, and each of the at least one task, each of the at least one modality, or each of at least one combination of the task and the modality has a respective correspondence between levels and pieces of query message length information.

Because each first query message may correspond to a task, a modality, or a combination of a task and a modality, and each task, modality or combination of task and modality may have its respective correspondence between levels and pieces of query message length information, different first query messages corresponding to different tasks, different modalities, or different combinations of task and modality may be sent based on different pieces of query message length information even if they correspond to the same first level, and thus the flexibility of sending the first query message may be further improved, and query may be conducted more flexibly and reasonably according to the task and/or modality.

In a possible implementation of the second aspect, the at least one first query message includes multiple first query messages, and first levels for at least two first query messages of the multiple first query messages are different.

Because at least two first query messages may correspond to different levels, the first query messages may be sent based on different first levels, and thus, the flexibility of query would be further improved, and query could be conducted more efficiently.

In a possible implementation of the second aspect, after the obtaining one or more first sensing results, the method further includes:
sending at least one second query message based on at least one second level, where each of the at least one second query message corresponds to one of the at least one second level, and for each of one or more second query messages of the at least one second query message, a second level is higher than a first level for a corresponding first query message in the at least one first query message; and
obtaining one or more second sensing results, where each of the one or more second sensing results includes at least one piece of second sensed data and/or at least one second sensing semantic.

In a possible implementation of the second aspect, the each of one or more second query messages is a fine grained query of the corresponding one in the at least one first query message.

In a possible implementation of the second aspect, each of one or more pieces of second sensed data of the at least one piece of second sensed data is a piece of fine grained sensed data of a corresponding piece of first sensed data in the at least one piece of first sensed data or a piece of fine grained sensed data of a corresponding first sensing semantic in the at least one first sensing semantic, and/or each of one or more second sensing semantics of the at least one second sensing semantic is a fine grained sensing semantic of a corresponding piece of first sensed data in the at least one piece of first sensed data or a fine grained sensing semantic of a corresponding first sensing semantic in the at least one first sensing semantic.

Because the sensing communication would go through several rounds, from low levels to high levels, where after a sensing result is obtained in response to a query message of a low level, a query message of a high level may be further sent and a sensing result in response to the query message of the high level would be obtained, query could be conducted progressively based on hierarchical levels of queries, and sensing results would become finer and finer.

In a possible implementation of the second aspect, the method further includes:
determining a respective first level for each of the at least one first query message.

Because the first level may be determined for each first query message, the first query message could be sent based on the first level corresponding thereto.

In a possible implementation of the second aspect, the method further includes:
determining, for each of the at least one first query message, according to the respective first level for each of the at least one first query message, a respective first piece of query message length information corresponding to the each of the at least one first query message, where the respective first piece of query message length information includes at least one of a first query message length or a first compression ratio of query message.

Because the query message length information may be determined for each first query message according to the first level corresponding thereto, the first query message could be sent based on the query message length information.

In a possible implementation of the second aspect, the method further includes:
obtaining a correspondence between levels and pieces of query message length information, where each of the pieces of query message length information includes at least one of query message length or the compression ratio of query message and the pieces of query message length information includes the first piece of query message length information; and
where the determining, for each of the at least one first query message, according to the respective first level for each of the at least one first query message, a respective first piece of query message length information corresponding to the each of the at least one first query message includes:
determining, for each of the at least one first query message, according to the respective first level for each of the at least one first query message and the correspondence, the respective first piece of query message length information corresponding to the each of the at least one first query message.

Because a correspondence between levels and pieces of query message length information could be obtained, the query message length information could be determined for each first query message according to its first level and the obtained correspondence.

In a possible implementation of the second aspect, the at least one first level includes a first query semantic level and/or a first query token level.

Because the at least one first level includes a first query semantic level and/or a first query token level, different types of query would be conducted.

In a possible implementation of the second aspect, when the at least one first query message includes at least one first query semantic, the at least one first level includes at least one first query semantic level.

In a possible implementation of the second aspect, the method further includes:
determining, for each of the at least one first query semantic, according to the respective first query semantic level for each of the at least one first query semantic, a respective first piece of query semantic length information corresponding to the each of the at least one first query semantic, where the respective first piece of query semantic length information includes at least one of a first query semantic length or a first compression ratio of query semantic.

Because the at least one first query message may include at least one first query semantic, and query semantic length information may be determined for each first query semantic according to its query semantic level, semantic query may be conducted more flexibly and reasonably.

In a possible implementation of the second aspect, the first query semantic length is represented by a value or a range.

Because the first query semantic length may be represented by a value or a range, the query could be conducted more flexibly according to actual demands.

In a possible implementation of the second aspect, the method further includes:
obtaining a correspondence between query semantic levels and pieces of query semantic length information, where each of the pieces of query semantic length information includes at least one of query semantic length or the compression ratio of query semantic, and the pieces of query semantic length information includes the first piece of query semantic length information, and
where the determining, for each of the at least one first query semantic, according to the respective first query semantic level for each of the at least one first query semantic, a respective first piece of query semantic length information corresponding to the each of the at least one first query semantic includes:
determining, for each of the at least one first query semantic, according to the respective first query semantic level for each of the at least one first query semantic and the correspondence, the respective first piece of query semantic length information corresponding to the each of the at least one first query semantic.

Because there is a correspondence between the query semantic levels and the pieces of query semantic length information, which may include the query semantic length and/or the compression ratio of query semantic, the query semantic could be sent based on its respective piece of query semantic length information, in particular, its corresponding length and compression ratio, thereby increasing the flexibility of sending the query semantic and expanding the range of application.

In a possible implementation of the second aspect, when the at least one first query message includes at least one first query token, the at least one first level includes at least one first query token level.

In a possible implementation of the second aspect, the method further includes:
determining, for each of the at least one first query token, according to the respective first query token level for each of the at least one first query token, a respective first piece of query token length information corresponding to the each of the at least one first query token, where the respective first piece of query token length information includes at least one of a first query token length or a first compression ratio of query token.

Because the at least one first query message may include at least one first query token, and query token length information may be determined for each first query token according to its query token level, token query may be conducted more flexibly and reasonably. Moreover, because the at least one query message may include the at least one query token, and the at least one level may include the at least one query token level, the privacy would be protected.

In a possible implementation of the second aspect, the first query token length is represented by a value or a range.

Because the first query token length may be represented by a value or a range, the query could be conducted more flexibly according to actual demands.

In a possible implementation of the second aspect, the method further includes:
obtaining a correspondence between query token levels and pieces of query token length information, where each of the pieces of query token length information includes at least one of query token length or the compression ratio of query token and the pieces of query token length information includes the first piece of query token length information, and
where the determining, for each of the at least one first query token, according to the respective first query token level for each of the at least one first query token, a respective first piece of query token length information corresponding to the each of the at least one first query token includes:
determining, for each of the at least one first query token, according to the respective first query token level for each of the at least one first query token and the correspondence, the respective first piece of query token length information corresponding to the each of the at least one first query token.

Because there is a correspondence between the query token levels and the pieces of query token length information, which may include the query token length and/or the compression ratio of query token, the query token could be sent based on its respective piece of query token length information, in particular, its corresponding length and compression ratio, thereby increasing the flexibility of sending the query token and expanding the range of application. Moreover, because the at least one query message includes the at least one query token, and the at least one level includes at least one query token level, privacy would be protected.

In a possible implementation of the second aspect, the sending at least one first query message includes:
sending the at least one first query message via a broadcast message;
sending the at least one first query message via a multicast message targeted to a group of first apparatuses; or
sending the at least one first query message via a dedicated message to a first apparatus.

By means of broadcasting or multicasting, a large number of apparatuses may be scheduled rather than one-to-one individual scheduling, the resource consumption can be reduced. By means of unicasting, one-to-one individual scheduling can be achieved for special query dedicated to a specific apparatus.

In a possible implementation of the second aspect, the at least one piece of first sensed data includes at least one piece of first raw sensed data, first half raw sensed data, or first compressed sensed data.

Because the at least one piece of first sensed data may include at least one piece of first raw sensed data, first half raw sensed data, or first compressed sensed data, diversity of sensed data would be obtained.

In a third aspect, a possible implementation of the present disclosure provides a first apparatus, including various modules configured to execute the sensing communication method according to the first aspect or any possible implementation of the first aspect.

In a fourth aspect, a possible implementation of the present disclosure provides a second apparatus, including various modules configured to execute the sensing communication method according to the second aspect or any possible implementation of the second aspect.

In a fifth aspect, a possible implementation of the present disclosure provides a third apparatus, including a processing circuitry for executing the sensing communication method according to the first aspect or any possible implementation of the first aspect.

In a sixth aspect, a possible implementation of the present disclosure provides a fourth apparatus, including a processing circuitry for executing the sensing communication method according to the second aspect or any possible implementation of the second aspect.

In a seventh aspect, a possible implementation of the present disclosure provides a wireless communication system, including: at least one first apparatus according to the third aspect or any possible implementation of the third aspect or at least one third apparatus according to the fifth aspect; at least one second apparatus according to the fourth aspect or any possible implementation of the fourth aspect or at least one fourth apparatus according to the sixth aspect; and at least one fifth apparatus, where each of the at least one fifth apparatus includes: a sending module, configured to send at least one query message to the at least one second apparatus; and an obtaining module, configured to obtain at least one fused sensing result sent by the at least one second apparatus, where the at least one fused sensing result is generated based on one or more first sensing results.

In an eighth aspect, a possible implementation of the present disclosure provides a wireless communication system, including: a first processing circuitry for executing the sensing communication method according to the first aspect or any possible implementation of the first aspect; a second processing circuitry for executing the sensing communication method according to the second aspect or any possible implementation of the second aspect; and a third processing circuitry for executing following steps: sending at least one query message to the second processing circuitry; and obtaining at least one fused sensing result sent by the second processing circuitry, where the at least one fused sensing result is generated based on one or more first sensing results.

In a ninth aspect, a possible implementation of the present disclosure provides a computer-readable storage medium storing computer execution instructions which, when executed by a processor, cause the processor to execute the sensing communication method according to the first aspect or any possible implementation of the first aspect or the second aspect or any possible implementation of the second aspect.

In a tenth aspect, a possible implementation of the present disclosure provides a computer program product including computer execution instructions which, when executed by a processor, cause the processor to execute the sensing communication method according to the first aspect or any possible implementation of the first aspect or the second aspect or any possible implementation of the second aspect.

The present disclosure provides a sensing communication method, apparatus, and system. An apparatus such as a central device can broadcast or multi-cast or unicast query message(s), so that other apparatus(es) such as one or more sensing devices can obtain the query message(s) and respond with sensing result(s) in response to the obtained query message(s). Query may be conducted for one or more rounds. In a round, the query messages can be of different levels, and as a result, more flexible and detailed query would be achieved. Moreover, query may be conducted for several rounds, and the apparatus may broadcast or multi-cast or unicast query messages of different levels in several rounds, so that other apparatus(es) can respond with sensing result(s) in response to the obtained query messages in several rounds, where a low level/coarse level query message is for initial query, and a high level query message is for subsequent fine grained query. As a result, query could be conducted progressively based on hierarchical levels of queries, and sensing results would become finer and finer.

### BRIEF DESCRIPTION OF DRAWINGS

Reference will now be made, by way of example, to the accompanying drawings which show example embodiments of the present disclosure, and in which:

FIG. 1 is a simplified schematic illustration of a communication system according to one or more example embodiments of the present disclosure.

FIG. 2 is a schematic illustration of an example communication system according to one or more example embodiments of the present disclosure.

FIG. 3 is a schematic illustration of a basic component structure of a communication system according to one or more example embodiments of the present disclosure.

FIG. 4 is a block diagram of a device in a communication system according to one or more example embodiments of the present disclosure.

FIG. 5 is a schematic illustration of a sensing communication scenario according to one or more example embodiments of the present disclosure.

FIG. 6 is a schematic illustration of a plurality of the sensing devices in a sensing communication scenario according to one or more example embodiments of the present disclosure.

FIG. 7 is a schematic illustration of interaction among devices in a sensing communication scenario according to one or more example embodiments of the present disclosure.

FIG. 8 is another schematic illustration of interaction among devices in a sensing communication scenario according to one or more example embodiments of the present disclosure.

FIG. 9 is a schematic flowchart of a sensing communication method according to one or more example embodiments of the present disclosure.

FIG. 10 is another schematic flowchart of a sensing communication method according to one or more example embodiments of the present disclosure.

FIG. 11 is another schematic flowchart of a sensing communication method according to one or more example embodiments of the present disclosure.

FIG. 12 is another schematic flowchart of a sensing communication method according to one or more example embodiments of the present disclosure.

FIG. 13 is another schematic flowchart of a sensing communication method according to one or more example embodiments of the present disclosure.

FIG. 14 is another schematic flowchart of a sensing communication method according to one or more example embodiments of the present disclosure.

FIG. 15 is another schematic flowchart of a sensing communication method according to one or more example embodiments of the present disclosure.

FIG. 16 is another schematic flowchart of a sensing communication method according to one or more example embodiments of the present disclosure.

FIG. 17 is another schematic flowchart of a sensing communication method according to one or more example embodiments of the present disclosure.

FIG. 18 is another schematic flowchart of a sensing communication method according to one or more example embodiments of the present disclosure.

FIG. 19 is another schematic flowchart of a sensing communication method according to one or more example embodiments of the present disclosure.

FIG. 20 is another schematic flowchart of a sensing communication method according to one or more example embodiments of the present disclosure.

FIG. 21 is another schematic flowchart of a sensing communication method according to one or more example embodiments of the present disclosure.

FIG. 22 is another schematic flowchart of a sensing communication method according to one or more example embodiments of the present disclosure.

FIG. 23 is another schematic flowchart of a sensing communication method according to one or more example embodiments of the present disclosure.

FIG. 24 is another schematic flowchart of a sensing communication method according to one or more example embodiments of the present disclosure.

FIG. 25 is another schematic flowchart of a sensing communication method according to one or more example embodiments of the present disclosure.

FIG. 26 is another schematic flowchart of a sensing communication method according to one or more example embodiments of the present disclosure.

FIG. 27 is another schematic flowchart of a sensing communication method according to one or more example embodiments of the present disclosure.

FIG. 28 is another schematic flowchart of a sensing communication method according to one or more example embodiments of the present disclosure.

FIG. 29 is another schematic flowchart of a sensing communication method according to one or more example embodiments of the present disclosure.

FIG. 30 is another schematic flowchart of a sensing communication method according to one or more example embodiments of the present disclosure.

FIG. 31 is another schematic flowchart of a sensing communication method according to one or more example embodiments of the present disclosure.

FIG. 32 is another schematic flowchart of a sensing communication method according to one or more example embodiments of the present disclosure.

FIG. 33 is another schematic flowchart of a sensing communication method according to one or more example embodiments of the present disclosure.

FIG. 34 is another schematic flowchart of a sensing communication method according to one or more example embodiments of the present disclosure.

FIG. 35 is another schematic flowchart of a sensing communication method according to one or more example embodiments of the present disclosure.

FIG. 36 is a schematic illustration of realizing a chain of thoughts according to one or more example embodiments of the present disclosure.

FIG. 37 is another schematic illustration of interaction among devices in a sensing communication scenario according to one or more example embodiments of the present disclosure.

FIG. 38 is another schematic illustration of interaction among devices in a sensing communication scenario according to one or more example embodiments of the present disclosure.

FIG. 39 is a schematic illustration of generating a query message.

FIG. 40 is a schematic illustration of reversing a semantic.

FIG. 41 is a schematic illustration of tokenizing a query semantic into a query token.

FIG. 42 is a schematic illustration of responding to a query token.

FIG. 43 is a schematic illustration of scoring the relevance with tokens.

FIG. 44 is another schematic illustration of responding to a query token.

FIG. 45 is a schematic illustration of scoring a relevance with semantic.

FIG. 46 is another schematic illustration of responding to a query token.

FIG. 47 is a schematic illustration of scoring the relevance with tokens converted from semantics.

FIG. 48 is a schematic illustration of generating query tokens.

FIG. 49 is a schematic illustration of generating query semantics.

FIG. 50 is a schematic illustration of responding to two queries with a common semantization model and two tokenization models.

FIG. 51 is a schematic illustration of responding to two queries with a common semantization model and a common tokenization model.

FIG. 52 is another schematic illustration of responding to two queries with two semantization models and two tokenization models.

FIG. 53 is another schematic illustration of responding to two queries with two semantization models and a common tokenization model.

FIG. 54 is a schematic illustration of responding to two query semantics with a common semantization model and two different tokenization models.

FIG. 55 is a schematic illustration of responding to two query semantics with a common semantization model and a common tokenization model.

FIG. 56 is a schematic illustration of responding to two query semantics with two semantization models and two tokenization models.

FIG. 57 is a schematic illustration of responding to two query semantics with two semantization models and one tokenization model.

FIG. 58 is a schematic illustration of responding to two query semantics with one semantization model without tokenization model.

FIG. 59 is a schematic illustration of responding to two query semantics with two semantization models without tokenization model.

FIG. 60 is a schematic illustration of processing two sensing semantics independently.

FIG. 61 is a schematic illustration of processing one sensing semantic but with two tasks independently.

FIG. 62 is a schematic structural diagram of a first apparatus according to one or more example embodiments of the present disclosure.

FIG. 63 is a schematic structural diagram of a second apparatus according to one or more example embodiments of the present disclosure.

### DESCRIPTION OF EMBODIMENTS

In the following description, reference is made to the accompanying figures, which form part of the present disclosure, and which show, by way of illustration, specific aspects of embodiments of the present disclosure or specific aspects in which embodiments of the present disclosure may be used. It is understood that embodiments of the present disclosure may be used in other aspects and include structural or logical changes not depicted in the figures. The following detailed description, therefore, is not to be taken in a limiting sense, and the scope of the present disclosure is defined by the appended claims.

To assist in understanding the present disclosure, examples of wireless communication systems and devices are described below.

### Example Communication Systems and Devices

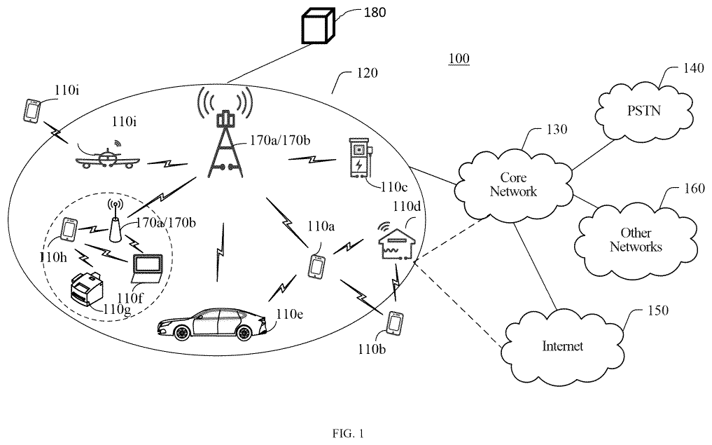

The present disclosure uses the interaction and processing procedures among at least one UE (i.e., the sensing device which is also called sensing node, which is marked as ED in FIG. 1), at least one BS (i.e., the central device) and at least one GPT devices in a wireless system as an illustrative example. The exchanged information and protocol flows can also be used between other network nodes described below, for example, between ED 110 and TRP 170, between ED 110 and core network, between ED 110 and ED 110, between TRP 170 and TRP 170, between TRP 170 and GPT device 180. The UE in the procedure described in the present disclosure may be replaced with a sensing node mentioned below. The BS in the procedure described in the present disclosure may be replaced with a sensing coordinator. Sensing coordinator are nodes in a network that can assist in the sensing operation. These nodes can be stand-alone nodes dedicated to just sensing operations or other nodes (for example TRP 170, ED 110, or core network node shown in FIG. 1) doing the sensing operations in parallel with communication transmissions.

Referring to FIG. 1, as an illustrative example without limitation, a simplified schematic illustration of a communication system according to one or more example embodiments of the present disclosure is provided. The communication system 100 (which may be the wireless system in FIG. 1) includes a radio access network 120. The radio access network 120 may be a next generation (e.g., sixth generation (6G) or later) radio access network, or a legacy (e.g., 5G, 4G, 3G or 2G) radio access network. One or more communication electric device (ED) 110a, 110b, 110c, 110d, 110e, 110f, 110g, 110h, 110i, 110j (generically referred to as 110) may be interconnected to one another or connected to one or more network nodes (170a, 170b, generically referred to as 170) in the radio access network 120. A core network 130 may be a part of the communication system and may be dependent or independent of the radio access technology used in the communication system 100. Also the communication system 100 includes a public switched telephone network (PSTN) 140, the internet 150, and other networks 160.

The uplink messages/data transmitted between the central device (e.g., the network node 170) and the sensing device (e.g., ED 110) could be carried in higher layer signaling, such as RRC signaling, or MAC layer signaling. Or, they could be carried in physical layer signaling, e.g., UCI. Or they could be carried in the combination of the higher layer signaling and the physical signaling. It could be noted that the message in the present disclosure could be replaced with information, which may be carried in one single message, or be carried in more than one separate message. The downlink messages/data transmitted between the central device and the ED 110 could be carried in higher layer signaling, such as RRC signaling, or MAC layer signaling. Or, they could be carried in physical layer signaling, e.g., UCI. Or they could be carried in the combination of the higher layer signaling and the physical signaling. It could be noted that the message in the present disclosure could be replaced with information, which may be carried in one single message, or be carried in more than one separate message.

In addition, the communication system 100 includes at least one GPT device 180. The GPT device 180 may be located within the one or more network node 170. The GPT device 180 may be an independent device connected to the network 170, such as an ED 110 which connected to the network node 170 via Uu interface. The GPT device 180 may be a device connected to the network node 170 via core network 130. When the GPT device 180 is an ED, the uplink messages/data transmitted between the central device (e.g., the network node 170) and the GPT device 180 could be carried in higher layer signaling, such as RRC signaling, or MAC layer signaling. Or, they could be carried in physical layer signaling, e.g., UCI. Or they could be carried in the combination of the higher layer signaling and the physical signaling. It could be noted that the message in the present disclosure could be replaced with information, which may be carried in one single message, or be carried in more than one separate message. The downlink messages/data transmitted between the central device and the GPT device 180 could be carried in higher layer signaling, such as RRC signaling, or MAC layer signaling. Or, they could be carried in physical layer signaling, e.g., UCI. Or they could be carried in the combination of the higher layer signaling and the physical signaling. It could be noted that the message in the present disclosure could be replaced with information, which may be carried in one single message, or be carried in more than one separate message.

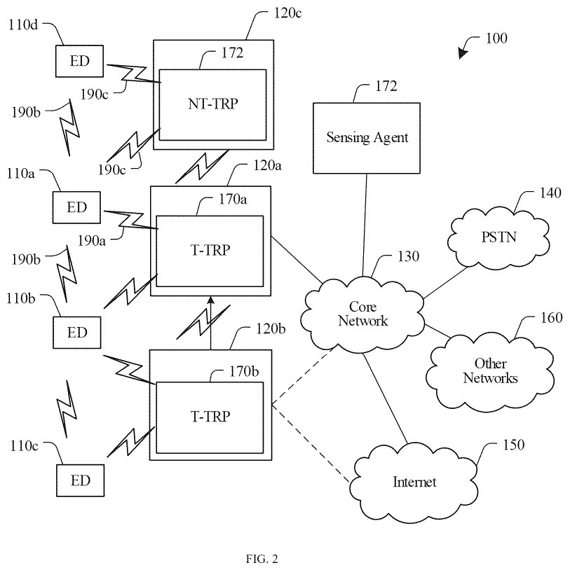

FIG. 2 is a schematic illustration of an example communication system according to one or more example embodiments of the present disclosure, where FIG. 2 illustrates an example communication system 100. In general, the communication system 100 enables multiple wireless or wired elements to communicate data and other content. The purpose of the communication system 100 may be to provide content, such as voice, data, video, signaling and/or text, via broadcast, multicast and unicast, etc. The communication system 100 may operate by sharing resources, such as carrier spectrum bandwidth, between its constituent elements. The communication system 100 may include a terrestrial communication system and/or a non-terrestrial communication system. The communication system 100 may provide a wide range of communication services and applications (such as earth monitoring, remote sensing, passive sensing and positioning, navigation and tracking, autonomous delivery and mobility, etc.). The communication system 100 may provide a high degree of availability and robustness through a joint operation of a terrestrial communication system and a non-terrestrial communication system. For example, integrating a non-terrestrial communication system (or components thereof) into a terrestrial communication system can result in what may be considered a heterogeneous network including multiple layers. Compared to conventional communication networks, the heterogeneous network may achieve better overall performance through efficient multi-link joint operation, more flexible functionality sharing, and faster physical layer link switching between terrestrial networks and non-terrestrial networks.

The terrestrial communication system and the non-terrestrial communication system could be considered as sub-systems of the communication system. In the example shown in FIG. 2, the communication system 100 includes electronic devices (ED) 110a, 110b, 110c, 110d (generically referred to as ED 110), radio access networks (RANs) 120a-120b, a non-terrestrial communication network 120c, a core network 130, a public switched telephone network (PSTN) 140, the Internet 150, and other networks 160. The RANs 120a-120b include respective base stations (BSs) 170a-170b, which may be generically referred to as terrestrial transmit and receive points (T-TRPs) 170a-170b. The non-terrestrial communication network 120c includes an access node 172, which may be generically referred to as a non-terrestrial transmit and receive point (NT-TRP) 172.

Any ED 110 may be alternatively or additionally configured to interface, access, or communicate with any T-TRP 170a-170b and NT-TRP 172, the Internet 150, the core network 130, the PSTN 140, the other networks 160, or any combination of the preceding. In some examples, ED 110a may communicate an uplink and/or downlink transmission over a terrestrial air interface 190a with T-TRP 170a. In some examples, the EDs 110a, 110b, 110c and 110d may also communicate directly with one another via one or more sidelink air interfaces 190b. In some examples, ED 110d may communicate an uplink and/or downlink transmission over a non-terrestrial air interface 190c with NT-TRP 172.

The air interfaces 190a and 190b may use similar communication technology, such as any suitable radio access technology. For example, the communication system 100 may implement one or more channel access methods, such as code division multiple access (CDMA), space division multiple access (SDMA), time division multiple access (TDMA), frequency division multiple access (FDMA), orthogonal FDMA (OFDMA), Direct Fourier Transform spread OFDMA (DFT-OFDMA) or single-carrier FDMA (SC-FDMA) in the air interfaces 190a and 190b. The air interfaces 190a and 190b may utilize other higher dimension signal spaces, which may involve a combination of orthogonal and/or non-orthogonal dimensions.

The non-terrestrial air interface 190c can enable communication between the ED 110d and one or multiple NT-TRPs 172 via a wireless link or simply a link. For some examples, the link is a dedicated connection for unicast transmission, a connection for broadcast transmission, or a connection between a group of EDs 110 and one or multiple NT-TRPs 172 for multicast transmission.

The RANs 120a and 120b are in communication with the core network 130 to provide the EDs 110a 110b, and 110c with various services such as voice, data, and other services. The RANs 120a and 120b and/or the core network 130 may be in direct or indirect communication with one or more other RANs (not shown), which may or may not be directly served by core network 130, and may or may not employ the same radio access technology as RAN 120a, RAN 120b or both. The core network 130 may also serve as a gateway access between (i) the RANs 120a and 120b or EDs 110a 110b, and 110c or both, and (ii) other networks (such as the PSTN 140, the Internet 150, and the other networks 160). In addition, some or all of the EDs 110a 110b, and 110c may include functionality for communicating with different wireless networks over different wireless links using different wireless technologies and/or protocols. Instead of wireless communication (or in addition thereto), the EDs 110a 110b, and 110c may communicate via wired communication channels to a service provider or switch (not shown), and to the Internet 150. PSTN 140 may include circuit switched telephone networks for providing plain old telephone service (POTS). Internet 150 may include a network of computers and subnets (intranets) or both, and incorporate protocols, such as Internet Protocol (IP), Transmission Control Protocol (TCP), User Datagram Protocol (UDP). EDs 110a 110b, and 110c may be multimode devices capable of operation according to multiple radio access technologies, and incorporate multiple transceivers necessary to support such.

### Basic Component Structure

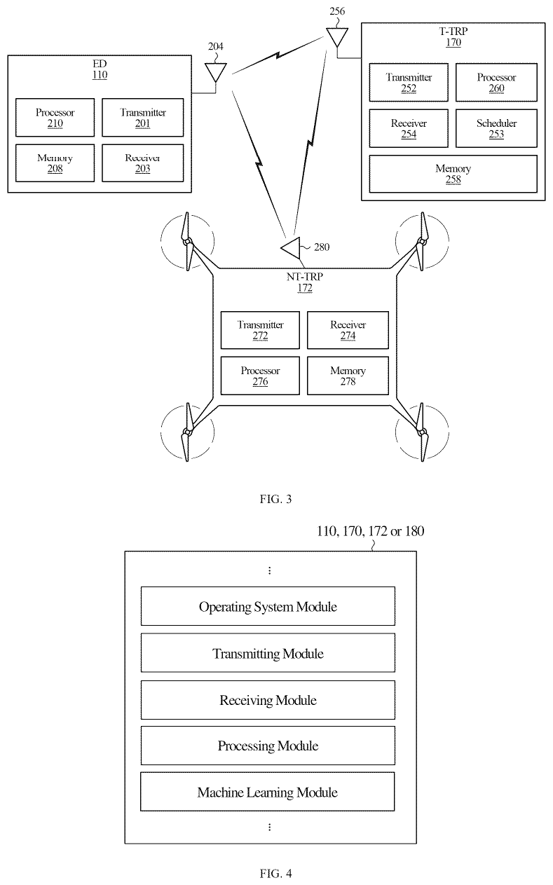

FIG. 3 is a schematic illustration of a basic component structure of a communication system according to one or more example embodiments of the present disclosure, where FIG. 3 illustrates another example of an ED 110 and a base station 170a, 170b and/or 170c. The ED 110 is used to connect persons, objects, machines, etc. The ED 110 may be widely used in various scenarios, for example, cellular communications, device-to-device (D2D), vehicle to everything (V2X), peer-to-peer (P2P), machine-to-machine (M2M), machine-type communications (MTC), Internet of things (IOT), virtual reality (VR), augmented reality (AR), mixed reality (MR), metaverse, digital twin, industrial control, self-driving, remote medical, smart grid, smart furniture, smart office, smart wearable, smart transportation, smart city, drones, robots, remote sensing, passive sensing, positioning, navigation and tracking, autonomous delivery and mobility, etc.

Each ED 110 represents any suitable end user device for wireless operation and may include such devices (or may be referred to) as a user equipment/device (UE), a wireless transmit/receive unit (WTRU), a mobile station, a fixed or mobile subscriber unit, a cellular telephone, a station (STA), a machine type communication (MTC) device, a personal digital assistant (PDA), a smartphone, a laptop, a computer, a tablet, a wireless sensor, a consumer electronics device, a smart book, a vehicle, a car, a truck, a bus, a train, or an IoT device, wearable devices such as a watch, head mounted equipment, a pair of glasses, an industrial device, or apparatus (e.g., communication module, modem, or chip) in the foregoing devices, among other possibilities. Future generation EDs 110 may be referred to using other terms. Each base station 170a and 170b is a T-TRP and will hereafter be referred to as T-TRP 170. Also shown in FIG. 3, a NT-TRP will hereafter be referred to as NT-TRP 172. Each ED 110 connected to T-TRP 170 and/or NT-TRP 172 can be dynamically or semi-statically turned-on (i.e., established, activated, or enabled), turned-off (i.e., released, deactivated, or disabled) and/or configured in response to one of more of: connection availability and connection necessity.

The ED 110 includes a transmitter 201 and a receiver 203 coupled to one or more antennas 204. Only one antenna 204 is illustrated. One, some, or all of the antennas 204 may alternatively be panels. The transmitter 201 and the receiver 203 may be integrated, e.g., as a transceiver. The transceiver is configured to modulate data or other content for transmission by at least one antenna 204 or network interface controller (NIC). The transceiver is also configured to demodulate data or other content received by the at least one antenna 204. Each transceiver includes any suitable structure for generating signals for wireless or wired transmission and/or processing signals received wirelessly or by wire. Each antenna 204 includes any suitable structure for transmitting and/or receiving wireless or wired signals.

The ED 110 includes at least one memory 208. The memory 208 stores instructions and data used, generated, or collected by the ED 110. For example, the memory 208 could store software instructions or modules configured to implement some or all of the functionality and/or embodiments described herein and that are executed by one or more processing unit(s) (e.g., a processor 210). Each memory 208 includes any suitable volatile and/or non-volatile storage and retrieval device(s). Any suitable type of memory may be used, such as random access memory (RAM), read only memory (ROM), hard disk, optical disc, subscriber identity module (SIM) card, memory stick, secure digital (SD) memory card, on-processor cache, and the like.

The ED 110 may further include one or more input/output devices (not shown) or interfaces (such as a wired interface to the Internet 150 in FIG. 1). The input/output devices permit interaction with a user or other devices in the network. Each input/output device includes any suitable structure for providing information to or receiving information from a user, such as through operation as a speaker, a microphone, a keypad, a keyboard, a display, or a touch screen, including network interface communications.

The ED 110 includes the processor 210 for performing operations including those operations related to preparing a transmission for uplink transmission to the NT-TRP 172 and/or the T-TRP 170, those operations related to processing downlink transmissions received from the NT-TRP 172 and/or the T-TRP 170, and those operations related to processing sidelink transmission to and from another ED 110. Processing operations related to preparing a transmission for uplink transmission may include operations such as encoding, modulating, transmit beamforming, and generating symbols for transmission. Processing operations related to processing downlink transmissions may include operations such as receive beamforming, demodulating and decoding received symbols. Depending upon the embodiment, a downlink transmission may be received by the receiver 203, possibly using receive beamforming, and the processor 210 may extract signaling from the downlink transmission (e.g., by detecting and/or decoding the signaling). An example of signaling may be a reference signal transmitted by the NT-TRP 172 and/or by the T-TRP 170. In some embodiments, the processor 210 implements the transmit beamforming and/or the receive beamforming based on the indication of beam direction, e.g., beam angle information (BAI), received from the T-TRP 170. In some embodiments, the processor 210 may perform operations relating to network access (e.g., initial access) and/or downlink synchronization, such as operations relating to detecting a synchronization sequence, decoding and obtaining the system information, etc. In some embodiments, the processor 210 may perform channel estimation, e.g., using a reference signal received from the NT-TRP 172 and/or from the T-TRP 170.

Although not illustrated, the processor 210 may form part of the transmitter 201 and/or part of the receiver 203. Although not illustrated, the memory 208 may form part of the processor 210.

The processor 210, the processing components of the transmitter 201 and the processing components of the receiver 203 may each be implemented by the same or different one or more processors that are configured to execute instructions stored in a memory (e.g., in the memory 208). Alternatively, some or all of the processor 210, the processing components of the transmitter 201 and the processing components of the receiver 203 may each be implemented using dedicated circuitry, such as a programmed field-programmable gate array (FPGA), a graphical processing unit (GPU), a Central Processing Unit (CPU) or an application-specific integrated circuit (ASIC).

In some implementations, the ED 110 may be an apparatus (also called component) for example, communication module, modem, chip, or chipset, it includes at least one processor 210, and an interface or at least one pin. In this scenario, the transmitter 201 and receiver 203 may be replaced by the interface or at least one pin, where the interface or at least one pin is to connect the apparatus (e.g., chip) and other apparatus (e.g., chip, memory, or bus). Accordingly, the transmitting information to the NT-TRP 172 and/or the T-TRP 170 and/or another ED 110 may be referred as transmitting information to the interface or at least one pin, or as transmitting information to the NT-TRP 172 and/or the T-TRP 170 and/or another ED 110 via the interface or at least one pin, and receiving information from the NT-TRP 172 and/or the T-TRP 170 and/or another ED 110 may be referred as receiving information from the interface or at least one pin, or as receiving information from the NT-TRP 172 and/or the T-TRP 170 and/or another ED 110 via the interface or at least one pin. The information may include control signaling and/or data.

The T-TRP 170 may be known by other names in some implementations, such as a base station, a base transceiver station (BTS), a radio base station, a network node, a network device, a device on the network side, a transmit/receive node, a Node B, an evolved NodeB (eNodeB or eNB), a Home eNodeB, a next Generation NodeB (gNB), a transmission point (TP), a site controller, an access point (AP), a wireless router, a relay station, a remote radio head, a terrestrial node, a terrestrial network device, a terrestrial base station, a base band unit (BBU), a remote radio unit (RRU), an active antenna unit (AAU), a remote radio head (RRH), a central unit (CU), a distributed unit (DU), a positioning node, among other possibilities. The T-TRP 170 may be a macro BS, a pico BS, a relay node, a donor node, or the like, or combinations thereof. The T-TRP 170 may refer to the foregoing devices or refer to apparatus (e.g., a communication module, a modem, or a chip) in the foregoing devices.

In some embodiments, the parts of the T-TRP 170 may be distributed. For example, some of the modules of the T-TRP 170 may be located remote from the equipment that houses the antennas 256 for the T-TRP 170, and may be coupled to the equipment that houses the antennas 256 over a communication link (not shown) sometimes known as front haul, such as common public radio interface (CPRI). Therefore, in some embodiments, the term T-TRP 170 may also refer to modules on the network side that perform processing operations, such as determining the location of the ED 110, resource allocation (scheduling), message generation, and encoding/decoding, and that are not necessarily part of the equipment that houses the antennas 256 of the T-TRP 170. The modules may also be coupled to other T-TRPs. In some embodiments, the T-TRP 170 may actually be a plurality of T-TRPs that are operating together to serve the ED 110, e.g., through the use of coordinated multipoint transmissions.

The T-TRP 170 includes at least one transmitter 252 and at least one receiver 254 coupled to one or more antennas 256. Only one antenna 256 is illustrated. One, some, or all of the antennas 256 may alternatively be panels. The transmitter 252 and the receiver 254 may be integrated as a transceiver. The T-TRP 170 further includes a processor 260 for performing operations including those related to: preparing a transmission for downlink transmission to the ED 110, processing an uplink transmission received from the ED 110, preparing a transmission for backhaul transmission to the NT-TRP 172, and processing a transmission received over backhaul from the NT-TRP 172. Processing operations related to preparing a transmission for downlink or backhaul transmission may include operations such as encoding, modulating, precoding (e.g., multiple input multiple output (MIMO) precoding), transmit beamforming, and generating symbols for transmission. Processing operations related to processing received transmissions in the uplink or over backhaul may include operations such as receive beamforming, demodulating received symbols and decoding received symbols. The processor 260 may also perform operations relating to network access (e.g., initial access) and/or downlink synchronization, such as generating the content of synchronization signal blocks (SSBs), generating the system information, etc. In some embodiments, the processor 260 also generates an indication of beam direction, e.g., BAI, which may be scheduled for transmission by a scheduler 253. The processor 260 performs other network-side processing operations described herein, such as determining the location of the ED 110, determining where to deploy the NT-TRP 172, etc. In some embodiments, the processor 260 may generate signaling, e.g., to configure one or more parameters of the ED 110 and/or one or more parameters of the NT-TRP 172. Any signaling generated by the processor 260 is sent by the transmitter 252. Note that “signaling,” as used herein, may alternatively be called control signaling. Dynamic signaling may be transmitted in a control channel, e.g., a physical downlink control channel (PDCCH), and static or semi-static higher layer signaling may be included in a packet transmitted in a data channel, e.g., in a physical downlink shared channel (PDSCH).

The scheduler 253 may be coupled to the processor 260. The scheduler 253 may be included within or operated separately from the T-TRP 170. The scheduler 253 may schedule uplink, downlink, and/or backhaul transmissions, including issuing scheduling grants and/or configuring scheduling-free (“configured grant”) resources. The T-TRP 170 further includes a memory 258 for storing information and data. The memory 258 stores instructions and data used, generated, or collected by the T-TRP 170. For example, the memory 258 could store software instructions or modules configured to implement some or all of the functionality and/or embodiments described herein and that are executed by the processor 260.

Although not illustrated, the processor 260 may form part of the transmitter 252 and/or part of the receiver 254. Also, although not illustrated, the processor 260 may implement the scheduler 253. Although not illustrated, the memory 258 may form part of the processor 260.

The processor 260, the scheduler 253, the processing components of the transmitter 252 and the processing components of the receiver 254 may each be implemented by the same or different one or more processors that are configured to execute instructions stored in a memory, e.g., in the memory 258. Alternatively, some or all of the processor 260, the scheduler 253, the processing components of the transmitter 252 and the processing components of the receiver 254 may be implemented using dedicated circuitry, such as a FPGA, a GPU, a CPU, or an ASIC.

When the T-TRP 170 is an apparatus (also called as component), for example, communication module, modem, chip, or chipset in a device, it includes at least one processor, and an interface or at least one pin. In this scenario, the transmitter 252 and receiver 254 may be replaced by the interface or at least one pin, where the interface or at least one pin is to connect the apparatus (e.g., chip) and other apparatus (e.g., chip, memory, or bus). Accordingly, the transmitting information to the NT-TRP 172 and/or the T-TRP 170 and/or ED 110 may be referred as transmitting information to the interface or at least one pin, and receiving information from the NT-TRP 172 and/or the T-TRP 170 and/or ED 110 may be referred as receiving information from the interface or at least one pin. The information may include control signaling and/or data.

Although the NT-TRP 172 is illustrated as a drone only as an example, the NT-TRP 172 may be implemented in any suitable non-terrestrial form, such as high altitude platforms, satellite, high altitude platform as international mobile telecommunication base stations and unmanned aerial vehicles, which forms will be discussed hereinafter. Also, the NT-TRP 172 may be known by other names in some implementations, such as a non-terrestrial node, a non-terrestrial network device, or a non-terrestrial base station. The NT-TRP 172 includes a transmitter 272 and a receiver 274 coupled to one or more antennas 280. Only one antenna 280 is illustrated. One, some, or all of the antennas may alternatively be panels. The transmitter 272 and the receiver 274 may be integrated as a transceiver. The NT-TRP 172 further includes a processor 276 for performing operations including those related to: preparing a transmission for downlink transmission to the ED 110, processing an uplink transmission received from the ED 110, preparing a transmission for backhaul transmission to T-TRP 170, and processing a transmission received over backhaul from the T-TRP 170. Processing operations related to preparing a transmission for downlink or backhaul transmission may include operations such as encoding, modulating, precoding (e.g., MIMO precoding), transmit beamforming, and generating symbols for transmission. Processing operations related to processing received transmissions in the uplink or over backhaul may include operations such as receive beamforming, demodulating received symbols and decoding received symbols. In some embodiments, the processor 276 implements the transmit beamforming and/or receive beamforming based on beam direction information (e.g., BAI) received from the T-TRP 170. In some embodiments, the processor 276 may generate signaling, e.g., to configure one or more parameters of the ED 110. In some embodiments, the NT-TRP 172 implements physical layer processing, but does not implement higher layer functions such as functions at the medium access control (MAC) or radio link control (RLC) layer. As this is only an example, more generally, the NT-TRP 172 may implement higher layer functions in addition to physical layer processing.

The NT-TRP 172 further includes a memory 278 for storing information and data. Although not illustrated, the processor 276 may form part of the transmitter 272 and/or part of the receiver 274. Although not illustrated, the memory 278 may form part of the processor 276.

The processor 276, the processing components of the transmitter 272 and the processing components of the receiver 274 may each be implemented by the same or different one or more processors that are configured to execute instructions stored in a memory, e.g., in the memory 278. Alternatively, some or all of the processor 276, the processing components of the transmitter 272 and the processing components of the receiver 274 may be implemented using dedicated circuitry, such as a programmed FPGA, a GPU, a CPU, or an ASIC. In some embodiments, the NT-TRP 172 may actually be a plurality of NT-TRPs that are operating together to serve the ED 110, e.g., through coordinated multipoint transmissions.

When the NT-TRP 172 is an apparatus (e.g., communication module, modem, chip, or chipset) in a device, it includes at least one processor, and an interface or at least one pin. In this scenario, the transmitter 272 and receiver 257 may be replaced by the interface or at least one pin, where the interface or at least one pin is to connect the apparatus (e.g., chip) and other apparatus (e.g., chip, memory, or bus). Accordingly, the transmitting information to the T-TRP 170 and/or another NT-TRP 172 and/or ED 110 may be referred as transmitting information to the interface or at least one pin, and receiving information from the T-TRP 170 and/or another NT-TRP 172 and/or ED 110 may be referred as receiving information from the interface or at least one pin. The information may include control signaling and/or data.

Note that “TRP,” as used herein, may refer to a T-TRP or a NT-TRP. A T-TRP may alternatively be called a terrestrial network TRP (“TN TRP”) and a NT-TRP may alternatively be called a non-terrestrial network TRP (“NTN TRP”).

The T-TRP 170, the NT-TRP 172, and/or the ED 110 may include other components, but these have been omitted for the sake of clarity.

Any or all of the EDs 110 and BS 170 may be sensing nodes in the system 100. Sensing nodes are network entities that perform sensing by transmitting and receiving sensing signals. Some sensing nodes are communication equipment that perform both communications and sensing. However, it is possible that some sensing nodes do not perform communications, and are instead dedicated to sensing. The sensing agent 174 is an example of a sensing node that is dedicated to sensing. Unlike the EDs 110 and BS 170, the sensing agent 174 does not transmit or receive communication signals. However, the sensing agent 174 may communicate configuration information, sensing information, signaling information, or other information within the communication system 100. The sensing agent 174 may be in communication with the core network 130 to communicate information with the rest of the communication system 100. By way of example, the sensing agent 174 may determine the location of the ED 110a, and transmit this information to the base station 170a via the core network 130. Although only one sensing agent 174 is shown in FIG. 2, any number of sensing agents may be implemented in the communication system 100. In some embodiments, one or more sensing agents may be implemented at one or more of the RANS 120.

A sensing node may combine sensing-based techniques with reference signal-based techniques to enhance UE pose determination. This type of sensing node may also be known as a sensing management function (SMF). In some networks, the SMF may also be known as a location management function (LMF). The SMF may be implemented as a physically independent entity located at the core network 130 with connection to the multiple BSs 170. In other aspects of the present application, the SMF may be implemented as a logical entity co-located inside a BS 170 through logic carried out by the processor 260.

Although not presented in FIG. 3, a GPT device 180 may be included, which has similar structure to ED 110, e.g., GPT device 180 includes at least one processor, a transmitter and a receiver.

### Basic Module Structure

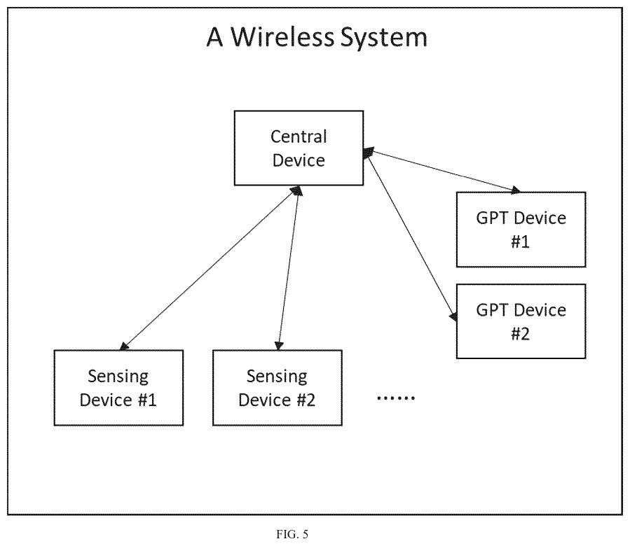

FIG. 4 is a block diagram of a device in a communication system according to one or more example embodiments of the present disclosure, where one or more steps of the embodiment methods provided herein may be performed by corresponding units or modules, according to FIG. 4. FIG. 4 illustrates units or modules in a device, such as in the ED 110, in the T-TRP 170, in the NT-TRP 172, or in the GPT device 180. For example, a signal may be transmitted by a transmitting unit or by a transmitting module. A signal may be received by a receiving unit or by a receiving module. A signal may be processed by a processing unit or a processing module. Other steps may be performed by an artificial intelligence (AI) or machine learning (ML) module. The respective units or modules may be implemented using hardware, one or more components or devices that execute software, or a combination thereof. For instance, one or more of the units or modules may be an integrated circuit, such as a programmed FPGA, a GPU, a CPU, or an ASIC. It will be appreciated that where the modules are implemented using software for execution by a processor for example, the modules may be retrieved by a processor, in whole or part as needed, individually or together for processing, in single or multiple instances, and that the modules themselves may include instructions for further deployment and instantiation. The transmitter mentioned with reference to FIG. 3 may be a detailed implementation for the transmitting module. The receiver mentioned with reference to FIG. 3 may be a detailed implementation for the receiving module. The processor mentioned with reference to FIG. 3 may be a detailed implementation for the processing module.

Additional details regarding the EDs 110, the T-TRP 170, the NT-TRP 172 and the GPT device 180 are known to those of skill in the art. As such, these details are omitted here.

The details of the present disclosure will be elaborated in the following description.

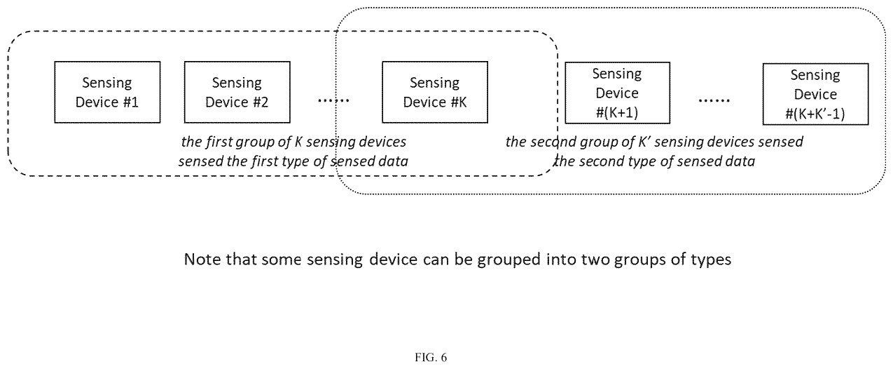

FIG. 5 is a schematic illustration of a sensing communication scenario according to one or more example embodiments of the present disclosure, where a wireless system includes a number of sensing devices, GPT device, and a central device.

In present disclosure, the wireless system is also called communication system, or wireless communication system. Herein the wireless system includes a plurality of devices, for example, the plurality of devices include at least a central device, a plurality of distributed sensing devices and at least a GPT device (in FIG. 5).

The GPT device is responsible for encoding or decoding query messages and sensed data. In details, it generates a query message that contains one goal or goals in natural language for the central device; the central device semantizes the query message into a semantic vector, tokenizes the semantic vector into a goal semantic token (vector), and then broadcasts the goal token to the sensing devices. A sensing device, triggered by receiving the goal semantic token, measures its sensed data and converts the sensed data into a sensed semantic token. The sensing device compares and scores the relevance between the goal semantic token and sensed semantic token and transmit the sensed data in semantic vector only if the score of relevance is higher than a threshold. The central device fuses the sensed data in semantic vectors and outputs the fused one to the GPT device that will generate the next query message based on the fused input.

A central device may be a BS, e.g., gNB, or eNB etc., or the central device may be an access point (AP).

A sensing device is responsible for measuring and/or collecting local physical-world data. It may be sensing UE, sensing equipment, IoT equipment, UE, mobile phones, handset, or other equipment. The sensing device may be equipped with a sensing gadget or component to measure local physical-world data near it into a sensed data; the sensing encodes and transmits them to the central device.

A GPT device may generate a sequence of the query messages and receives a fused sensing message from the central device. In the present disclosure, the GPT device could be also called AI agent device, robot device, or smart controlling device.

In some implementations, a sensing device may be a UE, a mobile phone or a handset, wherein independence among any two sensing devices are assumed; thereby, a sensing device may be scheduled individually by the wireless system to which the sensing device is associated; and the sensed data that the sensing device measures may be application-level payload for the wireless system and protocol.

The above scheme of scheduling a sensing device is inefficient in terms of radio bandwidth and energy consumption. For instance, a sensing device blindly keeps transmitting its sensed data to the central device, regardless of whether the sensed data is required or not.

From a higher level perspective, it is better to wake a plurality of sensing devices to measure and transmit only when their sensed data would serve a goal or goals; for example, when a generative pre-trained transformer (GPT) device such as a driverless car, may request the information about the moving obstacles near itself, it is useless to keep transmitting irrelevant information to the driverless car, or to transmit all the moving obstacles nearby to the car when the car is parking on the roadside.

To avoid any missing probability of the information, resources in the wireless system in above implementations may be over-scheduled.

FIG. 6 is a schematic illustration of a plurality of the sensing devices in a sensing communication scenario according to one or more example embodiments of the present disclosure, where sensing devices provide multiple-modality sensed data.

In details, a plurality of the sensing devices herein may be grouped or classified in terms of types of sensed data. The first group of the sensing devices may measure the first type of sensed data (e.g., red, green, blue (RGB) images or video), whereas the second group of sensing devices may measure the second type of sensed data (e.g., Radio RF point-cloud or Lidar Point cloud) as illustrated in FIG. 6.

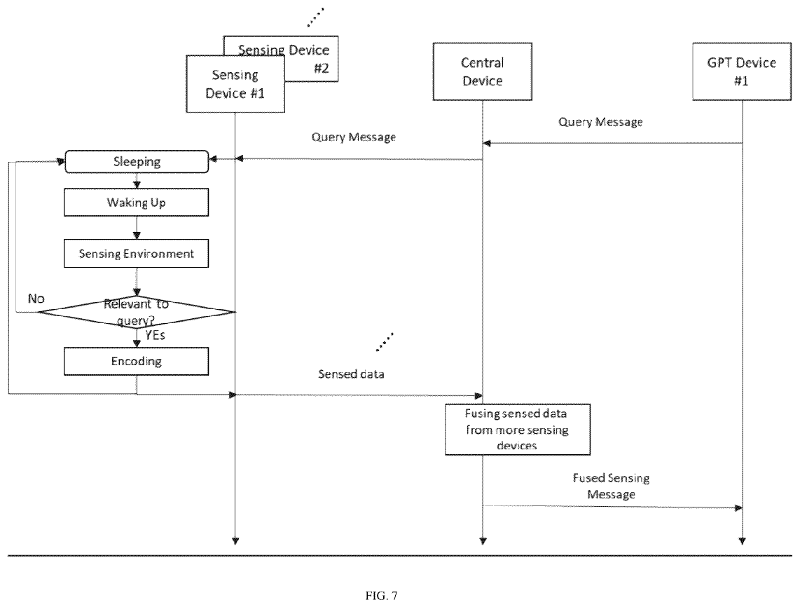

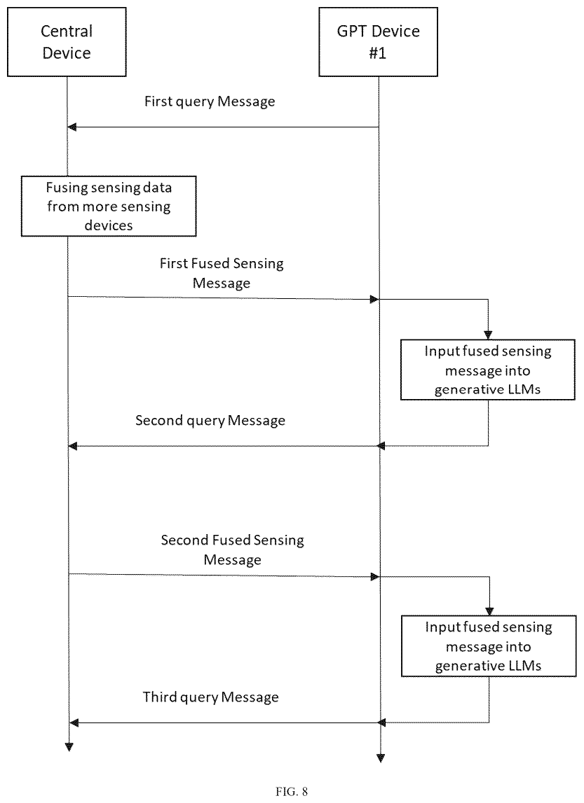

FIG. 7 is a schematic illustration of interaction among devices in a sensing communication scenario according to one or more example embodiments of the present disclosure, where a central device sends a query message to a number of sensing devices and receives the sensed data from the responsive sensing devices.

The central device actively requests or triggers the sensing devices to transmit their most recent sensed data (in FIG. 7). Accordingly, the sensing devices will transmit their sensed data.

The central device may transmit the first query message or messages to one or some sensing devices in DL broadcast, multicast, or unicast channel or channel(s), which may be in physical broadcast channel, shared channel, or dedicated channel(s).

After a sensing device receives the first query message, the sensing device decides whether or not to transmit its sensed data. In details, the sensing device decodes the first query message, measures its data, and decides whether or not to transmit its sensed data, which is called as responding to the first query message. If the sensing device decides to respond to the first query message, the sensing device would encode/encapsulate the sensed data into a payload and then transmit it to the central device in UL channel or channel(s), which may be physical UL shared channel or dedicated UL channel.

After the central device of the wireless system receives all the payloads from the sensing devices that responded to the first query message, the central device may fuse all or some payloads into a fused payload. Optionally, the central device may input the fused payload into the GPT device that may process them and then generate the second query message.

The central device may transmit the second query message or messages to one or some sensing devices in DL broadcast, multicast, or unicast channel or channel(s).

The GPT device transmits the query messages to the central device to inform and configure the central device to schedule when, how, what, and which sensing devices to sense and transmit their sensed data to the central device. The GPT device may be implemented/located together with the central device for shorter latency, or the GPT device may be implemented in a remote data center, to which the central device may access via core network, or the GPT device may be on another connected device in the same wireless system of the central device. Please note that, in the present disclosure, the query message from the central device to the sensing device (downlink message) could be carried in higher layer signaling, such as radio resource control (RRC) signaling, or medium access control (MAC) layer signaling. Or, the query message could be carried in physical layer signaling, e.g., downlink control information (DCI). Or the query message is carried in the combination of the higher layer signaling and the physical signaling. It is similar for other downlink messages/data transmitted from the central device to the sensing device. Similarly, in the present disclosure, for uplink messages/data, they could be carried in higher layer signaling, such as RRC signaling, or MAC layer signaling. Or, they could be carried in physical layer signaling, e.g., uplink control information (UCI). Or they could be carried in the combination of the higher layer signaling and the physical signaling. It could be noted that the message in the present disclosure could be replaced with information, which may be carried in one single message, or be carried in more than one separate message.

FIG. 8 is another schematic illustration of interaction among devices in a sensing communication scenario according to one or more example embodiments of the present disclosure, where the GPT device generates a sequence of query messages and receives a sequence of sensing messages.

The wireless system including a central device, sensing devices, and GPT device may form a series of interactions, in which the GPT device generates a sequence of the query messages for the sensing devices, the sensing devices collect and feedback the sensed data, and the central device fuses them and input them to the GPT device as illustrated in FIG. 8.

In some circumstances, some sensing devices may actively transmit their sensed data without receiving any query message from the central device. The sensing devices that transmit the sensed data may respond to some urgency queries such as fire alarming or car accident. In some sense, some query messages have been pre-defined and configured into the system by default.

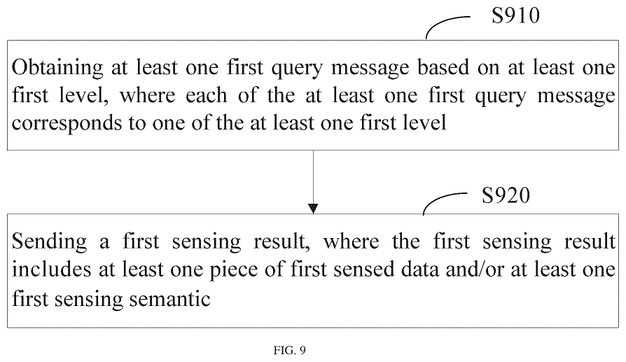

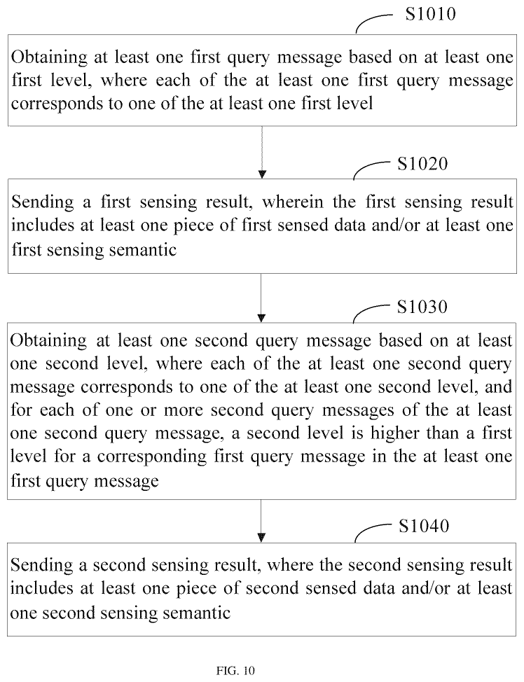

FIG. 9 is a schematic flowchart of a sensing communication method according to one or more example embodiments of the present disclosure. The method can be implemented by a first apparatus. Optionally, the first apparatus can be a sensing device or other device that has similar function (for example, the first apparatus could be a chip), which is not limited herein. As shown in FIG. 9, the method can include the following steps.

S910, obtaining at least one first query message based on at least one first level, where each of the at least one first query message corresponds to one of the at least one first level.

In details, the first apparatus may obtain the at least one first query message from a second apparatus based on the at least one first level, where each of the at least one first query message corresponds to one of the at least one first level. In other words, each first query message has its respective first level. Optionally, the second apparatus can be a central device or other device that has similar function (for example, the second apparatus could be a chip), which is not limited herein.

In a possible implementation, there is a correspondence between each of the at least one first level and a first piece of query message length information respectively, where the first piece of query message length information includes at least one of a first query message length or a first compression ratio of query message. For example, for level 1, the first query message length could be 64 bits and the compression ratio could be 1000. Further, the first query message length would be represented by a value or a range. For example, for level 1, the first query message length could be 64 bits or [32, 64) bits. The correspondence can also include other parameters, which is not limited herein.

In a possible implementation, the correspondence between levels and pieces of query message length information is stored in a table. In detail, the correspondence between different levels, and query messages lengths and/or compression ratios of query messages can be defined in a table. Some examples are given in following Table 1, Table 2, and Table 3.

TABLE 1
different query message length represented by value

| Level | Query message length |
|---|---|
| 1 | 64 bits |
| 2 | 128 bits |
| 3 | 512 bits |

Table 1 shows an example correspondence between different levels and different query message lengths, where the query message lengths are represented by values. The query message lengths could be in the unit of bit, which is not limited herein. For example, level 1 corresponds to a query message length of 64 bits, level 2 corresponds to a query message length of 128 bits, and level 3 corresponds to a query message length of 512 bits, and so on. It should be noted that the number of levels and corresponding query message lengths is not limited by the above Table 1, which could include less levels, or more levels, such as level 4, level 5.

TABLE 2
different query message length represented by range

| Level | Range of query message length | |
|---|---|---|
| 1 | [32, 64) | bits |
| 2 | [64, 128) | bits |
| 3 | [128, 512) | bits |

Table 2 shows an example correspondence between different levels and different query message lengths, where the query message lengths are represented by ranges. The query message lengths could be in the unit of bit, which is not limited herein. For example, level 1 corresponds to a query message length in a range of [32, 64) bits, level 2 corresponds to a query message length in a range of [64, 128) bits, and level 3 corresponds to a query message length in a range of [128, 512) bits, and so on. It should be noted that the number of levels and corresponding query message lengths is not limited by the above Table 2, which could include less levels, or more levels, such as level 4, level 5.

TABLE 3
different compression ratio of query message

| Level | Compression ratio of query message |
|---|---|
| 1 | 1000 |
| 2 | 500 |
| 3 | 200 |
| 4 | 50 |

Table 3 shows an example correspondence between different levels and different compression ratios of query message. For example, level 1 corresponds to a compression ratio of query message of 1000, level 2 corresponds to a compression ratio of query message of 500, level 3 corresponds to a compression ratio of query message of 200, and level 4 corresponds to a compression ratio of query message of 50, and so on. It should be noted that the number of levels and corresponding compression ratios of query message is not limited by the above Table 3, which could also include less levels, or more levels, such as level 5, level 6.

Furthermore, the above Table 1, Table 2, Table 3, and/or other tables could be combined in one table, which is not shown herein for brevity.

In a possible implementation, the correspondence is predefined in a protocol or is obtained from the second apparatus. For example, the first apparatus, i.e. the sensing device, can obtain the correspondence locally if the correspondence has been predefined in the sensing device, for example, as specified in a protocol, or, can obtain the correspondence from the central device, which is not limited herein.

In a possible implementation, each of the at least one first query message may correspond to a task, a modality, or a combination of a task and a modality, and each of the at least one task, each of the at least one modality, or each of at least one combination of the task and the modality may have its respective correspondence between levels and pieces of query message length information. For example, task 1 corresponds to a first correspondence between levels and pieces of query message length information, task 2 corresponds to a second correspondence between levels and pieces of query message length information, task 3 corresponds to a third correspondence between levels and pieces of query message length information and so on, where different tasks may have same or different correspondences. More specifically, task 1 “find moving obstacles” and task 2 “localize incoming pedestrians” may have same or different correspondences. Different modalities may also have same or different correspondences, and the different combinations of the task and the modality may also have same or different correspondences, which are not repeated herein for brevity.

Multiple tables can be defined for multiple tasks/modalities. Some examples are given in following Table 4-1 and Table 4-2.

TABLE 4-1
Table for task 1

| Level | Query message length for task 1 |
|---|---|
| 1 | 64 bits |
| 2 | 128 bits |
| 3 | 512 bits |

TABLE 4-2
Table for task 2

| Level | Query message length for task 2 |
|---|---|
| 1 | 50 bits |
| 2 | 100 bits |
| 3 | 300 bits |
| 4 | 500 bits |

Table 4-1 and Table 4-2 are two tables that may be defined for task 1 and task 2, respectively. However, multiple tables can also be defined for multiple modalities or multiple combinations of task and modality, which are not shown herein for brevity. Further, each of Table 4-1 and Table 4-2 shows a correspondence between different levels and different query message lengths represented by values for a specific task. However, a correspondence between different levels and different query message lengths represented by ranges or different compression ratios of query message can also be defined, which is not shown herein for brevity.

Furthermore, the above Table 4-1, Table 4-2, and/or other tables could be combined in one table, which is not shown herein for brevity.

In a possible implementation, the at least one first query message includes multiple first query messages, and first levels for at least two first query messages of the multiple first query messages are different. In other words, the first apparatus may obtain multiple first query messages of different levels from the second apparatus, where the multiple first query messages can be given at different levels, for example, the multiple first query messages may include a low level query message and a high level query message. For example, the multiple first query messages could include MSG 1, MSG 2, MSG 3, where the MSG1 could correspond to level 1, the MSG 2 could correspond to level 2, and the MSG 3 could correspond to level 3. In another example, the multiple first query messages could include MSG 1, MSG 2, MSG 3, where the MSG1 could correspond to level 1, the MSG 2 could correspond to level 1, and the MSG 3 could correspond to level 2. In still another example, the multiple first query messages could include MSG 1, MSG 2, MSG 3, where the MSG1 could correspond to level 2, the MSG 2 could correspond to level 3, and the MSG 3 could correspond to level 3. The above examples are only for illustration, which are not limited herein.

In brief, for one round of query, the central device can broadcast or multi-cast or unicast query messages of different levels to the sensing device(s), so that the sensing device(s) can obtain the query messages of different levels. The multiple query messages can be given at different levels.

S920, sending a first sensing result, where the first sensing result includes at least one piece of first sensed data and/or at least one first sensing semantic.

In details, the first apparatus may send the first sensing result to the second apparatus, where the first sensing result includes at least one piece of first sensed data and/or at least one first sensing semantic. Specifically, once the first apparatus obtains the first query message, the first apparatus may become waken but with little idea whether or not its sensed data is sufficiently relevant to the goal conveyed by the first query message. Thereby the first apparatus may enable its sensing gadget to sense its nearby environment into sensed data and compare the sensed data with the query message. If the first apparatus tells that the sensed data is sufficiently relevant with the query message, the sensing device encodes and sends the sensed data to the second apparatus. Further, the sensed data can be sent in many forms, such as, raw sensed data, half raw sensed data, compressed sensed data, or sensing semantic converted from the raw sensed data, which is not limited herein.

With the sensing communication method provided by the present disclosure, the first apparatus may obtain the at least one first query message from the second apparatus based on the at least one first level, where each of the at least one first query message corresponds to one of the at least one first level, and then the first apparatus may send the first sensing result to the second apparatus, where the first sensing result includes at least one piece of first sensed data and/or at least one first sensing semantic. Because the at least one first query message is obtained based on the at least one first level, more flexible and detailed query would be achieved.

FIG. 10 is another schematic flowchart of a sensing communication method according to one or more example embodiments of the present disclosure. In a possible implementation, as shown in FIG. 10, the method can include the following steps.

S1010, obtaining at least one first query message based on at least one first level, where each of the at least one first query message corresponds to one of the at least one first level.

The step S1010 is similar as step S910 shown in FIG. 9, which is not repeated herein for brevity.

S1020, sending a first sensing result, where the first sensing result includes at least one piece of first sensed data and/or at least one first sensing semantic.

The step S1020 is similar as step S920 shown in FIG. 9, which is not repeated herein for brevity.

S1030, obtaining at least one second query message based on at least one second level, where each of the at least one second query message corresponds to one of the at least one second level, and for each of one or more second query messages of the at least one second query message, a second level is higher than a first level for a corresponding first query message in the at least one first query message.

In details, after the first sensing result is sent, at least one second query message may further be obtained, each of which corresponds to one second level. Moreover, in the at least one second query message, there is one or more second messages, each of which corresponds to one first query message in the at least one first query message, and the second level for each of the one or more second query message is higher than the first level for its corresponding first query message. Herein, a second query message corresponding to a first query message refers to that the first query message for a task 1 and the second query message for a task 2 have a certain relationship such as progressive relationship, or a first query message for a modality 1 and a second query message for a modality 2 have a certain relationship such as progressive relationship, or a first query message for a combination 1 of a task and a modality and a second query message for a combination 2 of a task and a modality have a certain relationship such as progressive relationship. Optionally, the above task 1 and the above task 2 could be the same task or the different tasks, the above modality 1 and the above modality 2 could be the same modality or the different modalities, or the above combination 1 of the task and the modality and the above combination 2 of the task and the modality could be the same combination or the different combinations. For example, when the above task 1 and the above task 2 are the same task, the corresponding query messages could be the query messages of different granularities. It is noted that the above relationships are only the optional example, and other possible relationships could also be included, which is not limited herein. Moreover, when multiple second query messages are obtained, the multiple second query messages may include one or more query messages each having a corresponding first query message and one or more query messages not having a corresponding first query message.

S1040, sending a second sensing result, where the second sensing result includes at least one piece of second sensed data and/or at least one second sensing semantic.

In details, the first apparatus may send the second sensing result to the second apparatus, where the second sensing result includes at least one piece of first sensed data and/or at least one first sensing semantic. The procedure is similar as step S920 shown in FIG. 9, which is not repeated herein for brevity.

In a possible implementation, the each of one or more second query messages is a fine grained query of the corresponding one in the at least one first query message.

In a possible implementation, each of one or more pieces of second sensed data of the at least one piece of second sensed data is a piece of fine grained sensed data of a corresponding piece of first sensed data in the at least one piece of first sensed data or a piece of fine grained sensed data of a corresponding first sensing semantic in the at least one first sensing semantic, and/or each of one or more second sensing semantics of the at least one second sensing semantic is a fine grained sensing semantic of a corresponding piece of first sensed data in the at least one piece of first sensed data or a fine grained sensing semantic of a corresponding first sensing semantic in the at least one first sensing semantic.

In other words, in the at least one piece of second sensed data, there is one or more pieces of second sensed data and/or second sensing semantics each of which corresponds to one piece of first sensed data in the at least one piece of first sensing data or one first sensing semantic in the at least one sensing semantic included in the first sensing result, and each of which is a piece of fine grained sensed data or semantic of its corresponding piece of first sensed data or corresponding first sensing semantic. Herein, a second sensed data/second sensing semantic corresponding to a first sensed data/first sensing semantic refers to that the first sensed data/first sensing semantic for a task 1 and a second sensed data/second sensing semantic for a task 2 have a certain relationship such as progressive relationship, or a first sensed data/first sensing semantic for a modality 1 and a second sensed data/second sensing semantic for a modality 2 have a certain relationship such as progressive relationship, or a first sensed data/first sensing semantic for a combination 1 of a task and a modality and a second sensed data/second sensing semantic for a combination 2 of a task and a modality have a certain relationship such as progressive relationship. It is noted that the above relationships are only the optional example, and other possible relationships could also be included, which is not limited herein.

Because a second round of query may be performed after the first round of query, thereby query could be conducted progressively based on hierarchical levels of queries, and sensing results would become finer and finer. In another example embodiment, after the second round of query, a third round of query may further be performed according to actual demands, which is not limited herein.

In brief, query may be conducted progressively. The central device can broadcast or multi-cast or unicast query messages of different levels to the sensing device in several rounds, so that the sensing device can obtain the query messages of different levels. Query messages can be given at different levels, e.g., a low level/coarse level query message for initial query (possible with shorter length), and a high level query message for subsequent fine grained query (possible longer length).

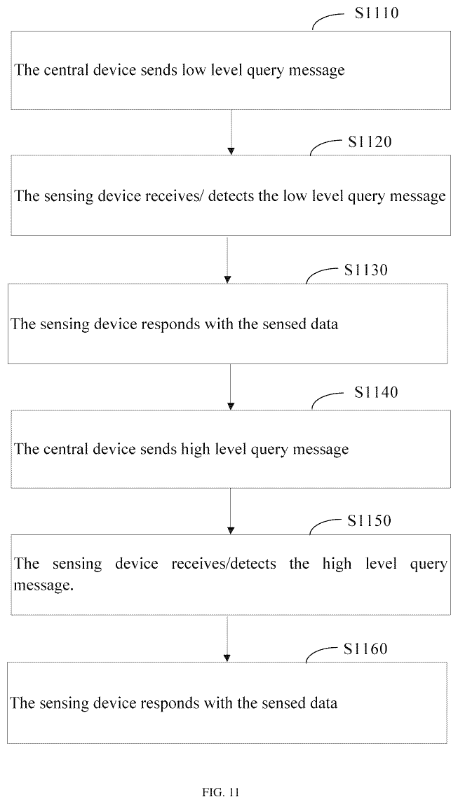

FIG. 11 is another schematic flowchart of a sensing communication method according to one or more example embodiments of the present disclosure. The procedure of the sensing communication method may include at least one of the following steps:
S1110: the central device sends low level query message;
S1120: the sensing device receives/detects the low level query message;
S1130: the sensing device responds with the sensed data;
S1140: the central device sends high level query message;
S1150: the sensing device receives/detects the high level query message.
S1160: the sensing device responds with the sensed data.

The previous processes can go through several rounds, from low levels to high levels. As a result, the central device can gradually obtain the progressive fusion results based on hierarchical levels of queries and responses.

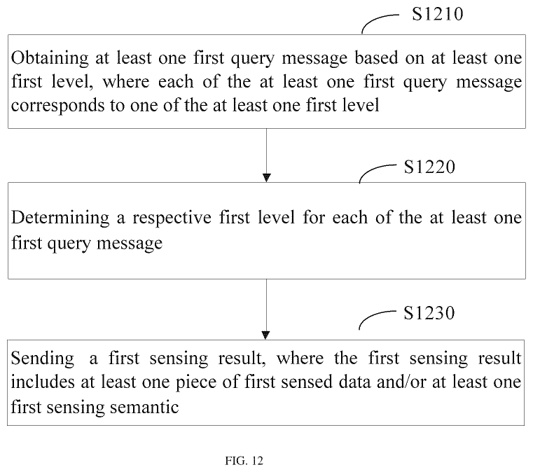

FIG. 12 is another schematic flowchart of a sensing communication method according to one or more example embodiments of the present disclosure. In a possible implementation, as shown in FIG. 12, the method can include the following steps.

S1210, obtaining at least one first query message based on at least one first level, where each of the at least one first query message corresponds to one of the at least one first level.

The step S1210 is similar as step S910 shown in FIG. 9, which is not repeated herein for brevity.

S1220, determining a respective first level for each of the at least one first query message.

Specifically, the first level for the first query message can be carried in the first query message, so that the first apparatus can determine the first level for the first query message based on the first query message sent from the second apparatus, or, the first apparatus can determine the first level for the first query message locally based on its processing capability, available resources, etc., which is not limited herein.

S1230, sending a first sensing result, where the first sensing result includes at least one piece of first sensed data and/or at least one first sensing semantic.

The step S1230 is similar as step S920 shown in FIG. 9, which is not repeated herein for brevity.

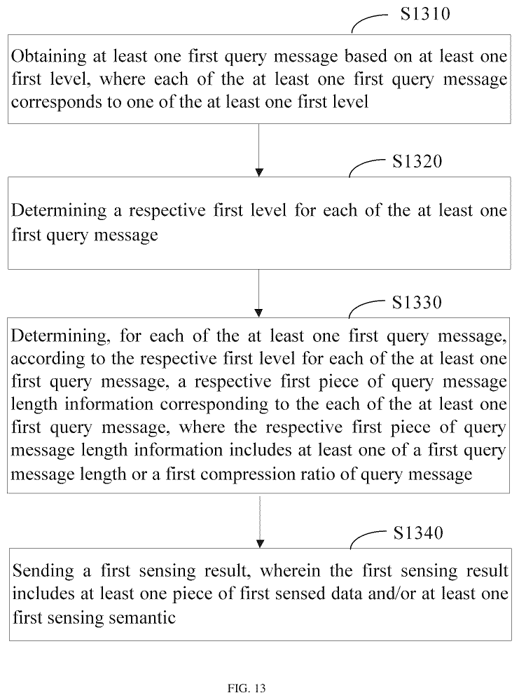

FIG. 13 is another schematic flowchart of a sensing communication method according to one or more example embodiments of the present disclosure. In a possible implementation, as shown in FIG. 13, the method can include the following steps.

S1310, obtaining at least one first query message based on at least one first level, where each of the at least one first query message corresponds to one of the at least one first level.

The step S1310 is similar as step S1210 shown in FIG. 12, which is not repeated herein for brevity.

S1320, determining a respective first level for each of the at least one first query message.

The step S1320 is similar as step S1220 shown in FIG. 12, which is not repeated herein for brevity.

S1330, determining, for each of the at least one first query message, according to the respective first level for each of the at least one first query message, a respective first piece of query message length information corresponding to the each of the at least one first query message, where the respective first piece of query message length information includes at least one of a first query message length or a first compression ratio of query message.

Specifically, after the first apparatus determines a respective first level for each of the at least one first query message, the first apparatus determines, for each of the at least one first query message, according to the respective first level for each of the at least one first query message, a respective first piece of query message length information corresponding to the each of the at least one first query message, where the respective first piece of query message length information includes at least one of a first query message length or a first compression ratio of query message. Therefore, the query message length information may be determined for each first query message according to the first level corresponding thereto, so that the first query message could be obtained based on the query message length information.

Further, in a possible implementation, the step S1330 could be that for each of the at least one first query message, according to the respective first level for each of the at least one first query message and a correspondence between levels and pieces of query message length information, the respective first piece of query message length information corresponding to the each of the at least one first query message is determined, under the circumstance that the correspondence is obtained, where each of the pieces of query message length information includes at least one of query message length or the compression ratio of query message and the pieces of query message length information includes the first piece of query message length information.

In details, the first apparatus may obtain a correspondence between levels and pieces of query message length information, where each of the pieces of query message length information includes at least one of query message length or the compression ratio of query message and the pieces of query message length information includes the first piece of query message length information. Then, for each of the at least one first query message, a first piece of query message length information corresponding to that first query message may be determined according to its first level and the obtained correspondence.

S1340, sending a first sensing result, where the first sensing result includes at least one piece of first sensed data and/or at least one first sensing semantic.

The step S1340 is similar as step S1230 shown in FIG. 12, which is not repeated herein for brevity.

In a possible implementation, the at least one first level includes a first query semantic level and/or a first query token level.

In details, the query message could include a query semantic and/or a query token. Correspondingly, the level could include the query semantic level and/or the query token level.

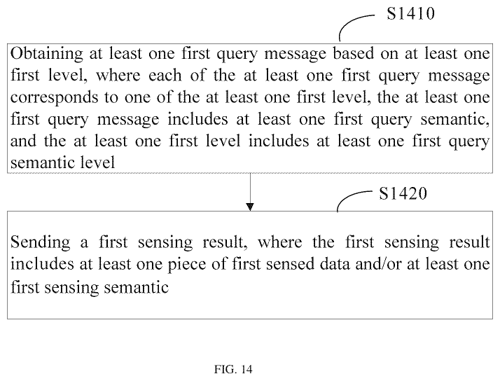

FIG. 14 is another schematic flowchart of a sensing communication method according to one or more example embodiments of the present disclosure. In a possible implementation, when the at least one first query message includes at least one first query semantic, the at least one first level includes at least one first query semantic level. Then, as shown in FIG. 14, the method can include the following steps.

S1410, obtaining at least one first query message based on at least one first level, where each of the at least one first query message corresponds to one of the at least one first level, the at least one first query message includes at least one first query semantic, and the at least one first level includes at least one first query semantic level.

In details, the first apparatus may obtain the at least one first query semantic from the second apparatus based on the at least one first query semantic level, where each of the at least one first query semantic corresponds to one of the at least one first query semantic level. In other words, each first query semantic has its respective first query semantic level. It is noted that when the first apparatus obtains the at least one query semantic, other query messages of other types may also be obtained, for example, a query token.

In a possible implementation, there is a correspondence between each of the at least one first query semantic level and a first piece of query semantic length information respectively, where the first piece of query semantic length information includes at least one of a first query semantic length or a first compression ratio of query semantic. For example, for level 1, the first query semantic length could be 64 bits and the compression ratio could be 1000. Further, the first query semantic length would be represented by a value or a range. For example, for level 1, the first query semantic length could be 64 bits or [32, 64) bits. The correspondence can also include other parameters, which is not limited herein.

In a possible implementation, the correspondence between levels and pieces of query semantic length information is stored in a table. That is, a table can be defined for different query semantic levels, query semantic lengths, or even compression ratio of query semantics. More specifically, the correspondence between different query semantic levels, and query semantic lengths and/or compression ratios of query semantics can be defined in a table. Some examples are given in following Table 5, Table 6, and Table 7.

TABLE 5
different query semantic lengths represented by value

| Level | Query semantic length |
|---|---|
| 1 | 64 bits |
| 2 | 128 bits |
| 3 | 512 bits |

Table 5 shows an example correspondence between different query semantic levels and different query semantic lengths, where the query semantic lengths are represented by values. The query semantic lengths could be in the unit of bit, which is not limited herein. For example, level 1 corresponds to a query semantic length of 64 bits, level 2 corresponds to a query semantic length of 128 bits, and level 3 corresponds to a query semantic length of 512 bits, and so on. It should be noted that the number of query semantic levels and corresponding query semantic lengths is not limited by the above Table 5, which could include less levels, or more levels, such as level 4, level 5.

TABLE 6
different query semantic lengths represented by range

| Level | Range of query semantic length | |
|---|---|---|
| 1 | [32, 64) | bits |
| 2 | [64, 128) | bits |
| 3 | [128, 512) | bits |

Table 6 shows an example correspondence between different query semantic levels and different query semantic lengths, where the query semantic lengths are represented by ranges. The query semantic lengths could be in the unit of bit, which is not limited herein. For example, level 1 corresponds to a query semantic length in a range of [32, 64) bits, level 2 corresponds to a query semantic length in a range of [64, 128) bits, and level 3 corresponds to a query semantic length in a range of [128, 512) bits, and so on. It should be noted that the number of query semantic levels and corresponding query semantic lengths is not limited by the above Table 6, which could include less levels, or more levels, such as level 4, level 5.

TABLE 7
different compression ratios of query semantic

| Level | Compression ratio of query semantic |
|---|---|
| 1 | 1000 |
| 2 | 500 |
| 3 | 200 |
| 4 | 50 |

Table 7 shows an example correspondence between different query semantic levels and different compression ratios of query semantic. For example, level 1 corresponds to a compression ratio of query semantic of 1000, level 2 corresponds to a compression ratio of query semantic of 500, level 3 corresponds to a compression ratio of query semantic of 200, and level 4 corresponds to a compression ratio of query semantic of 50, and so on. It should be noted that the number of levels and corresponding compression ratios of query semantic is not limited by the above Table 7, which could also include less levels, or more levels, such as level 5, level 6.

Furthermore, the above Table 5, Table 6, Table 7, and/or other tables could be combined in one table, which is not shown herein for brevity.

In a possible implementation, the correspondence is predefined in a protocol or is obtained from the second apparatus. For example, the first apparatus, i.e. the sensing device, can obtain the correspondence locally if the correspondence has been predefined in the sensing device, for example, as specified in a protocol, or, can obtain the correspondence from the central device, which is not limited herein.

In a possible implementation, each of the at least one first query semantic may correspond to a task, a modality, or a combination of a task and a modality, and each of the at least one task, each of the at least one modality, or each of at least one combination of the task and the modality may have its respective correspondence between query semantic levels and pieces of query semantic length information. For example, task 1 corresponds to a first correspondence between query semantic levels and pieces of query semantic length information, task 2 corresponds to a second correspondence between query semantic levels and pieces of query semantic length information, task 3 corresponds to a third correspondence between query semantic levels and pieces of query semantic length information and so on, where different tasks may have same or different correspondences. More specifically, task 1 “find moving obstacles” and task 2 “localize incoming pedestrians” may have same or different correspondences. Different modalities may also have same or different correspondences, and the difference combinations of the task and the modality may also have same or different correspondences, which are not repeated herein for brevity.

Multiple tables can be defined for multiple tasks/modalities. Some examples are given in following Table 8-1 and Table 8-2.

TABLE 8-1
Table for task 1

| Level | Query semantic length for task 1 |
|---|---|
| 1 | 64 bits |
| 2 | 128 bits |
| 3 | 512 bits |

TABLE 8-2
Table for task 2

| Level | Query semantic length for task 2 |
|---|---|
| 1 | 50 bits |
| 2 | 100 bits |
| 3 | 300 bits |
| 4 | 500 bits |

Table 8-1 and Table 8-2 are two tables that may be defined for task 1 and task 2, respectively. However, multiple tables can also be defined for multiple modalities or multiple combinations of task and modality, which is not shown herein for brevity. Further, each of Table 8-1 and Table 8-2 shows a correspondence between different query semantic levels and different query semantic lengths represented by values for a specific task. However, a correspondence between different query semantic levels and different query semantic lengths represented by ranges or different compression ratios of query semantic can also be defined, which is not shown herein for brevity.

Furthermore, the above Table 8-1, Table 8-2, and/or other tables could be combined in one table, which is not shown herein for brevity.

In a possible implementation, the at least one first query semantic includes multiple first query semantics, and first query semantic levels for at least two first query semantics of the multiple first query semantics are different. In other words, the first apparatus may obtain multiple first query semantics of different levels from the second apparatus, where the multiple first query semantics can be given at different levels, for example, the multiple first query semantics may include a low level query semantic and a high level query semantic. For example, the multiple first query semantics could include Semantic 1, Semantic 2, Semantic 3, where the Semantic 1 could correspond to level 1, the Semantic 2 could correspond to level 2, and the Semantic 3 could correspond to level 3. In another example, the multiple first query semantics could include Semantic 1, Semantic 2, Semantic 3, where the Semantic 1 could correspond to level 1, the Semantic 2 could correspond to level 1, and the Semantic 3 could correspond to level 2. In still another example, the multiple first query semantics could include Semantic 1, Semantic 2, Semantic 3, where the Semantic 1 could correspond to level 2, the Semantic 2 could correspond to level 3, and the Semantic 3 could correspond to level 3. The above examples are only for illustration, which are not limited herein.

In brief, for one round of query, the central device can broadcast or multi-cast or unicast query semantics of different levels to the sensing device(s), so that the sensing device(s) can obtain the query semantics of different levels. The multiple query semantics can be given at different levels

S1420, sending a first sensing result, where the first sensing result includes at least one piece of first sensed data and/or at least one first sensing semantic.

The step S1420 is similar as step S920 shown in FIG. 9, which is not repeated herein for brevity.

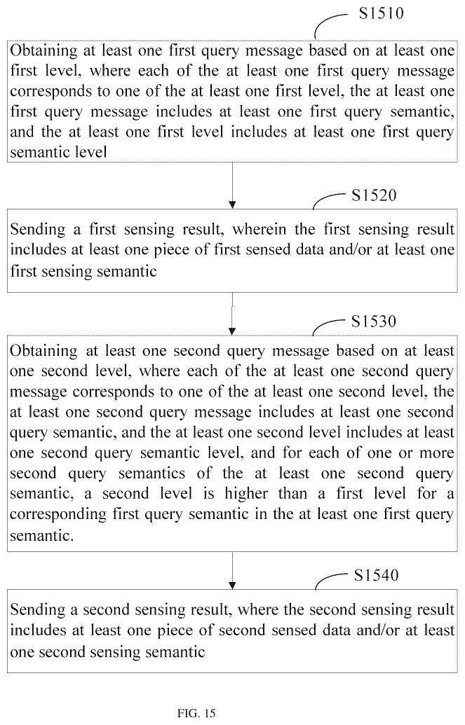

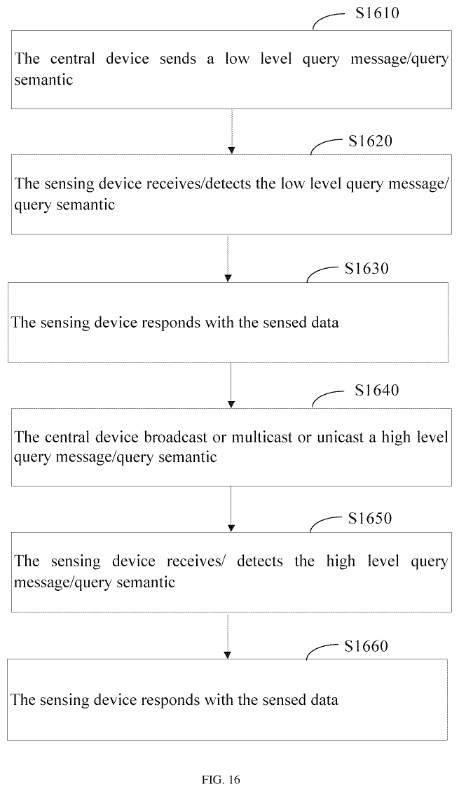

FIG. 15 is another schematic flowchart of a sensing communication method according to one or more example embodiments of the present disclosure. In a possible implementation, as shown in FIG. 15, the method can include the following steps.

S1510, obtaining at least one first query message based on at least one first level, where each of the at least one first query message corresponds to one of the at least one first level, the at least one first query message includes at least one first query semantic, and the at least one first level includes at least one first query semantic level.

The step S1510 is similar as step S1410 shown in FIG. 14, which is not repeated herein for brevity.

S1520, sending a first sensing result, where the first sensing result includes at least one piece of first sensed data and/or at least one first sensing semantic.

The step S1520 is similar as step S1420 shown in FIG. 14, which is not repeated herein for brevity.

S1530, obtaining at least one second query message based on at least one second level, where each of the at least one second query message corresponds to one of the at least one second level, the at least one second query message includes at least one second query semantic, and the at least one second level includes at least one second query semantic level, and for each of one or more second query semantics of the at least one second query semantic, a second level is higher than a first level for a corresponding first query semantic in the at least one first query semantic.

In details, after the first sensing result is sent, at least one second query semantic may further be obtained, each of which corresponds to one second query semantic level. Moreover, in the at least one second query semantic, there is one or more second semantics, each of which corresponds to one first query semantic in the at least one first query semantic, and the second query semantic level for each of the one or more second query semantic is higher than the first query semantic level for its corresponding first query semantic. Herein, a second query semantic corresponding to a first query semantic refers to that the first query semantic for a task 1 and the second query semantic for a task 2 have a certain relationship such as progressive relationship, or a first query semantic for a modality 1 and a second query semantic for a modality 2 have a certain relationship such as progressive relationship, or a first query semantic for a combination 1 of a task and a modality and a second query semantic for a combination 2 of a task and a modality have a certain relationship such as progressive relationship. Optionally, the above task 1 and the above task 2 could be the same task or the different tasks, the above modality 1 and the above modality 2 could be the same modality or the different modalities, or the above combination 1 of the task and the modality and the above combination 2 of the task and the modality could be the same combination or the different combinations. For example, when the above task 1 and the above task 2 are the same task, the corresponding query semantics could be the query semantic of different granularities. It is noted that the above relationships are only the optional example, and other possible relationships could also be included, which is not limited herein. Moreover, when multiple second query semantics are obtained, the multiple second query semantics may include one or more query semantics each having a corresponding first query semantic and one or more query semantics not having a corresponding first query semantic.

S1540, sending a second sensing result, where the second sensing result includes at least one piece of second sensed data and/or at least one second sensing semantic.

The step S1540 is similar as step S1040 shown in FIG. 10, which is not repeated herein for brevity.

In a possible implementation, the each of one or more second query semantics is a fine grained query of the corresponding one in the at least one first query semantic.

Because a second round of query may be performed after the first round of query, thereby query could be conducted progressively based on hierarchical levels of queries, and sensing results would become finer and finer. In another possible implementation, after the second round of query, a third round of query may further be performed according to actual demands, which is not limited herein.

In brief, query may be conducted progressively. The central device can broadcast or multi-cast or unicast different levels of query semantics. Each semantic query/query Message can be given at different levels, e.g., low level/coarse level semantic for initial query (possible with shorter length), and high level semantic for subsequent fine grained query (possible longer length). More specifically, the central device can broadcast or multi-cast or unicast query semantics of different query semantic levels to the sensing device in several rounds, so that the sensing device can obtain the query semantics of different query semantic levels. Query semantics can be given at different query semantic levels, e.g., a low query semantic level/coarse query semantic level query semantic for initial query (possible with shorter length), and a high query semantic level query semantic for subsequent fine grained query (possible longer length).

FIG. 16 is another schematic flowchart of a sensing communication method according to one or more example embodiments of the present disclosure. The procedure may include at least one of the following steps.

S1610: the central device sends low level query Message/query semantic.

In details, the central device broadcasts or multicasts or unicasts low level query Message/query semantic.

The query Message/query semantic q can be selected from low level/coarse level queries. For example, level 1 or other low levels.

Optionally, the query Message can include multiple query semantics: {q₁, q₂, . . . qₙ}, where n is the number of query semantics. And the queries can be for single task, single modality, or multiple tasks or multiple modalities.

S1620: the sensing device receives/detects the low level query Message/query semantic.

Based on the sensing environment/sensed data, sensing device obtains its sensing semantic o. The sensing device compares and scores the relevance between the sensing semantic o and the query semantic q; if the sensing device tells that the sensing semantic o is close to, or matches any query semantic q, then sensing device will response the sensed data and/or the sensing semantics.

S1630: the sensing device responds with the sensed data.

The sensed data from sensing device can include matched raw sensed data and/or sensing semantics in step 1620.

Step 1640: the central device broadcast or multicast or unicast higher level query Message/query semantic.

After receiving the sensed data from the sensing device, the central device can send higher level (fine grained) query Message/query semantic q′ to the sensing device for further query.

Step 1650: the sensing device receives/detects the higher level query Message/query semantic.

Based on the sensing environment/sensed data, the sensing device obtains its sensing semantic o′. The sensing device compares and scores the relevance between the sensing semantic o′ and the fine grained query semantic q′; if the sensing device tells that the sensing semantic o′ is close to, or matches any query semantic q′, then sensing device will response the sensed data and/or the sensing semantics.

Step 1660: the sensing device responds with the sensed data.

The sensed data from sensing device can include matched raw sensed data and/or sensing semantics in step 1650. It can be a high level (fine grained) sensed data/sensing semantics compared to the response in step 1630.

The previous processes can go through several rounds, from lower levels to higher levels. As a result, the central device can gradually obtain the progressive fusion results based on hierarchical levels of queries and responses.

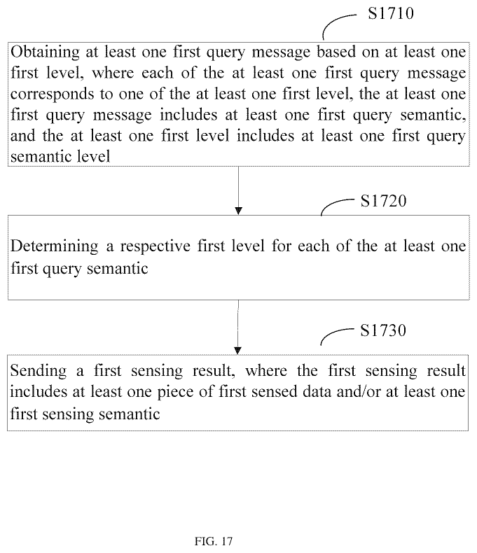

FIG. 17 is another schematic flowchart of a sensing communication method according to one or more example embodiments of the present disclosure. In a possible implementation, as shown in FIG. 17, the method can include the following steps.

S1710, obtaining at least one first query message based on at least one first level, where each of the at least one first query message corresponds to one of the at least one first level, the at least one first query message includes at least one first query semantic, and the at least one first level includes at least one first query semantic level.

The step S1710 is similar as step S1410 shown in FIG. 14, which is not repeated herein for brevity.

S1720, determining a respective first query semantic level for each of the at least one first query semantic.

Specifically, the first query semantic level for the first query semantic can be carried in the first query semantic, so that the first apparatus can determine the first query semantic level for the first query semantic based on the first query semantic sent from the second apparatus, or, the first apparatus can determine the first query semantic level for the first query semantic locally based on its processing capability, available resources, etc., which is not limited herein.

S1730, sending a first sensing result, where the first sensing result includes at least one piece of first sensed data and/or at least one first sensing semantic.

The step S1730 is similar as step S1420 shown in FIG. 14, which is not repeated herein for brevity.

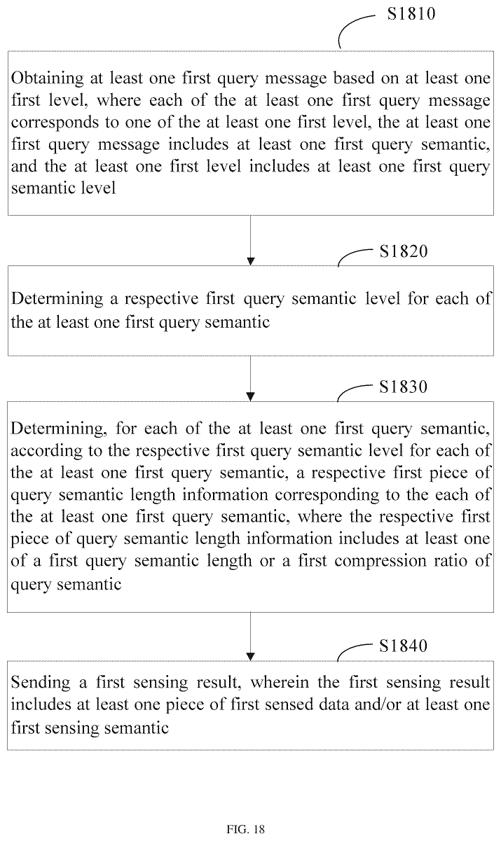

FIG. 18 is another schematic flowchart of a sensing communication method according to one or more example embodiments of the present disclosure. In a possible implementation, as shown in FIG. 18, the method can include the following steps.

S1810, obtaining at least one first query message based on at least one first level, where each of the at least one first query message corresponds to one of the at least one first level, the at least one first query message includes at least one first query semantic, and the at least one first level includes at least one first query semantic level.

The step S1810 is similar as step S1710 shown in FIG. 17, which is not repeated herein for brevity.

S1820, determining a respective first query semantic level for each of the at least one first query semantic.

The step S1820 is similar as step S1720 shown in FIG. 17, which is not repeated herein for brevity.

S1830, determining, for each of the at least one first query semantic, according to the respective first query semantic level for each of the at least one first query semantic, a respective first piece of query semantic length information corresponding to the each of the at least one first query semantic, where the respective first piece of query semantic length information includes at least one of a first query semantic length or a first compression ratio of query semantic.

Specifically, after the first apparatus determines a respective first query semantic level for each of the at least one first query semantic, the first apparatus determines, for each of the at least one first query semantic, according to the respective first query semantic level for each of the at least one first query semantic, a respective first piece of query semantic length information corresponding to the each of the at least one first query semantic, where the respective first piece of query semantic length information includes at least one of a first query semantic length or a first compression ratio of query semantic. Therefore, the query semantic length information may be determined for each first query semantic according to the first query semantic level corresponding thereto, so that the first query semantic could be obtained based on the query semantic length information.

Further, in a possible implementation, the step S1830 could be that for each of the at least one first query semantic, according to the respective first query semantic level for each of the at least one first query semantic and a correspondence between query semantic levels and pieces of query semantic length information, the respective first piece of query semantic length information corresponding to the each of the at least one first query semantic is determined, under the circumstance that the correspondence is obtained, where each of the pieces of query semantic length information includes at least one of query semantic length or the compression ratio of query semantic and the pieces of query semantic length information includes the first piece of query semantic length information.

In details, the first apparatus may obtain a correspondence between query semantic levels and pieces of query semantic length information, where each of the pieces of query semantic length information includes at least one of query semantic length or the compression ratio of query semantic and the pieces of query semantic length information includes the first piece of query semantic length information. Then, for each of the at least one first query semantic, a first piece of query semantic length information corresponding to that first query semantic may be determined according to its first query semantic level and the obtained correspondence.

S1840, sending a first sensing result, where the first sensing result includes at least one piece of first sensed data and/or at least one first sensing semantic.

The step S1840 is similar as step S1730 shown in FIG. 17, which is not repeated herein for brevity.

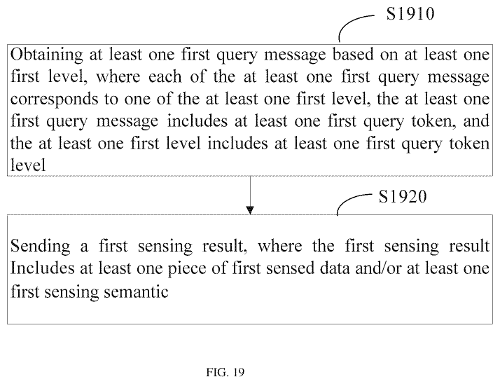

FIG. 19 is another schematic flowchart of a sensing communication method according to one or more example embodiments of the present disclosure. In a possible implementation, when the at least one first query message includes at least one first query token, the at least one first level includes at least one first query token level. Then, as shown in FIG. 19, the method can include the following steps.

S1910, obtaining at least one first query message based on at least one first level, where each of the at least one first query message corresponds to one of the at least one first level, the at least one first query message includes at least one first query token, and the at least one first level includes at least one first query token level.

In details, the first apparatus may obtain the at least one first query token from the second apparatus based on the at least one first query token level, where each of the at least one first query token corresponds to one of the at least one first query token level. In other words, each first query token has its respective first query token level. It is noted that when the first apparatus obtains the at least one query token, other query messages of other types may also be obtained, for example, a query semantic.

In a possible implementation, there is a correspondence between each of the at least one first query token level and a first piece of query token length information respectively, where the first piece of query token length information includes at least one of a first query token length or a first compression ratio of query token. For example, for level 1, the first query token length could be 64 bits and the compression ratio could be 1000. Further, the first query token length would be represented by a value or a range. For example, for level 1, the first query token length could be 64 bits or [32, 64) bits. The correspondence can also include other parameters, which is not limited herein.

In a possible implementation, the correspondence between levels and pieces of query token length information is stored in a table. That is, a table can be defined for different query token levels, query token lengths, or even compression ratio of query tokens. More specifically, the correspondence between different query token levels, and query token lengths and/or compression ratios of query tokens can be defined in a table. Some examples are given in following Table 9, Table 10, and Table 11.

TABLE 9
different query token lengths represented by value

| Level | Query token length |
|---|---|
| 1 | 16 bits |
| 2 | 32 bits |
| 3 | 64 bits |

Table 9 shows an example correspondence between different query token levels and different query token lengths, where the query token lengths are represented by values. The query token lengths could be in the unit of bit, which is not limited herein. For example, level 1 corresponds to a query token length of 16 bits, level 2 corresponds to a query token length of 32 bits, and level 3 corresponds to a query token length of 64 bits, and so on. It should be noted that the number of query token levels and corresponding query token lengths is not limited by the above Table 9, which could include less levels, or more levels, such as level 4, level 5.

TABLE 10
different query token lengths represented by range

| Level | Range of query token length |
|---|---|
| 1 | [8, 16) bits |
| 2 | [16, 32) bits |
| 3 | [32, 64) bits |

Table 10 shows an example correspondence between different query token levels and different query token lengths, where the query token lengths are represented by ranges. The query token lengths could be in the unit of bit, which is not limited herein. For example, level 1 corresponds to a query token length in a range of [8, 16) bits, level 2 corresponds to a query token length in a range of [16, 32) bits, and level 3 corresponds to a query token length in a range of [32, 64) bits, and so on. It should be noted that the number of query token levels and corresponding query token lengths is not limited by the above Table 10, which could include less levels, or more levels, such as level 4, level 5.

TABLE 11
different compression ratios of query token

| Level | Compression ratio of query token |
|---|---|
| 1 | 1000 |
| 2 | 600 |
| 3 | 300 |

Table 11 shows an example correspondence between different query token levels and different compression ratios of query token. For example, level 1 corresponds to a compression ratio of query token of 1000, level 2 corresponds to a compression ratio of query token of 600, and level 3 corresponds to a compression ratio of query token of 300, and so on. It should be noted that the number of levels and corresponding compression ratios of query token is not limited by the above Table 11, which could also include less levels, or more levels, such as level 4, level 5.

Furthermore, the above Table 9, Table 10, Table 11, and/or other tables could be combined in one table, which is not shown herein for brevity.

In a possible implementation, the correspondence is predefined in a protocol or is obtained from the second apparatus. For example, the first apparatus, i.e. the sensing device, can obtain the correspondence locally if the correspondence has been predefined in the sensing device, for example, as specified in a protocol, or, can obtain the correspondence from the central device, which is not limited herein.

In a possible implementation, each of the at least one first query token may correspond to a task, a modality, or a combination of a task and a modality, and each of the at least one task, each of the at least one modality, or each of at least one combination of the task and the modality may have its respective correspondence between query token levels and pieces of query token length information. For example, task 1 corresponds to a first correspondence between query token levels and pieces of query token length information, task 2 corresponds to a second correspondence between query token levels and pieces of query token length information, task 3 corresponds to a third correspondence between query token levels and pieces of query token length information and so on, where different tasks may have same or different correspondences. More specifically, task 1 “find moving obstacles” and task 2 “localize incoming pedestrians” may have same or different correspondences. Different modalities may also have same or different correspondences, and the difference combinations of the task and the modality may also have same or different correspondences, which are not repeated herein for brevity.

Multiple tables can be defined for multiple tasks/modalities. Some examples are given in following Table 12-1 and Table 12-2.

TABLE 12-1
Table for task 1

| Level | Query token length for task 1 |
|---|---|
| 1 | 16 bits |
| 2 | 32 bits |
| 3 | 64 bits |

TABLE 12-2
Table for task 2

| Level | Query token length for task 2 |
|---|---|
| 1 | 8 bits |
| 2 | 10 bits |
| 3 | 12 bits |
| 4 | 16 bits |

Table 12-1 and Table 12-2 are two tables that may be defined for task 1 and task 2, respectively. However, multiple tables can also be defined for multiple modalities or multiple combinations of task and modality, which is not shown herein for brevity. Further, each of Table 12-1 and Table 12-2 shows a correspondence between different query token levels and different query token lengths represented by values for a specific task. However, a correspondence between different query token levels and different query token lengths represented by ranges or different compression ratios of query token can also be defined, which is not shown herein for brevity.

Furthermore, the above Table 12-1, Table 12-2, and other tables could be combined in one table, which is not shown herein for brevity.

In a possible implementation, the at least one first query token includes multiple first query tokens, and first query token levels for at least two first query tokens of the multiple first query tokens are different. In other words, the first apparatus may obtain multiple first query tokens of different levels from the second apparatus, where the multiple first query tokens can be given at different levels, for example, the multiple first query tokens may include a low level query token and a high level query token. For example, the multiple first query tokens could include Token 1, Token 2, Token 3, where the Token 1 could correspond to level 1, the Token 2 could correspond to level 2, and the Token 3 could correspond to level 3. In another example, the multiple first query tokens could include Token 1, Token 2, Token 3, where the Token 1 could correspond to level 1, the Token 2 could correspond to level 1, and the Token 3 could correspond to level 2. In still another example, the multiple first query tokens could include Token 1, Token 2, Token 3, where the Token 1 could correspond to level 2, the Token 2 could correspond to level 3, and the Token 3 could correspond to level 3. The above examples are only for illustration, which are not limited herein.

In brief, for one round of query, the central device can broadcast or multi-cast or unicast query tokens of different levels to the sensing device(s), so that the sensing device(s) can obtain the query tokens of different levels. The multiple query tokens can be given at different levels.

S1920, sending a first sensing result, where the first sensing result includes at least one piece of first sensed data and/or at least one first sensing semantic.

The step S1920 is similar as step S920 shown in FIG. 9, which is not repeated herein for brevity.

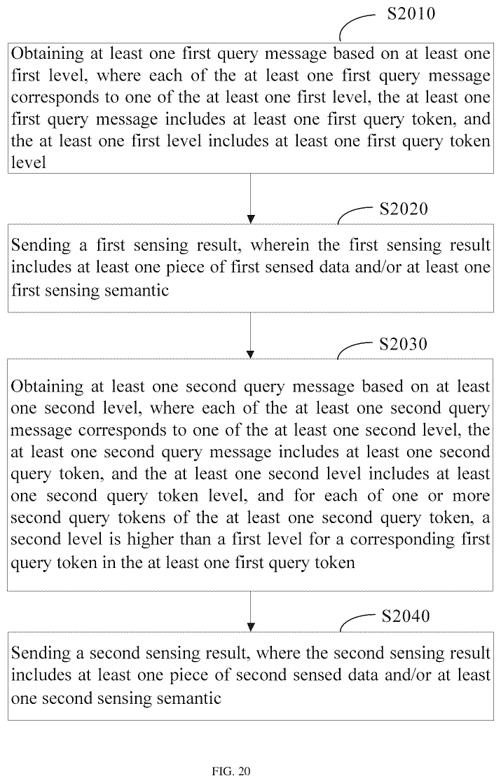

FIG. 20 is another schematic flowchart of a sensing communication method according to one or more example embodiments of the present disclosure. In a possible implementation, as shown in FIG. 20, the method can include the following steps.

S2010, obtaining at least one first query message based on at least one first level, where each of the at least one first query message corresponds to one of the at least one first level, the at least one first query message includes at least one first query token, and the at least one first level includes at least one first query token level.

The step S2010 is similar as step S1910 shown in FIG. 19, which is not repeated herein for brevity.

S2020, sending a first sensing result, where the first sensing result includes at least one piece of first sensed data and/or at least one first sensing semantic.

The step S2020 is similar as step S1920 shown in FIG. 19, which is not repeated herein for brevity.

S2030, obtaining at least one second query message based on at least one second level, where each of the at least one second query message corresponds to one of the at least one second level, the at least one second query message includes at least one second query token, and the at least one second level includes at least one second query token level, and for each of one or more second query tokens of the at least one second query token, a second level is higher than a first level for a corresponding first query token in the at least one first query token.

In details, after the first sensing result is sent, at least one second query token may further be obtained, each of which corresponds to one second query token level. Moreover, in the at least one second query token, there is one or more second tokens, each of which corresponds to one first query token in the at least one first query token, and the second query token level for each of the one or more second query token is higher than the first query token level for its corresponding first query token. Herein, a second query token corresponding to a first query token refers to that the first query token for a task 1 and the second query token for a task 2 have a certain relationship such as progressive relationship, or a first query token for a modality 1 and a second query token for a modality 2 have a certain relationship such as progressive relationship, or a first query token for a combination 1 of a task and a modality and a second query token for a combination 2 of a task and a modality have a certain relationship such as progressive relationship. Optionally, the above task 1 and the above task 2 could be the same task or the different tasks, the above modality 1 and the above modality 2 could be the same modality or the different modalities, or the above combination 1 of the task and the modality and the above combination 2 of the task and the modality could be the same combination or the different combinations. For example, when the above task 1 and the above task 2 are the same task, the corresponding query tokens could be the query tokens of different granularities. It is noted that the above relationships are only the optional example, and other possible relationships could also be included, which is not limited herein. Moreover, when multiple second query tokens are obtained, the multiple second query tokens may include one or more query tokens each having a corresponding first query token and one or more query tokens not having a corresponding first query token.

S2040, sending a second sensing result, where the second sensing result includes at least one piece of second sensed data and/or at least one second sensing semantic.

The step S2040 is similar as step S1040 shown in FIG. 10, which is not repeated herein for brevity.

In a possible implementation, the each of one or more second query tokens is a fine grained query of the corresponding one in the at least one first query token.

Because a second round of query may be performed after the first round of query, thereby query could be conducted progressively based on hierarchical levels of queries, and sensing results would become finer and finer. In another possible implementation, after the second round of query, a third round of query may further be performed according to actual demands, which is not limited herein.

In brief, query may be conducted progressively. The central device can broadcast or multi-cast or unicast different levels of query tokens. Each query token can be given at different levels, e.g., low level/coarse level token for initial query (possible with shorter length), and high level token for subsequent fine grained query (possible longer length). More specifically, the central device can broadcast or multi-cast or unicast query tokens of different query token levels to the sensing device in several rounds, so that the sensing device can obtain the query tokens of different query token levels. Query tokens can be given at different levels, e.g., a low query token level/coarse query token level query token for initial query (possible with shorter length), and a high query token level query token for subsequent fine grained query (possible longer length).

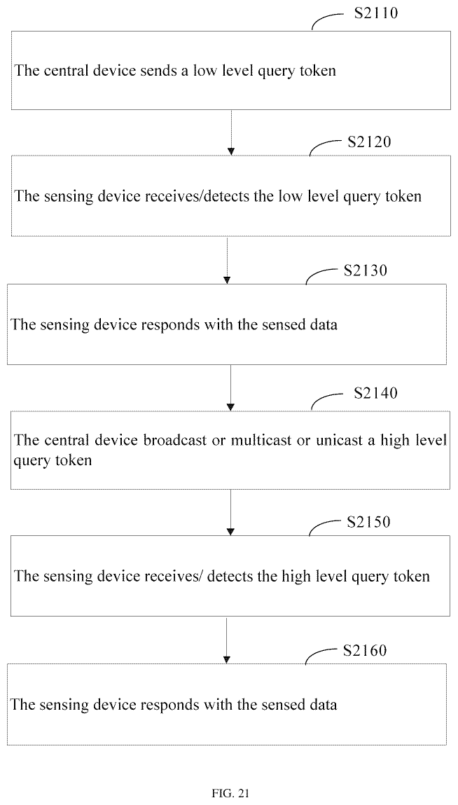

FIG. 21 is another schematic flowchart of a sensing communication method according to one or more example embodiments of the present disclosure. The procedure may include at least one of the following steps.

S2110: the central device sends low level query token.

In details, the central device broadcasts or multicasts or unicasts low level query token. The query token t can be selected from low level/coarse level queries. For example, level 1 or other low levels.

Optionally, multiple query tokens can be included: {t₁, t₂, . . . tₙ}, where n is the number of query tokens. And the queries can be for single task, single modality, or multiple tasks or multiple modalities.

S2120: the sensing device receives/detects the low level query token.

Based on the sensing environment/sensed data, sensing device obtains its sensing semantic o, and then tokenize the sensing semantic o to a sensing token c, e.g., based on a tokenization model. The sensing device compares and scores the relevance between the query token t and the sensing token c; if the sensing device tells that the sensing token is close to, or matches any query token, then sensing device will response the sensed data and/or the sensing semantics.

S2130: the sensing device responds with the sensed data.

The sensed data from sensing device can include matched raw sensed data and/or sensing semantics in S2120.

S2140: the central device broadcast or multicast or unicast higher level query token.

After receiving the sensed data from the sensing device, the central device can send higher level (fine grained) query token t′ to the sensing device for further query.

S2150: the sensing device receives/detects the higher level query token.

Based on the sensing environment/sensed data, sensing device obtains its sensing semantic o′, and then tokenize the sensing semantic o′ to a sensing token c′, e.g., based on a tokenization model. The sensing device compares and scores the relevance between the fine grained query token t′ and the sensing token c′; if the sensing device tells that the sensing token is close to, or matches any query token, then sensing device will response the sensed data and/or the sensing semantics.

S2160: the sensing device responds with the sensed data.

The sensed data from sensing device can include matched raw sensed data and/or sensing semantics in S2150. It can be a high level (fine grained) sensed data/sensing semantics compared to the response in S2130.

The previous processes can go through several rounds, from lower levels to higher levels. As a result, the central device can gradually obtain the progressive fusion results based on hierarchical levels of queries and responses.

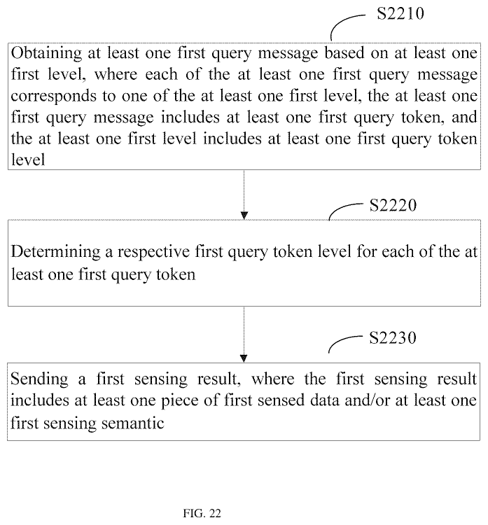

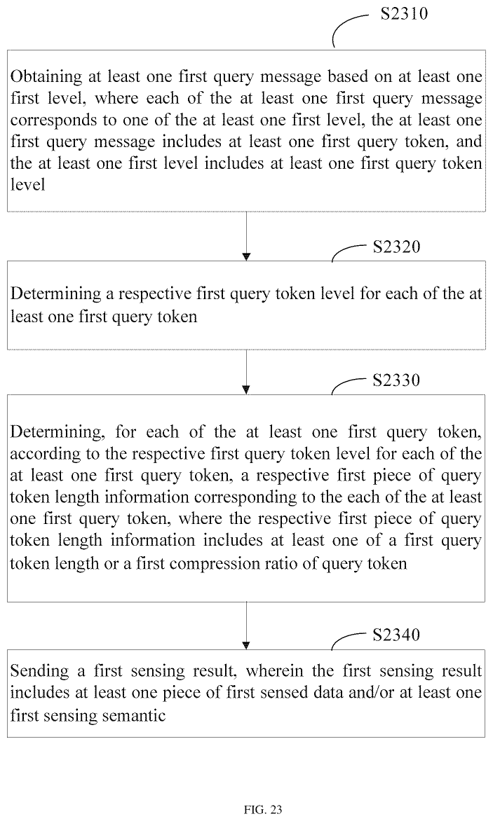

FIG. 22 is another schematic flowchart of a sensing communication method according to one or more example embodiments of the present disclosure. In a possible implementation, as shown in FIG. 22, the method can include the following steps.

S2210, obtaining at least one first query message based on at least one first level, where each of the at least one first query message corresponds to one of the at least one first level, the at least one first query message includes at least one first query token, and the at least one first level includes at least one first query token level.

The step S2210 is similar as step S1910 shown in FIG. 19, which is not repeated herein for brevity.

S2220, determining a respective first query token level for each of the at least one first query token.

Specifically, the first query token level for the first query token can be carried in the first query token, so that the first apparatus can determine the first query token level for the first query token based on the first query token sent from the second apparatus, or, the first apparatus can determine the first query token level for the first query token locally based on its processing capability, available resources, etc., which is not limited herein.

S2230, sending a first sensing result, where the first sensing result includes at least one piece of first sensed data and/or at least one first sensing semantic.

The step S2230 is similar as step S1920 shown in FIG. 19, which is not repeated herein for brevity.

FIG. 23 is another schematic flowchart of a sensing communication method according to one or more example embodiments of the present disclosure. In a possible implementation, as shown in FIG. 23, the method can include the following steps.

S2310, obtaining at least one first query message based on at least one first level, where each of the at least one first query message corresponds to one of the at least one first level, the at least one first query message includes at least one first query token, and the at least one first level includes at least one first query token level.

The step S2310 is similar as step S1910 shown in FIG. 19, which is not repeated herein for brevity.

S2320, determining a respective first query token level for each of the at least one first query token.

The step S2320 is similar as step S2220 shown in FIG. 22, which is not repeated herein for brevity.

S2330, determining, for each of the at least one first query token, according to the respective first query token level for each of the at least one first query token, a respective first piece of query token length information corresponding to the each of the at least one first query token, where the respective first piece of query token length information includes at least one of a first query token length or a first compression ratio of query token.

Specifically, after the first apparatus determines a respective first query token level for each of the at least one first query token, the first apparatus determines, for each of the at least one first query token, according to the respective first query token level for each of the at least one first query token, a respective first piece of query token length information corresponding to the each of the at least one first token message, where the respective first piece of query token length information includes at least one of a first query token length or a first compression ratio of query token. Therefore, the query token length information may be determined for each first query token according to the first query token level corresponding thereto, so that the first query token could be obtained based on the query token length information.

Further, in a possible implementation, the step S230 could be that for each of the at least one first query token, according to the respective first query token level for each of the at least one first query token and a correspondence between query token levels and pieces of query token length information, the respective first piece of query token length information corresponding to the each of the at least one first query token is determined, under the circumstance that the correspondence is obtained, where each of the pieces of query token length information includes at least one of query token length or the compression ratio of query token and the pieces of query token length information includes the first piece of query token length information.

In details, the first apparatus may obtain a correspondence between levels and pieces of query token length information, where each of the pieces of query token length information includes at least one of query token length or the compression ratio of query token and the pieces of query token length information includes the first piece of query token length information. Then, for each of the at least one first query token, a first piece of query token length information corresponding to that first query token may be determined according to its first query token level and the obtained correspondence.

S2340, sending a first sensing result, where the first sensing result includes at least one piece of first sensed data and/or at least one first sensing semantic.

The step S2340 is similar as step S2230 shown in FIG. 22, which is not repeated herein for brevity.

In a possible implementation, the at least one first query message may be obtained via a broadcast message; a multicast message targeted to a group of first apparatuses; or a dedicated message to a first apparatus.

For example, the at least one first query message can be broadcast or multicast or unicast, for example by a second apparatus such as a central device, as required, so that the first apparatus can obtain the at least one first query message via a broadcast message, obtain the at least one first query message via a multicast message targeted to a group of first apparatuses, or obtain the at least one first query message via a dedicated message to the first apparatus.

In a possible implementation, the at least one piece of first sensed data includes at least one piece of first raw sensed data, first half raw sensed data, or first compressed sensed data.

In details, the information transmitted by the first apparatus such as a sensing device could be several forms, for example, raw sensed data, half raw sensed data, compressed sensed data, and so on, which is not limited herein.

With the sensing communication method provided by the present disclosure, an apparatus such as a sensing device may obtain query message(s) from other apparatus such as a central device and respond with sensing result(s) in response to the obtained query message(s). Query may be conducted for one or more rounds. In a round, the query messages can be of different levels, and as a result, more flexible and detailed query would be achieved. Moreover, query may be conducted for several rounds, and the apparatus may broadcast or multi-cast or unicast query messages of different levels in several rounds, so that other apparatus(es) can respond with sensing result(s) in response to the obtained query messages in several rounds, where a low level/coarse level query message is for initial query, and a high level query message is for subsequent fine grained query. As a result, query could be conducted progressively based on hierarchical levels of queries, and sensing results would become finer and finer.

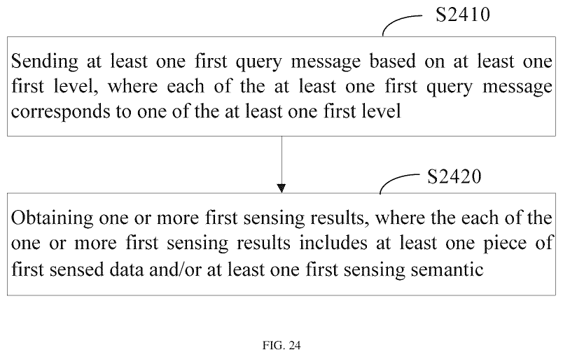

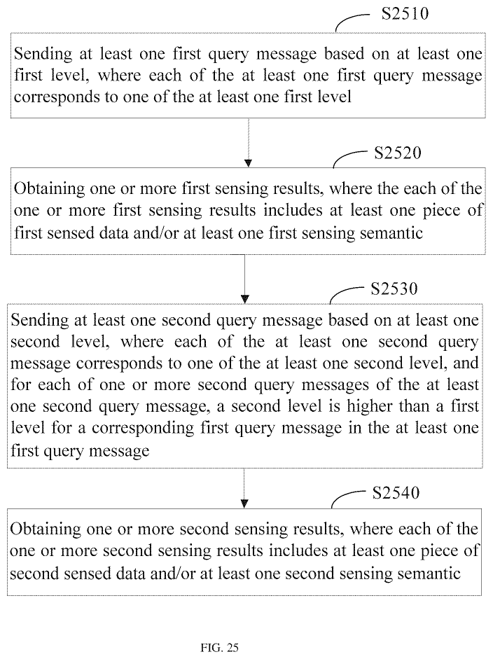

In the above, the sensing communication method of the present disclosure is described from the perspective of the first apparatus (such as the sensing device) in combination with FIG. 9 to FIG. 23. In the following, a sensing communication method of the present disclosure will be described from the perspective of the second apparatus (such as the central device) in combination with FIG. 24 to FIG. 35.

FIG. 24 is another schematic flowchart of a sensing communication method according to one or more example embodiments of the present disclosure. The method can be implemented by a second apparatus. Optionally, the second apparatus can be a central device or other device that has similar function (for example, the second apparatus could be a chip), which is not limited herein. As shown in FIG. 24, the method can include the following steps.

S2410, sending at least one first query message based on at least one first level, where each of the at least one first query message corresponds to one of the at least one first level.

In details, the second apparatus may send the at least one first query message to at least one first apparatus based on the at least one first level, where each of the at least one first query message corresponds to one of the at least one first level. In other words, each first query message has its respective first level. Optionally, the first apparatus can be a sensing device or other device that has similar function (for example, the first apparatus could be a chip), which is not limited herein.

In a possible implementation, there is a correspondence between each of the at least one first level and a first piece of query message length information respectively, where the first piece of query message length information includes at least one of a first query message length or a first compression ratio of query message. For example, for level 1, the first query message length could be 64 bits and the compression ratio could be 1000. Further, the first query message length would be represented by a value or a range. For example, for level 1, the first query message length could be 64 bits or [32, 64) bits. The correspondence can also include other parameters, which is not limited herein.

In a possible implementation, the correspondence between levels and pieces of query message length information is stored in a table. In detail, the correspondence between different levels, and query messages lengths and/or compression ratios of query messages can be defined in a table. Some examples are given in the above Table 1, Table 2, and Table 3, which is not repeated herein for brevity.

In a possible implementation, the correspondence is predefined in a protocol or is obtained from a core network, and/or the correspondence is sent to a first apparatus, i.e. the central device can obtain the correspondence locally if the correspondence has been predefined in the central device, for example, as specified in a protocol, or, the central device can obtain the correspondence from a core network, which is not limited herein. Moreover, the central device can send the correspondence to the sensing device.

In a possible implementation, each of the at least one first query message may correspond to a task, a modality, or a combination of a task and a modality, and each of the at least one task, each of the at least one modality, or each of at least one combination of the task and the modality may have its respective correspondence between levels and pieces of query message length information. For example, task 1 corresponds to a first correspondence between levels and pieces of query message length information, task 2 corresponds to a second correspondence between levels and pieces of query message length information, task 3 corresponds to a third correspondence between levels and pieces of query message length information and so on, where different tasks may have same or different correspondences. More specifically, task 1 “find moving obstacles” and task 2 “localize incoming pedestrians” may have same or different correspondences. Different modalities may also have same or different correspondences, and the difference combinations of the task and the modality may also have same or different correspondences, which are not repeated herein for brevity.

Multiple tables can be defined for multiple tasks/modalities. Some examples are given in the above Table 4-1 and Table 4-2, which is not repeated herein for brevity.

In a possible implementation, the at least one first query message includes multiple first query messages, and first levels for at least two first query messages of the multiple first query messages are different. In other words, the second apparatus may send multiple first query messages of different levels to the first apparatus, where the multiple first query messages can be given at different levels, for example, the multiple first query messages may include a low level query message and a high level query message. For example, the multiple first query messages could include MSG 1, MSG 2, MSG 3, where the MSG1 could correspond to level 1, the MSG 2 could correspond to level 2, and the MSG 3 could correspond to level 3. In another example, the multiple first query messages could include MSG 1, MSG 2, MSG 3, where the MSG1 could correspond to level 1, the MSG 2 could correspond to level 1, and the MSG 3 could correspond to level 2. In still another example, the multiple first query messages could include MSG 1, MSG 2, MSG 3, where the MSG1 could correspond to level 2, the MSG 2 could correspond to level 3, and the MSG 3 could correspond to level 3. The above examples are only for illustration, which are not limited herein.

In brief, for one round of query, the central device can broadcast or multi-cast or unicast query messages of different levels to the sensing device(s), so that the sensing device(s) can obtain the query messages of different levels. The multiple query messages can be given at different levels.

S2420, obtaining one or more first sensing results, where the each of the one or more first sensing results includes at least one piece of first sensed data and/or at least one first sensing semantic.

In details, the second apparatus may obtain one or more first sensing results from one or more of the at least one first apparatus, where the each of the one or more first sensing results includes at least one piece of first sensed data and/or at least one first sensing semantic. In other words, it is not necessary for all of the at least one first apparatus to respond with the first query message.

With the sensing communication method provided by the present disclosure, the second apparatus may send the at least one first query message to at least one first apparatus based on the at least one first level, where each of the at least one first query message corresponds to one of the at least one first level, and then the second apparatus may obtain one or more first sensing results from one or more of the at least one first apparatus, where the each of the one or more first sensing results includes at least one piece of first sensed data and/or at least one first sensing semantic. Because the at least one first query message is sent based on the at least one first level, more flexible and detailed query would be achieved.

FIG. 25 is another schematic flowchart of a sensing communication method according to one or more example embodiments of the present disclosure. In a possible implementation, as shown in FIG. 25, the method can include the following steps.

S2510, sending at least one first query message based on at least one first level, where each of the at least one first query message corresponds to one of the at least one first level.

The step S2510 is similar as step S2410 shown in FIG. 24, which is not repeated herein for brevity.

S2520, obtaining one or more first sensing results, where the each of the one or more first sensing results includes at least one piece of first sensed data and/or at least one first sensing semantic.

The step S2520 is similar as step S2420 shown in FIG. 24, which is not repeated herein for brevity.

S2530, sending at least one second query message based on at least one second level, where each of the at least one second query message corresponds to one of the at least one second level, and for each of one or more second query messages of the at least one second query message, a second level is higher than a first level for a corresponding first query message in the at least one first query message.

In details, after the one or more first sensing results are obtained, at least one second query message may further be sent, each of which corresponds to one second level. Moreover, in the at least one second query message, there is one or more second messages, each of which corresponds to one first query message in the at least one first query message, and the second level for each of the one or more second query message is higher than the first level for its corresponding first query message. Herein, a second query message corresponding to a first query message refers to that the first query message for a task 1 and the second query message for a task 2 have a certain relationship such as progressive relationship, or a first query message for a modality 1 and a second query message for a modality 2 have a certain relationship such as progressive relationship, or a first query message for a combination 1 of a task and a modality and a second query message for a combination 2 of a task and a modality have a certain relationship such as progressive relationship. Optionally the above task 1 and the above task 2 could be the same task or the different tasks, the above modality 1 and the above modality 2 could be the same modality or the different modalities, or the above combination 1 of the task and the modality and the above combination 2 of the task and the modality could be the same combination or the different combinations. For example, when the above task 1 and the above task 2 are the same task, the corresponding query messages could be the query messages of different granularities. It is noted that the above relationships are only the optional example, and other possible relationships could also be included, which is not limited herein. Moreover, when multiple second query messages are sent, the multiple second queries may include one or more messages each having a corresponding first query message and one or more messages not having a corresponding first message.

S2540, obtaining one or more second sensing results, where each of the one or more second sensing results includes at least one piece of second sensed data and/or at least one second sensing semantic.

In details, the second apparatus may obtain one or more second sensing results from one or more of at least one first apparatus, where the each of the one or more second sensing results includes at least one piece of second sensed data and/or at least one second sensing semantic. The procedure is similar as step S2420 shown in FIG. 24, which is not repeated herein for brevity.

In a possible implementation, the each of one or more second query messages is a fine grained query of the corresponding one in the at least one first query message.

In a possible implementation, each of one or more pieces of second sensed data of the at least one piece of second sensed data is a piece of fine grained sensed data of a corresponding piece of first sensed data in the at least one piece of first sensed data or a piece of fine grained sensed data of a corresponding first sensing semantic in the at least one first sensing semantic, and/or each of one or more second sensing semantics of the at least one second sensing semantic is a fine grained sensing semantic of a corresponding piece of first sensed data in the at least one piece of first sensed data or a fine grained sensing semantic of a corresponding first sensing semantic in the at least one first sensing semantic.

In other words, in the at least one piece of second sensed data, there is one or more pieces of second sensed data and/or second sensing semantics each of which corresponds to one piece of first sensed data in the at least one piece of first sensing data or one first sensing semantic in the at least one sensing semantic included in the first sensing result, and each of which is a piece of fine grained sensed data or semantic of its corresponding piece of first sensed data or corresponding first sensing semantic. Herein, a second sensed data/second sensing semantic corresponding to a first sensed data/first sensing semantic refers to that the a first sensed data/first sensing semantic for a task 1 and a second sensed data/second sensing semantic for a task 2 have a certain relationship such as progressive relationship, or a first sensed data/first sensing semantic for a modality 1 and a second sensed data/second sensing semantic for a modality 2 have a certain relationship such as progressive relationship, or a first sensed data/first sensing semantic for a combination 1 of a task and a modality and a second sensed data/second sensing semantic for a combination 2 of a task and a modality have a certain relationship such as progressive relationship. It is noted that the above relationships are only the optional example, and other possible relationships could also be included, which is not limited herein.

Because a second round of query may be performed after the first round of query, thereby query could be conducted progressively based on hierarchical levels of queries, and sensing results would become finer and finer. In another possible implementation, after the second round of query, a third round of query may further be performed according to actual demands, which is not limited herein.

In brief, query may be conducted progressively. The central device can broadcast or multi-cast or unicast query messages of different levels to the sensing device in several rounds, so that the sensing device can obtain the query messages of different levels. Query messages can be given at different levels, e.g., a low level/coarse level query message for initial query (possible with shorter length), and a high level query message for subsequent fine grained query (possible longer length).

The procedure is similar as that discussed above, which is not repeated herein for brevity. Thus, the processes can go through several rounds, from low levels to high levels. As a result, the central device can gradually obtain the progressive fusion results based on hierarchical levels of queries and responses.

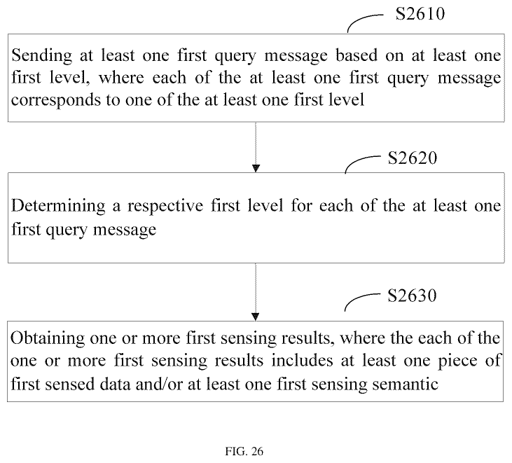

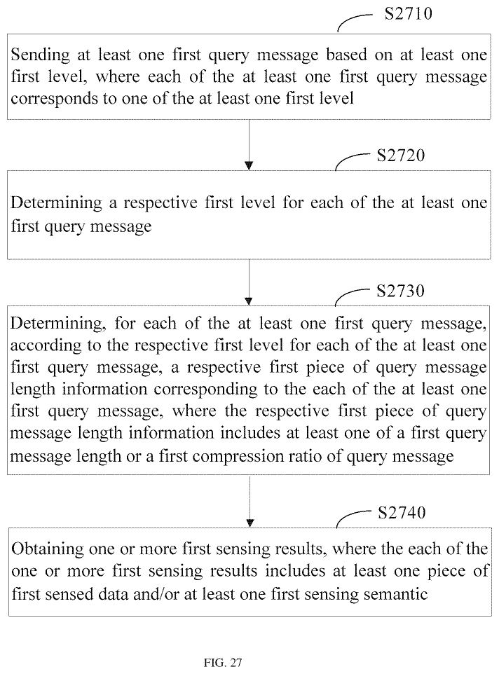

FIG. 26 is another schematic flowchart of a sensing communication method according to one or more example embodiments of the present disclosure. In a possible implementation, as shown in FIG. 23, the method can include the following steps.

S2610, sending at least one first query message based on at least one first level, where each of the at least one first query message corresponds to one of the at least one first level.

The step S2610 is similar as step S2410 shown in FIG. 24, which is not repeated herein for brevity.

S2620, determining a respective first level for each of the at least one first query message.

Specifically, the first level for the first query message can be obtained from the core network, so that the second apparatus can determine the first level for the first query message, or, the second apparatus can determine the first level for the first query message locally based on its processing capability, available resources, etc., which is not limited herein.

S2630, obtaining one or more first sensing results, where the each of the one or more first sensing results includes at least one piece of first sensed data and/or at least one first sensing semantic.

The step S2630 is similar as step S2420 shown in FIG. 24, which is not repeated herein for brevity.

FIG. 27 is another schematic flowchart of a sensing communication method according to one or more example embodiments of the present disclosure. In a possible implementation, as shown in FIG. 27, the method can include the following steps.

S2710, sending at least one first query message based on at least one first level, where each of the at least one first query message corresponds to one of the at least one first level.

The step S2710 is similar as step S2610 shown in FIG. 26, which is not repeated herein for brevity.

S2720, determining a respective first level for each of the at least one first query message.

The step S2720 is similar as step S2620 shown in FIG. 26, which is not repeated herein for brevity.

S2730, determining, for each of the at least one first query message, according to the respective first level for each of the at least one first query message, a respective first piece of query message length information corresponding to the each of the at least one first query message, where the respective first piece of query message length information includes at least one of a first query message length or a first compression ratio of query message.

Specifically, after the second apparatus determines a respective first level for each of the at least one first query message, the second apparatus determines, for each of the at least one first query message, according to the respective first level for each of the at least one first query message, a respective first piece of query message length information corresponding to the each of the at least one first query message, where the respective first piece of query message length information includes at least one of a first query message length or a first compression ratio of query message. Therefore, the query message length information may be determined for each first query message according to the first level corresponding thereto, so that the first query message could be obtained based on the query message length information.

Further, in a possible implementation, the step S2730 could be that for each of the at least one first query message, according to the respective first level for each of the at least one first query message and a correspondence between levels and pieces of query message length information, the respective first piece of query message length information corresponding to the each of the at least one first query message is determined, under the circumstance that the correspondence is obtained, where each of the pieces of query message length information includes at least one of query message length or the compression ratio of query message and the pieces of query message length information includes the first piece of query message length information.

In details, the second apparatus may obtain a correspondence between levels and pieces of query message length information, where each of the pieces of query message length information includes at least one of query message length or the compression ratio of query message and the pieces of query message length information includes the first piece of query message length information. Then, for each of the at least one first query message, a first piece of query message length information corresponding to that first query message may be determined according to its first level and the obtained correspondence.

S2740, obtaining one or more first sensing results, where the each of the one or more first sensing results includes at least one piece of first sensed data and/or at least one first sensing semantic.

The step S2740 is similar as step S2630 shown in FIG. 26, which is not repeated herein for brevity.

In a possible implementation, the at least one first level includes a first query semantic level and/or a first query token level.

In details, the query message could include a query semantic and/or a query token. Correspondingly, the level could include the query semantic level and/or the query token level.

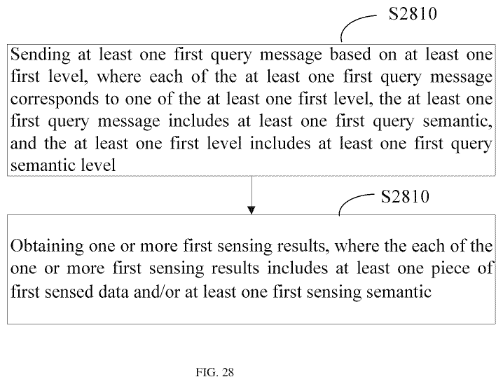

FIG. 28 is another schematic flowchart of a sensing communication method according to one or more example embodiments of the present disclosure. In a possible implementation, when the at least one first query message includes at least one first query semantic, the at least one first level includes at least one first query semantic level. Then, as shown in FIG. 28, the method can include the following steps.

S2810, sending at least one first query message based on at least one first level, where each of the at least one first query message corresponds to one of the at least one first level, the at least one first query message includes at least one first query semantic, and the at least one first level includes at least one first query semantic level.

In details, the second apparatus may send the at least one first query semantic to the at least one second apparatus based on the at least one first query semantic level, where each of the at least one first query semantic corresponds to one of the at least one first query semantic level. In other words, each first query semantic has its respective first query semantic level. It is noted that when the second apparatus sends the at least one query semantic, other query messages of other types may also be sent, for example, a query token.

In a possible implementation, there is a correspondence between each of the at least one first query semantic level and a first piece of query semantic length information respectively, where the first piece of query semantic length information includes at least one of a first query semantic length or a first compression ratio of query semantic. For example, for level 1, the first query semantic length could be 64 bits and the compression ratio could be 1000. Further, the first query semantic length would be represented by a value or a range. For example, for level 1, the first query semantic length could be 64 bits or [32, 64) bits. The correspondence can also include other parameters, which is not limited herein.

In a possible implementation, the correspondence between levels and pieces of query semantic length information is stored in a table. In detail, the correspondence between different query semantic levels, and query semantic lengths and/or compression ratios of query semantics can be defined in a table. Some examples are given in the above Table 5, Table 6, and Table 7, which is not repeated herein for brevity.

In a possible implementation, the correspondence is predefined in a protocol or is obtained from the core network. For example, the second apparatus, i.e. the central device can obtain the correspondence locally if the correspondence has been predefined in the central device, for example, as specified in a protocol, or, can obtain the correspondence from the core network, which is not limited herein.

In a possible implementation, each of the at least one first query semantic may correspond to a task, a modality, or a combination of a task and a modality, and each of the at least one task, each of the at least one modality, or each of at least one combination of the task and the modality may have its respective correspondence between query semantic levels and pieces of query semantic length information. For example, task 1 corresponds to a first correspondence between query semantic levels and pieces of query semantic length information, task 2 corresponds to a second correspondence between query semantic levels and pieces of query semantic length information, task 3 corresponds to a third correspondence between query semantic levels and pieces of query semantic length information and so on, where different tasks may have same or different correspondences. More specifically, task 1 “find moving obstacles” and task 2 “localize incoming pedestrians” may have same or different correspondences. Different modalities may also have same or different correspondences, and the difference combinations of the task and the modality may also have same or different correspondences, which are not repeated herein for brevity

Multiple tables can be defined for multiple tasks/modalities. Some examples are given in the above Table 8-1 and Table 8-2, which is not repeated herein for brevity.

In a possible implementation, multiple first query semantics are sent, where first query semantic levels for at least two first query semantics of the multiple first query semantics are different. In other words, the second apparatus may send multiple first query semantics of different levels to the at least one first apparatus, where the multiple first query semantics can be given at different levels, for example, the multiple first query semantics may include a low level query semantic and a high level query semantic. For example, the multiple first query semantics could include Semantic 1, Semantic 2, Semantic 3, where the Semantic 1 could correspond to level 1, the Semantic 2 could correspond to level 2, and the Semantic 3 could correspond to level 3. In another example, the multiple first query semantics could include Semantic 1, Semantic 2, Semantic 3, where the Semantic 1 could correspond to level 1, the Semantic 2 could correspond to level 1, and the Semantic 3 could correspond to level 2. In still another example, the multiple first query semantics could include Semantic 1, Semantic 2, Semantic 3, where the Semantic 1 could correspond to level 2, the Semantic 2 could correspond to level 3, and the Semantic 3 could correspond to level 3. The above examples are only for illustration, which are not limited herein.

In brief, for one round of query, the central device can broadcast or multi-cast or unicast query semantics of different levels to the sensing device(s), so that the sensing device(s) can obtain the query semantics of different levels. The multiple query semantics can be given at different levels

S2820, obtaining one or more first sensing results, where the each of the one or more first sensing results includes at least one piece of first sensed data and/or at least one first sensing semantic.

The step S2820 is similar as step S2420 shown in FIG. 24, which is not repeated herein for brevity.

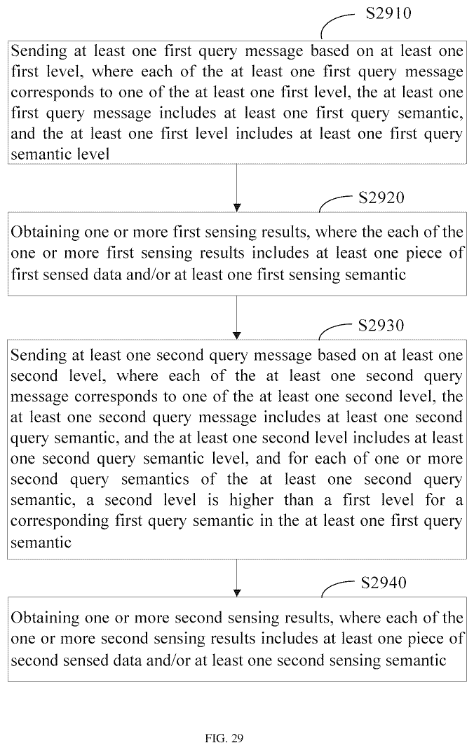

FIG. 29 is another schematic flowchart of a sensing communication method according to one or more example embodiments of the present disclosure. In a possible implementation, as shown in FIG. 29, the method can include the following steps.

S2910, sending at least one first query message based on at least one first level, where each of the at least one first query message corresponds to one of the at least one first level, the at least one first query message includes at least one first query semantic, and the at least one first level includes at least one first query semantic level.

The step S2910 is similar as step S2810 shown in FIG. 28, which is not repeated herein for brevity.

S2920, obtaining one or more first sensing results, where the each of the one or more first sensing results includes at least one piece of first sensed data and/or at least one first sensing semantic.

The step S2920 is similar as step S2820 shown in FIG. 28, which is not repeated herein for brevity.

S2930, sending at least one second query message based on at least one second level, where each of the at least one second query message corresponds to one of the at least one second level, the at least one second query message includes at least one second query semantic, and the at least one second level includes at least one second query semantic level, and for each of one or more second query semantics of the at least one second query semantic, a second level is higher than a first level for a corresponding first query semantic in the at least one first query semantic.

In details, after the one or more first sensing results are obtained, at least one second query semantic may further be sent, each of which corresponds to one second query semantic level. Moreover, in the at least one second query semantic, there is one or more second semantics, each of which corresponds to one first query semantic in the at least one first query semantic, and the second query semantic level for each of the one or more second query semantic is higher than the first query semantic level for its corresponding first query semantic. Herein, a second query semantic corresponding to a first query semantic refers to that the first query semantic for a task 1 and the second query semantic for a task 2 have a certain relationship such as progressive relationship, or a first query semantic for a modality 1 and a second query semantic for a modality 2 have a certain relationship such as progressive relationship, or a first query semantic for a combination 1 of a task and a modality and a second query semantic for a combination 2 of a task and a modality have a certain relationship such as progressive relationship. Optionally, the above task 1 and the above task 2 could be the same task or the different tasks, the above modality 1 and the above modality 2 could be the same modality or the different modalities, or the above combination 1 of the task and the modality and the above combination 2 of the task and the modality could be the same combination or the different combinations. For example, when the above task 1 and the above task 2 are the same task, the corresponding query semantics could be the query semantic of different granularities. It is noted that the above relationships are only the optional example, and other possible relationships could also be included, which is not limited herein. Moreover, when multiple second query semantics are sent, the multiple second query semantics may include one or more query semantics each having a corresponding first query semantic and one or more query semantics not having a corresponding first query semantic

S2940, obtaining one or more second sensing results, where each of the one or more second sensing results includes at least one piece of second sensed data and/or at least one second sensing semantic.

The step S2940 is similar as step S2540 shown in FIG. 25, which is not repeated herein for brevity.

In a possible implementation, the each of one or more second query semantics is a fine grained query of the corresponding one in the at least one first query semantic.

Because a second round of query may be performed after the first round of query, thereby query could be conducted progressively based on hierarchical levels of queries, and sensing results would become finer and finer. In another possible implementation, after the second round of query, a third round of query may further be performed according to actual demands, which is not limited herein.

In brief, query may be conducted progressively. The central device can broadcast or multi-cast or unicast query semantics of different query semantic levels to the sensing device in several rounds, so that the sensing device can obtain the query semantics of different query semantic levels. Query semantics can be given at different query semantic levels, e.g., a low query semantic level/coarse query semantic level query semantic for initial query (possible with shorter length), and a high query semantic level query semantic for subsequent fine grained query (possible longer length).

The procedure is similar as that discussed above, which is not repeated herein for brevity. Thus, the processes can go through several rounds, from low levels to high levels. As a result, the central device can gradually obtain the progressive fusion results based on hierarchical levels of queries and responses.

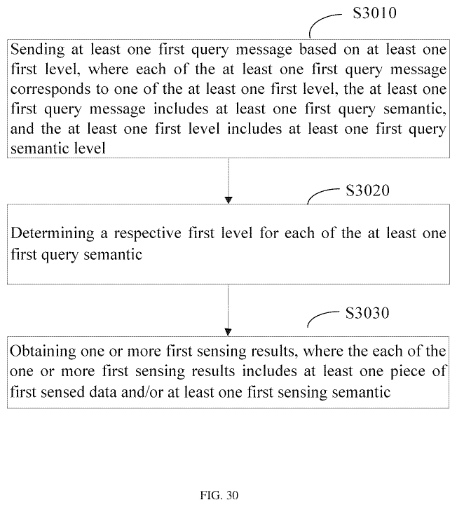

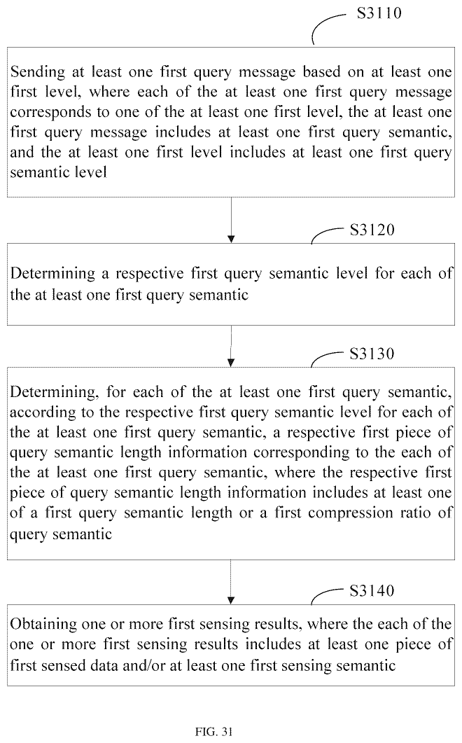

FIG. 30 is another schematic flowchart of a sensing communication method according to one or more example embodiments of the present disclosure. In a possible implementation, as shown in FIG. 30, the method can include the following steps.

S3010, sending at least one first query message based on at least one first level, where each of the at least one first query message corresponds to one of the at least one first level, the at least one first query message includes at least one first query semantic, and the at least one first level includes at least one first query semantic level.

The step S3010 is similar as step S2810 shown in FIG. 28, which is not repeated herein for brevity.

S3020, determining a respective first query semantic level for each of the at least one first query semantic.

Specifically, the first query semantic level for the first query semantic can be obtained from the core network, so that the second apparatus can determine the first query semantic level for the first query semantic, or, the second apparatus can determine the first query semantic level for the first query semantic locally based on its processing capability, available resources, etc., which is not limited herein.

S3030, obtaining one or more first sensing results, where the each of the one or more first sensing results includes at least one piece of first sensed data and/or at least one first sensing semantic.

The step S3030 is similar as step S2820 shown in FIG. 28, which is not repeated herein for brevity.

FIG. 31 is another schematic flowchart of a sensing communication method according to one or more example embodiments of the present disclosure. In a possible implementation, as shown in FIG. 31, the method can include the following steps.

S3110, sending at least one first query message based on at least one first level, where each of the at least one first query message corresponds to one of the at least one first level, the at least one first query message includes at least one first query semantic, and the at least one first level includes at least one first query semantic level.

The step S3110 is similar as step S3010 shown in FIG. 30, which is not repeated herein for brevity.

S3120, determining a respective first query semantic level for each of the at least one first query semantic.

The step S3120 is similar as step S3020 shown in FIG. 30, which is not repeated herein for brevity.

S3130, determining, for each of the at least one first query semantic, according to the respective first query semantic level for each of the at least one first query semantic, a respective first piece of query semantic length information corresponding to the each of the at least one first query semantic, where the respective first piece of query semantic length information includes at least one of a first query semantic length or a first compression ratio of query semantic.

Specifically, after the second apparatus determines a respective first query semantic level for each of the at least one first query semantic, the second apparatus determines, for each of the at least one first query semantic, according to the respective first query semantic level for each of the at least one first query semantic, a respective first piece of query semantic length information corresponding to the each of the at least one first query semantic, where the respective first piece of query semantic length information includes at least one of a first query semantic length or a first compression ratio of query semantic. Therefore, the query semantic length information may be determined for each first query semantic according to the first query semantic level corresponding thereto, so that the first query semantic could be obtained based on the query semantic length information.

Further, in a possible implementation, the step S3130 could be that for each of the at least one first query semantic, according to the respective first query semantic level for each of the at least one first query semantic and a correspondence between query semantic levels and pieces of query semantic length information, the respective first piece of query semantic length information corresponding to the each of the at least one first query semantic is determined, under the circumstance that the correspondence is obtained, where each of the pieces of query semantic length information includes at least one of query semantic length or the compression ratio of query semantic and the pieces of query semantic length information includes the first piece of query semantic length information.

In details, the second apparatus may obtain a correspondence between query semantic levels and pieces of query semantic length information, where each of the pieces of query semantic length information includes at least one of query semantic length or the compression ratio of query semantic and the pieces of query semantic length information includes the first piece of query semantic length information. Then, for each of the at least one first query semantic, a first piece of query semantic length information corresponding to that first query semantic may be determined according to its first query semantic level and the obtained correspondence.

S3140, obtaining one or more first sensing results, where the each of the one or more first sensing results includes at least one piece of first sensed data and/or at least one first sensing semantic.

The step S3140 is similar as step S3030 shown in FIG. 30, which is not repeated herein for brevity.

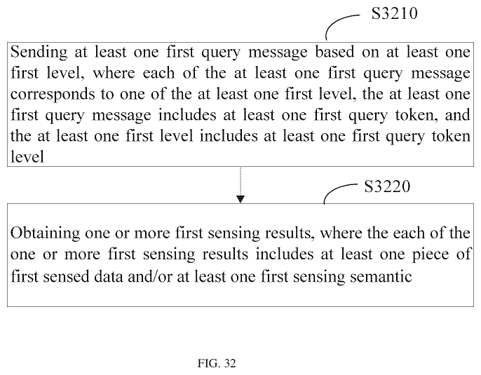

FIG. 32 is another schematic flowchart of a sensing communication method according to one or more example embodiments of the present disclosure. In a possible implementation, when the at least one first query message includes at least one first query token, the at least one first level includes at least one first query token level. Then, as shown in FIG. 32, the method can include the following steps.

S3210, sending at least one first query message based on at least one first level, where each of the at least one first query message corresponds to one of the at least one first level, the at least one first query message includes at least one first query token, and the at least one first level includes at least one first query token level.

In details, the second apparatus may send the at least one first query token to the at least one second apparatus based on the at least one first query token level, where each of the at least one first query token corresponds to one of the at least one first query token level. In other words, each first query token has its respective first query token level. It is noted that when the second apparatus sends the at least one query token, other query messages of other types may also be sent, for example, a query token.

In a possible implementation, there is a correspondence between each of the at least one first query token level and a first piece of query token length information respectively, where the first piece of query token length information includes at least one of a first query token length or a first compression ratio of query token. For example, for level 1, the first query token length could be 64 bits and the compression ratio could be 1000. Further, the first query token length would be represented by a value or a range. For example, for level 1, the first query token length could be 64 bits or [32, 64) bits. The correspondence can also include other parameters, which is not limited herein.

In a possible implementation, the correspondence between levels and pieces of query token length information is stored in a table. In detail, the correspondence between different query token levels, and query token lengths and/or compression ratios of query tokens can be defined in a table. Some examples are given in the above Table 9, Table 10, and Table 11, which is not repeated herein for brevity.

In a possible implementation, the correspondence is predefined in a protocol or is obtained from the core network. For example, the second apparatus, i.e. the central device can obtain the correspondence locally if the correspondence has been predefined in the central device, for example, as specified in a protocol, or, can obtain the correspondence from the core network, which is not limited herein.

In a possible implementation, each of the at least one first query token may correspond to a task, a modality, or a combination of a task and a modality, and each of the at least one task, each of the at least one modality, or each of at least one combination of the task and the modality may have its respective correspondence between query token levels and pieces of query token length information. For example, task 1 corresponds to a first correspondence between query token levels and pieces of query token length information, task 2 corresponds to a second correspondence between query token levels and pieces of query token length information, task 3 corresponds to a third correspondence between query token levels and pieces of query token length information and so on, where different tasks may have same or different correspondences. More specifically, task 1 “find moving obstacles” and task 2 “localize incoming pedestrians” may have same or different correspondences. Different modalities may also have same or different correspondences, and the difference combinations of the task and the modality may also have same or different correspondences, which are not repeated herein for brevity.

Multiple tables can be defined for multiple tasks/modalities. Some examples are given in the above Table 12-1 and Table 12-2, which is not repeated herein for brevity.

In a possible implementation, the at least one first query token includes multiple first query tokens, and first query token levels for at least two first query tokens of the multiple first query tokens are different. In other words, the second apparatus may send multiple first query tokens of different levels to the at least one first apparatus, where the multiple first query tokens can be given at different levels, for example, the multiple first query tokens may include a low level query token and a high level query token. For example, the multiple first query tokens could include Token 1, Token 2, Token 3, where the Token 1 could correspond to level 1, the Token 2 could correspond to level 2, and the Token 3 could correspond to level 3. In another example, the multiple first query tokens could include Token 1, Token 2, Token 3, where the Token 1 could correspond to level 1, the Token 2 could correspond to level 1, and the Token 3 could correspond to level 2. In still another example, the multiple first query tokens could include Token 1, Token 2, Token 3, where the Token 1 could correspond to level 2, the Token 2 could correspond to level 3, and the Token 3 could correspond to level 3. The above examples are only for illustration, which are not limited herein.

In brief, for one round of query, the central device can broadcast or multi-cast or unicast query tokens of different levels to the sensing device(s), so that the sensing device(s) can obtain the query tokens of different levels. The multiple query tokens can be given at different levels

S3220, obtaining one or more first sensing results, where the each of the one or more first sensing results includes at least one piece of first sensed data and/or at least one first sensing semantic.

The step S3220 is similar as step S2420 shown in FIG. 24, which is not repeated herein for brevity.

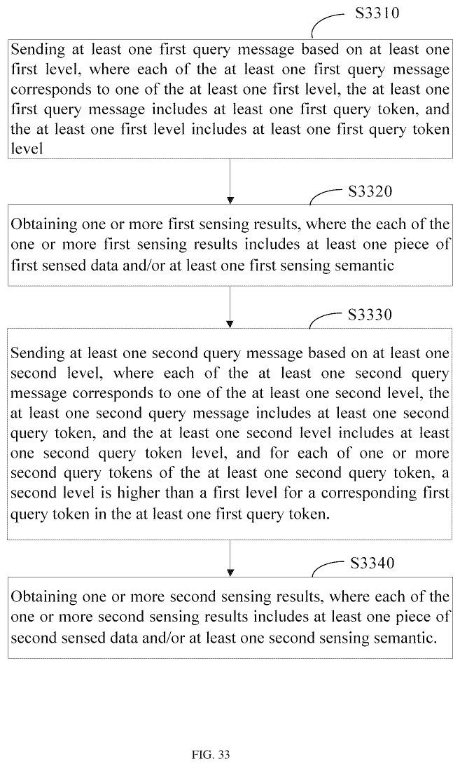

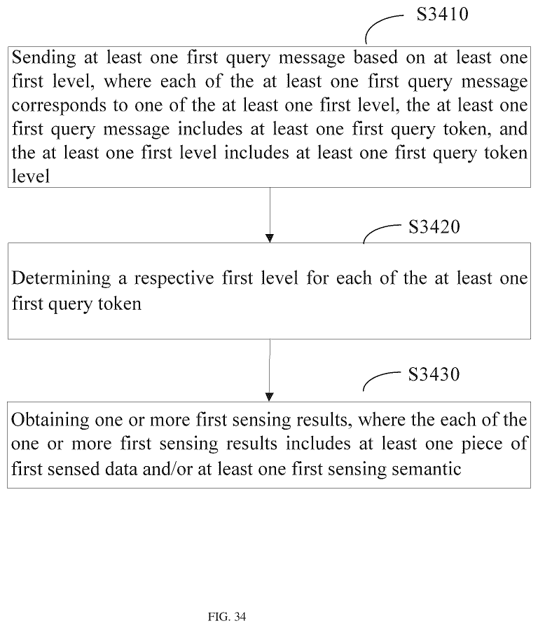

FIG. 33 is another schematic flowchart of a sensing communication method according to one or more example embodiments of the present disclosure. In a possible implementation, as shown in FIG. 33, the method can include the following steps.

S3310, sending at least one first query message based on at least one first level, where each of the at least one first query message corresponds to one of the at least one first level, the at least one first query message includes at least one first query token, and the at least one first level includes at least one first query token level.

The step S3310 is similar as step S3210 shown in FIG. 32, which is not repeated herein for brevity.

S3320, obtaining one or more first sensing results, where the each of the one or more first sensing results includes at least one piece of first sensed data and/or at least one first sensing semantic.

The step S3320 is similar as step S3220 shown in FIG. 32, which is not repeated herein for brevity.

S3330, sending at least one second query message based on at least one second level, where each of the at least one second query message corresponds to one of the at least one second level, the at least one second query message includes at least one second query token, and the at least one second level includes at least one second query token level, and for each of one or more second query tokens of the at least one second query token, a second level is higher than a first level for a corresponding first query token in the at least one first query token.

In details, after the one or more first sensing results are obtained, at least one second query token may further be sent, each of which corresponds to one second query token level. Moreover, in the at least one second query token, there is one or more second tokens, each of which corresponds to one first query token in the at least one first query token, and the second query token level for each of the one or more second query token is higher than the first query token level for its corresponding first query token. Herein, a second query token corresponding to a first query token refers to that the first query token for a task 1 and the second query token for a task 2 have a certain relationship such as progressive relationship, or a first query token for a modality 1 and a second query token for a modality 2 have a certain relationship such as progressive relationship, or a first query token for a combination 1 of a task and modality and a second query token for a combination 2 of a task and modality have a certain relationship such as progressive relationship. Optionally, the above task 1 and the above task 2 could be the same task or the different tasks, the above modality 1 and the above modality 2 could be the same modality or the different modalities, or the above combination 1 of the task and the modality and the above combination 2 of the task and the modality could be the same combination or the different combinations. For example, when the above task 1 and the above task 2 are the same task, the corresponding query tokens could be the query tokens of different granularities. It is noted that the above relationships are only the optional example, and other possible relationships could also be included, which is not limited herein. Moreover, when multiple second query tokens are obtained, the multiple second query tokens may include one or more query tokens each having a corresponding first query token and one or more query tokens not having a corresponding first query token.

S3340, obtaining one or more second sensing results, where each of the one or more second sensing results includes at least one piece of second sensed data and/or at least one second sensing semantic.

The step S3340 is similar as step S2540 shown in FIG. 25, which is not repeated herein for brevity.

In a possible implementation, the each of one or more second query tokens is a fine grained query of the corresponding one in the at least one first query token.

Because a second round of query may be performed after the first round of query, thereby query could be conducted progressively based on hierarchical levels of queries, and sensing results would become finer and finer. In another possible implementation, after the second round of query, a third round of query may further be performed according to actual demands, which is not limited herein.

In brief, query may be conducted progressively. The central device can broadcast or multi-cast or unicast query tokens of different query token levels to the sensing device in several rounds, so that the sensing device can obtain the query tokens of different query token levels. Query tokens can be given at different levels, e.g., a low query token level/coarse query token level query token for initial query (possible with shorter length), and a high query token level query token for subsequent fine grained query (possible longer length).

The procedure is similar as that discussed above, which is not repeated herein for brevity. Thus, the processes can go through several rounds, from low levels to high levels. As a result, the central device can gradually obtain the progressive fusion results based on hierarchical levels of queries and responses.

FIG. 34 is another schematic flowchart of a sensing communication method according to one or more example embodiments of the present disclosure. In a possible implementation, as shown in FIG. 34, the method can include the following steps.

S3410, sending at least one first query message based on at least one first level, where each of the at least one first query message corresponds to one of the at least one first level, the at least one first query message includes at least one first query token, and the at least one first level includes at least one first query token level.

The step S3410 is similar as step S3210 shown in FIG. 32, which is not repeated herein for brevity.

S3420, determining a respective first query token level for each of the at least one first query token.

Specifically, the first query token level for the first query token can be obtained from the core network, so that the second apparatus can determine the first query token level for the first query token, or, the second apparatus can determine the first query token level for the first query token locally based on its processing capability, available resources, etc., which is not limited herein.

S3430, obtaining one or more first sensing results, where the each of the one or more first sensing results includes at least one piece of first sensed data and/or at least one first sensing semantic.

The step S3430 is similar as step S3220 shown in FIG. 32, which is not repeated herein for brevity.

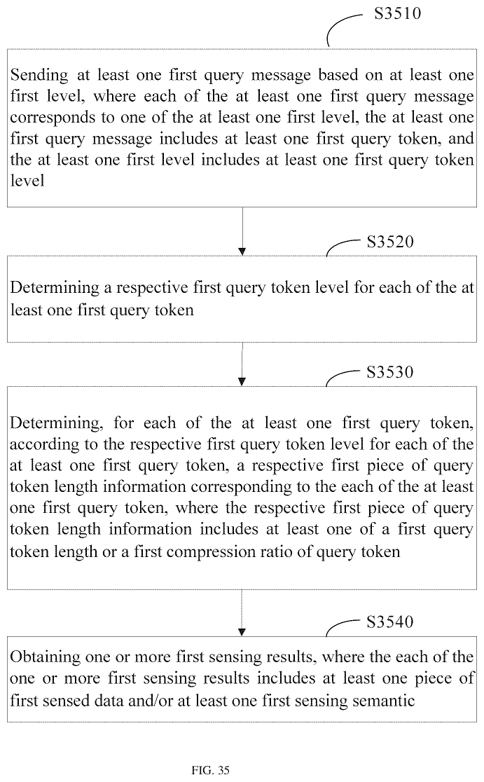

FIG. 35 is another schematic flowchart of a sensing communication method according to one or more example embodiments of the present disclosure. In a possible implementation, as shown in FIG. 35, the method can include the following steps.

S3510, sending at least one first query message based on at least one first level, where each of the at least one first query message corresponds to one of the at least one first level, the at least one first query message includes at least one first query token, and the at least one first level includes at least one first query token level.

The step S3510 is similar as step S3210 shown in FIG. 32, which is not repeated herein for brevity.

S3520, determining a respective first query token level for each of the at least one first query token.

The step S3520 is similar as step S3420 shown in FIG. 34, which is not repeated herein for brevity.

S3530, determining, for each of the at least one first query token, according to the respective first query token level for each of the at least one first query token, a respective first piece of query token length information corresponding to the each of the at least one first query token, where the respective first piece of query token length information includes at least one of a first query token length or a first compression ratio of query token.

Specifically, after the second apparatus determines a respective first query token level for each of the at least one first query token, the second apparatus determines, for each of the at least one first query token, according to the respective first query token level for each of the at least one first query token, a respective first piece of query token length information corresponding to the each of the at least one first token message, where the respective first piece of query token length information includes at least one of a first query token length or a first compression ratio of query token. Therefore, the query token length information may be determined for each first query token according to the first query token level corresponding thereto, so that the first query token could be obtained based on the query token length information.

Further, in a possible implementation, the step S3530 could be that for each of the at least one first query token, according to the respective first query token level for each of the at least one first query token and a correspondence between query token levels and pieces of query token length information, the respective first piece of query token length information corresponding to the each of the at least one first query token is determined, under the circumstance that the correspondence is obtained, where each of the pieces of query token length information includes at least one of query token length or the compression ratio of query token and the pieces of query token length information includes the first piece of query token length information.

In details, the second apparatus may obtain a correspondence between levels and pieces of query token length information, where each of the pieces of query token length information includes at least one of query token length or the compression ratio of query token and the pieces of query token length information includes the first piece of query token length information. Then, for each of the at least one first query token, a first piece of query token length information corresponding to that first query token may be determined according to its first query token level and the obtained correspondence.

S3540, obtaining one or more first sensing results, where the each of the one or more first sensing results includes at least one piece of first sensed data and/or at least one first sensing semantic.

The step S3540 is similar as step S3030 shown in FIG. 30, which is not repeated herein for brevity.

In a possible implementation, the at least one first query message may be sent via a broadcast message; a multicast message targeted to a group of first apparatuses; or a dedicated message to a first apparatus.

For example, the at least one first query message can be broadcast or multicast or unicast, for example by a second apparatus such as a central device, as required, so that the first apparatus can obtain the at least one first query message via a broadcast message, obtain the at least one first query message via a multicast message targeted to a group of first apparatuses, or obtain the at least one first query message via a dedicated message to the first apparatus.

In a possible implementation, the at least one piece of first sensed data includes at least one piece of first raw sensed data, first half raw sensed data, or first compressed sensed data.

In details, the information transmitted by the first apparatus such as a sensing device could be several forms, for example, raw sensed data, half raw sensed data, compressed sensed data, and so on, which is not limited herein.

With the sensing communication method provided by the present disclosure, an apparatus such as a central device can broadcast or multi-cast or unicast query message(s), so that other apparatus(es) such as one or more sensing devices can obtain the query message(s) and respond with sensing result(s) in response to the obtained query message(s). Query may be conducted for one or more rounds. In a round, the query messages can be of different levels, and as a result, more flexible and detailed query would be achieved. Moreover, query may be conducted for several rounds, and the apparatus may broadcast or multi-cast or unicast query messages of different levels in several rounds, so that other apparatus(es) can respond with sensing result(s) in response to the obtained query messages in several rounds, where a low level/coarse level query message is for initial query, and a high level query message is for subsequent fine grained query. As a result, query could be conducted progressively based on hierarchical levels of queries, and sensing results would become finer and finer.

In the above, the sensing communication method of the present disclosure is described from the perspective of the first apparatus (such as the sensing device) in combination with FIG. 9 to FIG. 23 and from the perspective of the second apparatus (such as the central device) in combination with FIG. 24 to FIG. 35. In the following, a sensing communication method of the present disclosure will be described from the perspective of the wireless communication system including the at least one GPT device, the at least one central device, and the at least one sensing device.

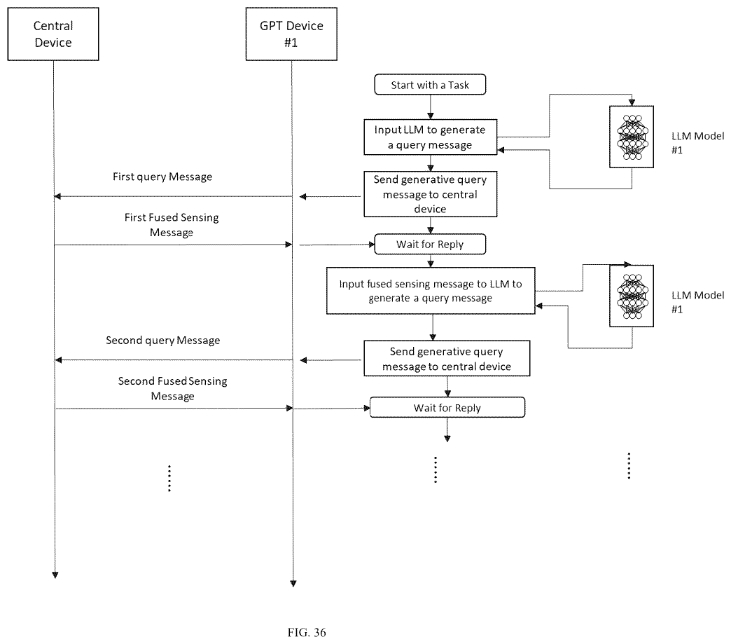

FIG. 36 is a schematic illustration of realizing a chain of thoughts according to one or more example embodiments of the present disclosure, where a chain of thoughts is realized by generative AI model and is embodied by a sequence of query messages.

A GPT device may generate a sequence of the query messages based on the previous sensing messages, wherein the previous sensing messages are received and/or fused by the central device. The GPT device may inference one or several generative AI models. The generative AI model or model inferences deep neural network or networks to output a query message or messages. The GPT device generates a sequence of the query messages, called as “a chain of the thoughts” by interacting with a sequence of the fused sensing messages into which the central device fuses the sensed data transmitted by the responsive sensing devices; as illustrated in FIG. 36.

A query message that the GPT device generate may convey semantic goals, tasks, or objectives. For example, a query message of “localize an incoming pedestrians” explicitly establishes a semantic goal for the sensing devices to focus on its nearby pedestrian and to prevent the sensing devices from being distracted. Since a query message conveys a semantic goal or goals, the query message that the central device transmits to the sensing devices may trigger a goal-oriented sensing task at each responsive sensing device that receives and responds to the very query message. Please note that a message may convey several goals. For example, a message of “find a moving pedestrian with white coat” conveys two semantic goals or tasks: a moving pedestrian and a pedestrian with white coat.

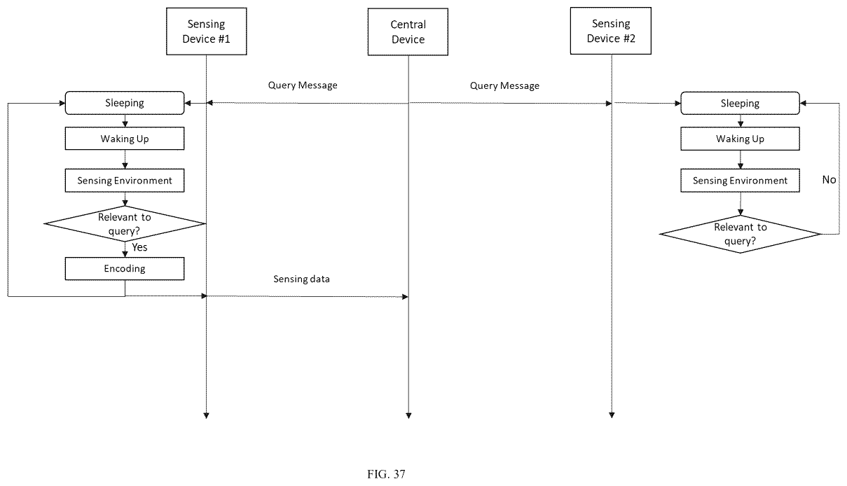

FIG. 37 is another schematic illustration of interaction among devices in a sensing communication scenario according to one or more example embodiments of the present disclosure. In the example, the sensing device #1 responds to the query message and the sensing device #2 doesn't respond to the query message.

In a possible implementation, as shown in FIG. 37, the central device may broadcast a sequence of the query messages, because it may be too costly or even forbidden to schedule sensing device individually in a wireless system including such a high density of sensing devices. Therefore, once a sensing device receives a query message, the sensing device may become waken but with little idea whether or not its sensed data is sufficiently relevant to the goal conveyed by the query message. Thereby the sensing device may enable its sensing gadget to sense its nearby environment into a sensed data and compare the sensed data with the query message. If the sensing device tells that the sensed data is sufficiently relevant with the query message, the sensing device encodes and transmits the sensed data to the central device (Sensing Device #1 in FIG. 37). Otherwise, the sensing may not respond to the query message at all (Sensing Device #2 in FIG. 37). In this sense, the wireless system doesn't schedule individual sensing device but schedule a common task across a collectivity of sensing devices.

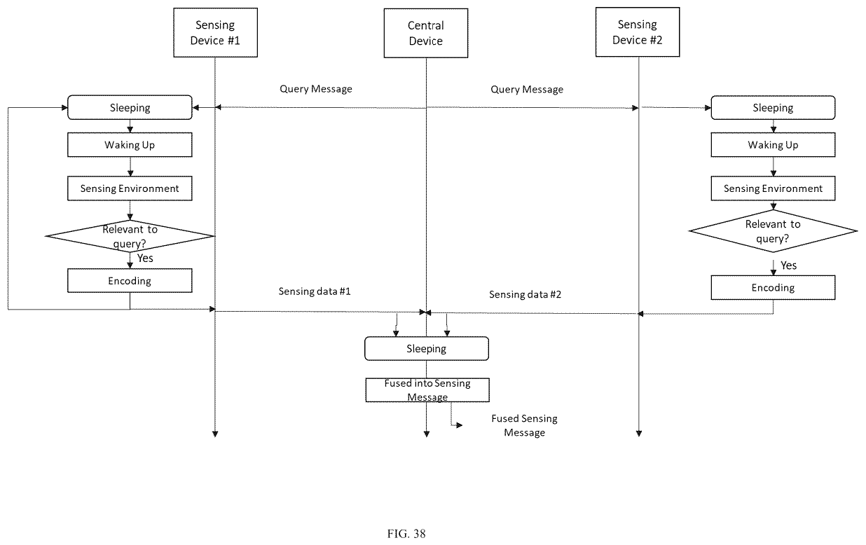

FIG. 38 is another schematic illustration of interaction among devices in a sensing communication scenario according to one or more example embodiments of the present disclosure. In the example, the central device receives the two sensed data from the two responsive sensing devices and fuse the two sensed data into a fused sensing message for the GPT device.

In a possible implementation, as shown in FIG. 38, the central device may receive a plurality of sensed data from some or all the sensing devices that respond to the query message at the end of a pre-defined responding timing interval. The central device may fuse all the sensed data into one sensing message and input the sensing message to the GPT device that would generate the next query message based on the sensing message, as shown in FIG. 38. Because only those sensing devices that respond to the query message would transmit the sensed data, lots of radio resource would be saved in comparison with one-to-one scheduling algorithm.

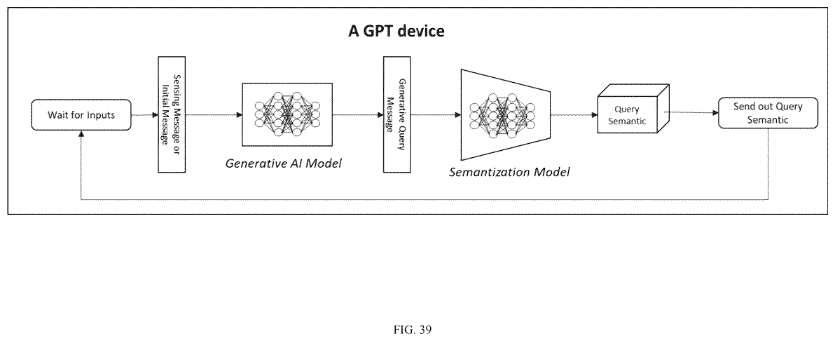

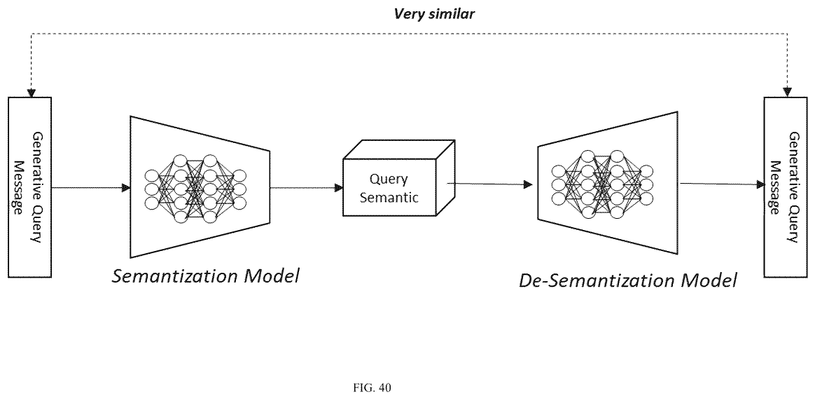

FIG. 39 is a schematic illustration of generating a query message, where GPT device uses generative AI model to generate the query message and then use semantization model to translate the query message into a query semantic. FIG. 40 is a schematic illustration of reversing a semantic, where semantic is reversible, meaning that if someone had a de-semantization model, he could recover a query message from a query semantic.

A sequence of the query messages that the GPT device generates and the central device broadcasts is in a natural language, that is, human-readable. The GPT device may employ a LLM (large-language-model) to inference over a fused sensing message (in a natural language too) input to generate a new query message. The LLM model may be a “standard” foundation model like a transformer, or a “custom” model that is built for a narrower vocabulary and specific scenarios. For example, a customized LLM for dealing with industry 4.0 or a customized LLM for dealing with wireless communication signaling and protocols. The GPT device may change, update, downsize, upsize, replace its LLM or LLMs anytime as it wishes. Please note that broadcast, multicast or unicast is allowed.

A query message that the GPT device generates is in a natural language. Because of randomness in generating, two different query messages may convey very similar semantic goal or goals. For example, “find a pedestrian” and “localize a walking man” may have the same semantic goal. Therefore, the GPT device may semantize a query message into a query semantic, which is called as “embedding,” “semantization,” “encoding,” “natural-language to machine translation” and so on. The GPT device may translate a query message into a query semantic that may include a vector, a matrix, or a tensor of scalars. The translation may be realized by deep-neural network or other classic functions. A query semantic may preserve all the key semantic goals conveyed by the query message such that the query semantic can be well translated (de-semantized) back to a query message. Optionally, the GPT device may transmit a query semantic instead of a query message to the central device, as illustrated in FIG. 39. Please note that if all the LLMs outputs to a common natural language (e.g., English), these LLMs are said to be aligned by the natural language; then whatever LLMs are used, everyone can be smoothly hooked into the GPT device and work well within the wireless system.

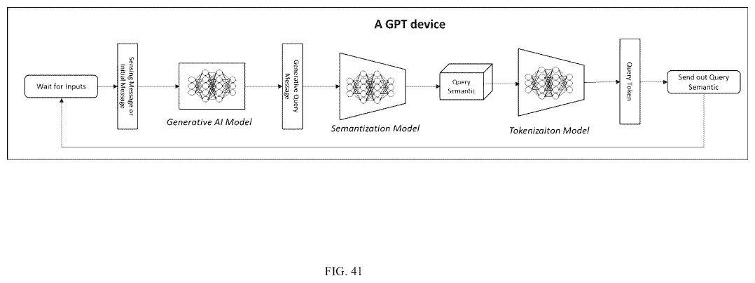

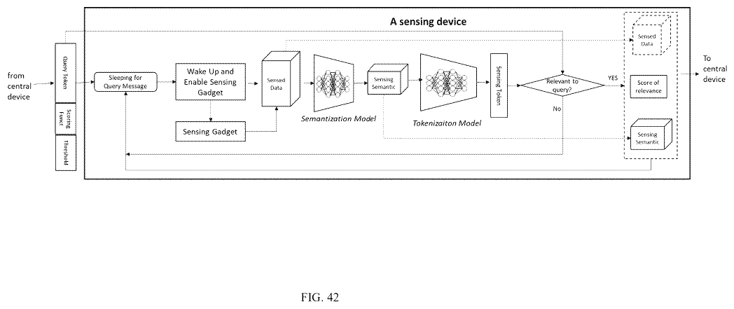

FIG. 41 is a schematic illustration of tokenizing a query semantic into a query token, where a GPT device tokenize a query semantic into a query token.

In one implementation, the central device may further tokenize a query semantic into a query token. A query token is a fixed-length semantic but including a vector of scalars, simpler for transmission and comparison purposes. The wireless system may pre-specify a plurality of lengths for query tokens. Thus, the central device may choose a right token length when tokenizing a query semantic according to the size range of the query semantic. The tokenization can be such a harsh function to prevent a sensing device from recovering a complete query message from a query token. The tokenization may come up with certain privacy protection for query messages. The tokenization may be realized by deep-neural network or other classic functions; as shown in FIG. 41.

Optionally, the central device receives a query semantic from the GPT device, and then the central device converts the query semantic into a query token with a fixed length; the central device may broadcast the query token with the length to all the sensing devices; the central device may keep the query semantic in its memory or storage to check the feedback sensed data.

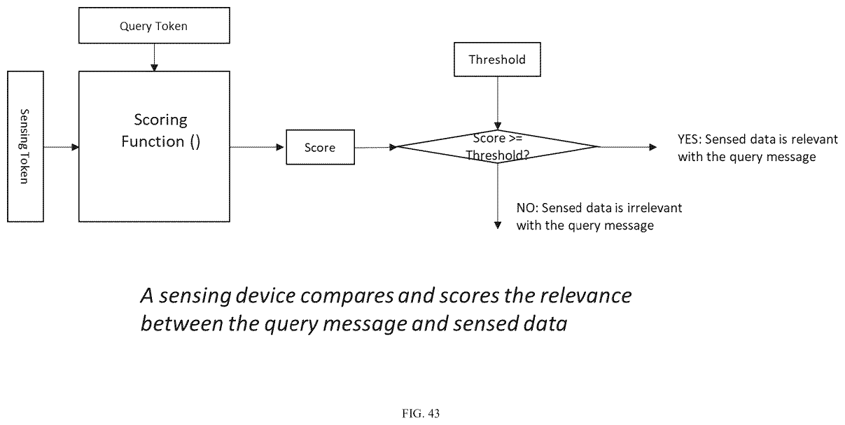

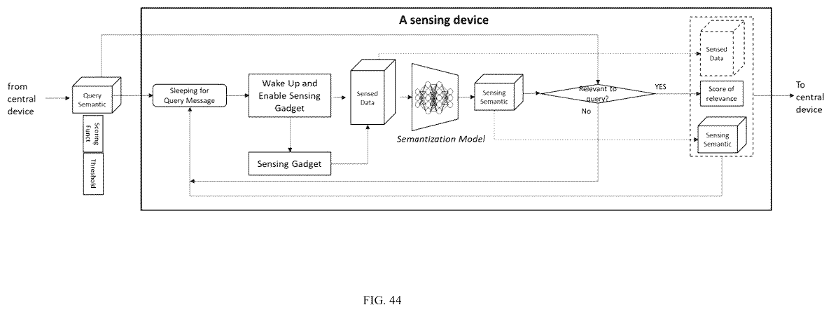

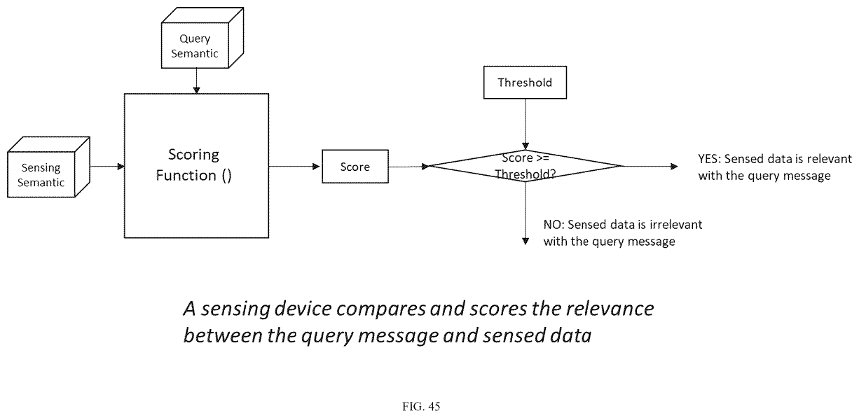

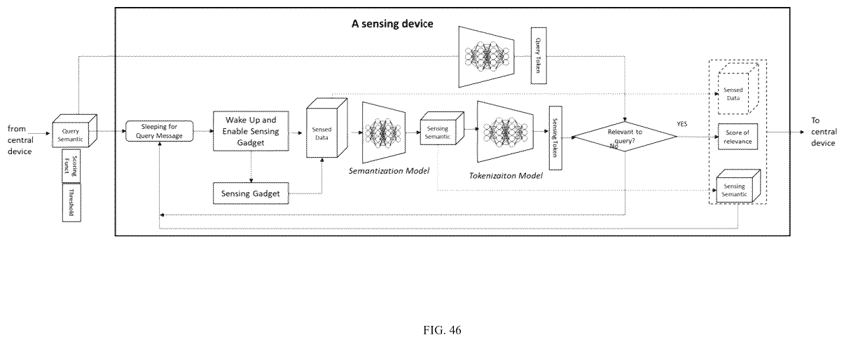

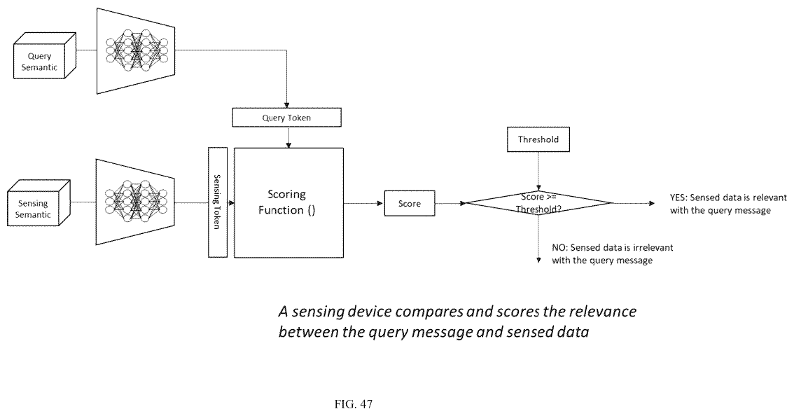

FIG. 42 is a schematic illustration of responding to a query token, where a sensing device responds to a query token. FIG. 43 is a schematic illustration of scoring the relevance with tokens, where score the relevance with tokens. FIG. 44 is another schematic illustration of responding to a query token, where a sensing device responds to a query token. FIG. 45 is a schematic illustration of scoring a relevance with semantic, where score the relevance with semantic. FIG. 46 is another schematic illustration of responding to a query token, where a sensing device responds to a query token. FIG. 47 is a schematic illustration of scoring the relevance with tokens converted from semantics, where score the relevance with tokens converted from semantics.

A sensing device may compare its sensed data with the query message; after the sensing device receives a query token (with its length or indicator of its length), the sensing device is waked up to enable its sensing gadget to measure its nearby physical-word environment into a sensed data; the sensing device may be equipped with one LLM or LLMs as semantization model and input the sensed data into the semantization model to output a sensing semantic; optionally, the sensing device may choose a right length and format of the sensing semantic; and the sensing device may continue to tokenize the sensing semantic into a sensing token with the same length as the query token that the sensing device has received; the sensing device compares or scores the relevance between the query message and sensed data, which is based on what the sensing device has received.

Alternative #1 (FIG. 42 and FIG. 43): the sensing device receives a query token and scoring function; it compares and scores the relevance between the query token and the sensing token; if the score of relevance was greater than or equal to a pre-defined threshold, the sensing device would tell that the sensed data is sufficiently relevant with the query message from the central device.

Alternative #2 (FIG. 44 and FIG. 45): the sensing device receives a query semantic and scoring function; it compares and scores the relevance between the query semantic with the sensing semantic, if both semantics are in a similar size and format; if the score of relevance was greater than or equal to a pre-defined threshold, the sensing device would tell that the sensed data is sufficiently relevant with the query message from the central device.

Alternative #3 (FIG. 46 and FIG. 47): the sensing device receives a query semantic and scoring function; it firstly converts the query semantic into a query token by the local tokenization model; and it compares and scores the relevance between the query token and sensing token; if the score of relevance was greater than or equal to a pre-defined threshold, the sensing device would tell that the sensed data is sufficiently relevant with the query message from the central device.

If the score of relevance is greater than or equal to a pre-defined threshold, the sensing device may transmit information including the sensed data and optionally the score of relevance to the central device. The following are some alternatives of the contents in the transmitted information:
Alternative #1: raw sensed data;
Alternative #2: sensing semantic;
Alternative #3: half raw sensed data (e.g., exact value or number)+sensing semantic;
Alternative #4: raw sensed data+score of relevance;
Alternative #5: sensing semantic+score of relevance;
Alternative #6: half raw sensed data (e.g., exact value or number)+sensing semantic+score of relevance.

A sensing device may be equipped with one or several semantization models to generate sensing semantic from sensed (raw) data, may be equipped with tokenization model to generate sensing token from sensing semantic, and may be configured to have a scoring function; unlike the GPT device, the LLMs, tokenization model, and scoring functions that a sensing device may use are configured by the central device; the central device may configure and inform the sensing devices of a common LLMs and/or tokenization model and scoring function at all the beginning or on the run.

A plurality of sensing devices, either in one type or in multiple types, may serve one or several tasks simultaneously; in an efficient way, a sensing device may be triggered once to serve as many tasks as possible.

A wireless system may include two GPT devices, or one GPT device that can conduct two separated tasks; in the following disclosure, two GPT devices is mentioned as an example. And the two GPT devices may be easily extended to one GPT device with two separated tasks.

Although the two GPT devices have their own separate and independent tasks, the two GPT devices may trigger the same sensing devices simultaneously; for example, a driverless car GPT device and a traffic-light GPT device may trigger the same roadside camera sensing devices; nevertheless, although the same sensing devices may be triggered by two GPT devices at the same time interval, the query message from the first GPT device may be different from the query message from the second GPT device; for example, the driverless car GPT device may broadcast a query message about “moving obstacles” and the traffic-light GPT device may broadcast a query message about “density of vehicles,” both of which may be somehow relevant but not similar.

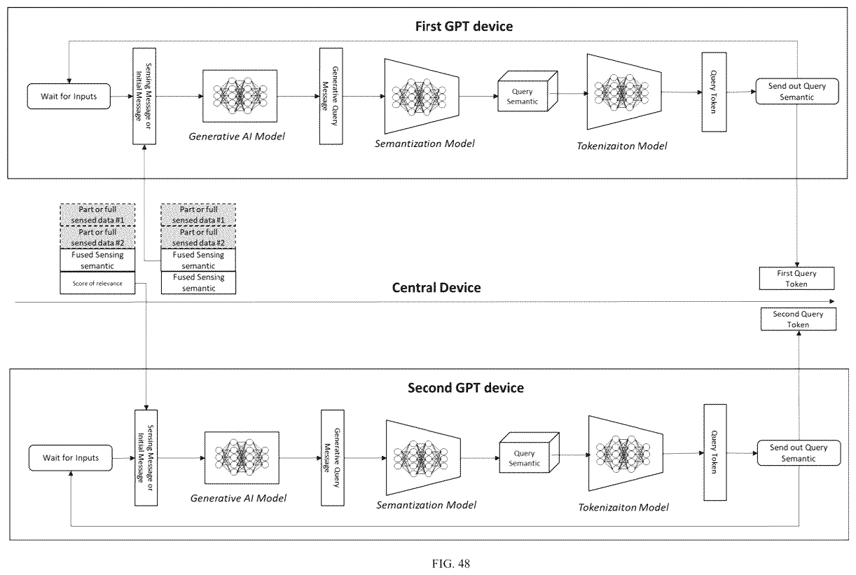

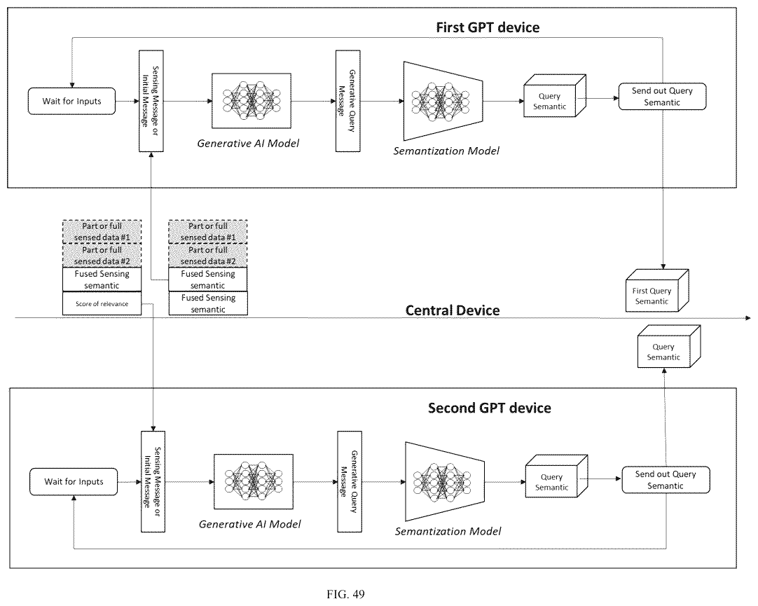

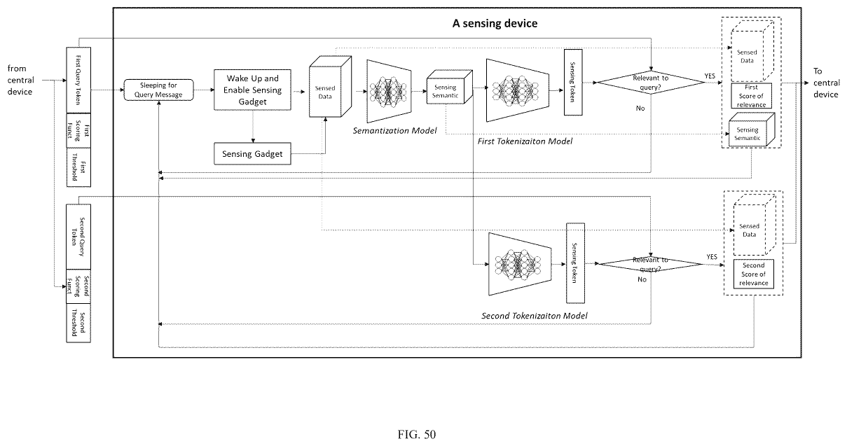

FIG. 48 is a schematic illustration of generating query tokens, where GPT devices generate the query tokens. FIG. 49 is a schematic illustration of generating query semantics, where GPT devices generate the query semantics.

The first GPT device generates the first query semantic to the central device and the second GPT device generates the second query semantic to the central device. There are two options shown as follows:
Alternative #1: as shown in FIG. 48, the central device may tokenize the first query message into the first query token and tokenize the second query message into the second query token; the central device may use the first tokenization model to tokenize the first query message and the second tokenization model to tokenize the second query message, or the central device may use a common tokenization model to tokenize the first query message and the second query message; then the central device may broadcast the first query token, the length of the first token, the first scoring function related to the first token, and the first threshold related to the first scoring function, and the second query token the length of the second token, the second scoring function related to the second token, and the second threshold related to the second scoring function in a multiplex way in DL channel(s);
Alternative #2: as shown in FIG. 49, the central device may not perform the tokenization, and the central device may broadcast the first query semantic, the length and format of the first semantic, the first scoring function related to the first semantic, and the first threshold related to the first scoring function, and the second query message the length of the second message, the second scoring function related to the second message, and the second threshold related to the second scoring function in a multiplex way in DL channel(s).

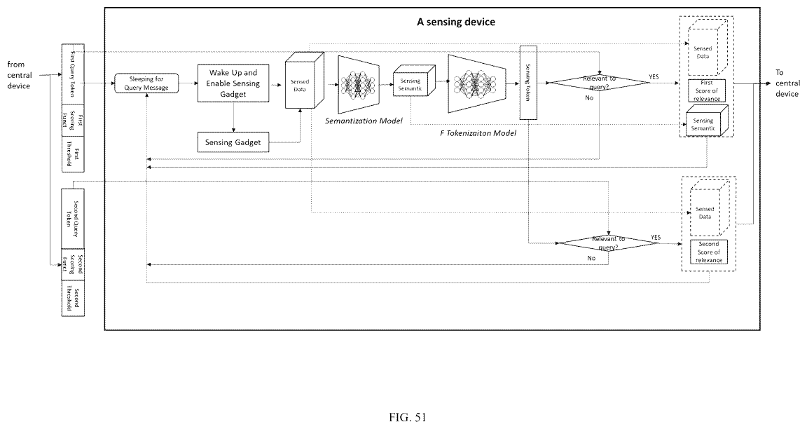

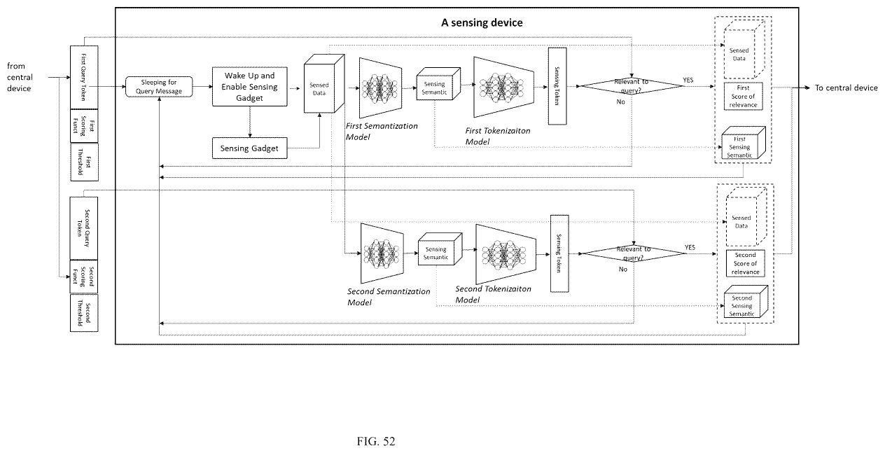

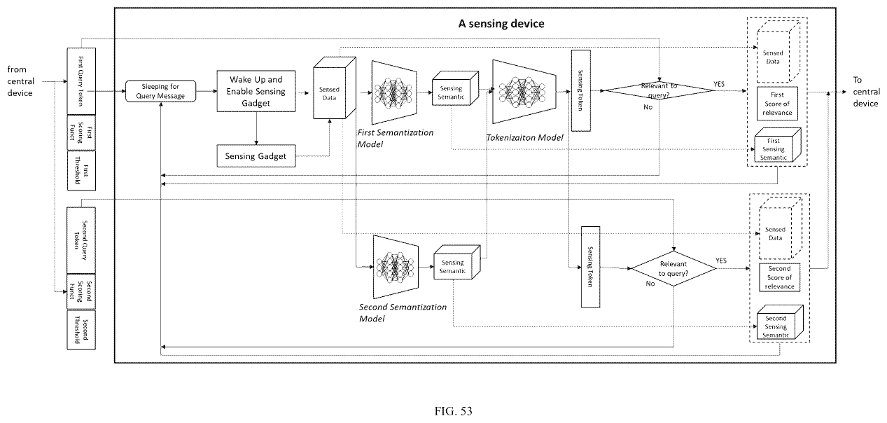

FIG. 50 is a schematic illustration of responding to two queries with a common semantization model and two tokenization models, where a sensing device responds to two queries with a common semantization model and two tokenization models. FIG. 51 is a schematic illustration of responding to two queries with a common semantization model and a common tokenization model, where a sensing device responds to two queries with a common semantization model and a common tokenization model. FIG. 52 is another schematic illustration of responding to two queries with two semantization models and two tokenization models, where a sensing device responds to two queries with two semantization models and two tokenization models. FIG. 53 is another schematic illustration of responding to two queries with two semantization models and a common tokenization model, where a sensing device responds to two queries with two semantization models and a common tokenization model.

A sensing device may receive both the first query token and the second query token and wakes to enable its sensing gadget to sense the physical-world around itself into a sensed data. There are two options shown as follows:
Alternative #1: the sensing device may convert the sensed data into one common sensing semantic by one LLM or LLMs; and then the sensing device may tokenize the sensing semantic into the first sensing token in terms of the length of the first query token and tokenize the sensing semantic into the second sensing token in terms of the length of the second query token, in which the sensing device may use the first tokenization model to tokenize the sensing semantic into the first sensing token and the second tokenization model to tokenize the sensing semantic into the second sensing token (as shown in FIG. 50), or may use a common tokenization model to tokenize the sensing semantic into both the first sensing token and the second sensing token (as shown in FIG. 51); the sensing device may score the relevance between the first query token and the first sensing token and the relevance between the second query token and the second sensing token; the sensing device may tell whether or not the sensed data provides an enough relevance to the first query token if the first score of the relevance is greater than or equal to the first threshold, and the sensing device may tell whether or not the sensed data provides an enough relevance to the second query token if the second score of the relevance is greater than or equal to the second threshold; the sensing device may transmit at least one of the sensed data, sensing semantic or the first score of relevance if deciding the first score of relevance is high enough; the sensing device may transmit at least one of the sensed data, sensing semantic or the second score of relevance if deciding the second score of relevance is high enough;
Alternative #2: as shown in FIG. 51, the sensing device may convert the sensed data into the first sensing semantic by one LLM or LLMs and convert the same sensed data into the second sensing semantic by one LLM or LLMs; and then the sensing device may tokenize the first sensing semantic into the first sensing token in terms of the length of the first query token and tokenize the second sensing semantic into the second sensing token in terms of the length of the second query token, in which the sensing device may use the first tokenization model to tokenize the first sensing semantic into the first sensing token and the second tokenization model to tokenize the second sensing semantic into the second sensing token (as shown in FIG. 52), or may use a common tokenization model to tokenize the sensing semantic into both the first sensing token and the second sensing token (as shown in FIG. 53); the sensing device may score the relevance between the first query token and the first sensing token and the relevance between the second query token and the second sensing token; the sensing device may tell whether or not the sensed data provides an enough relevance to the first query token if the first score of the relevance is greater than or equal to the first threshold, and the sensing device may tell whether or not the sensed data provides an enough relevance to the second query token if the second score of the relevance is greater than or equal to the second threshold; the sensing device may transmit at least one of the sensed data, the first sensing semantic or the first score of relevance if deciding the first score of relevance is high enough; the sensing device may transmit at least one of the sensed data, the second sensing semantic or the second score of relevance if deciding the second score of relevance is high enough.

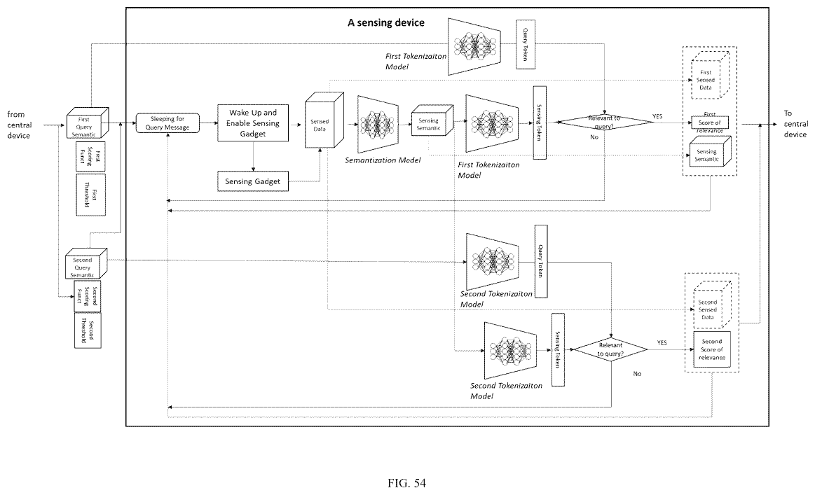

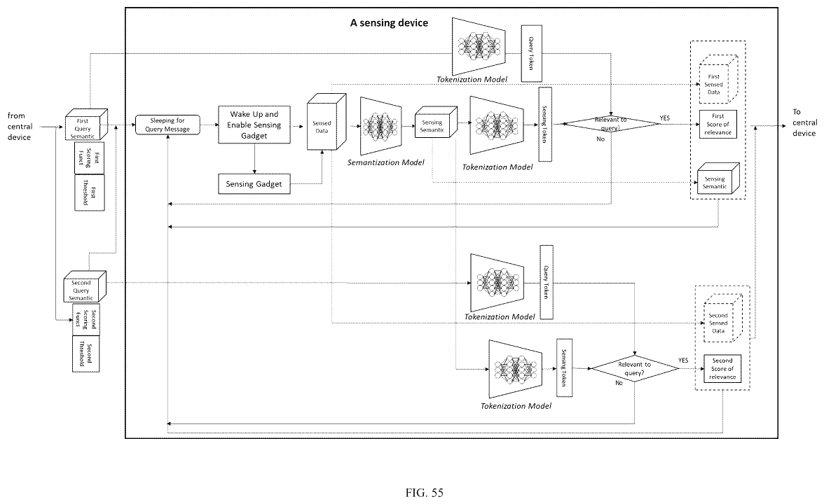

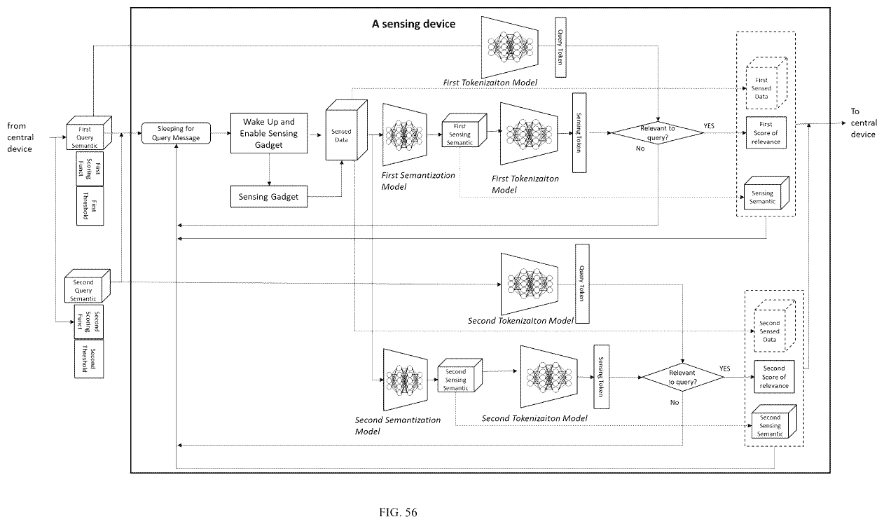

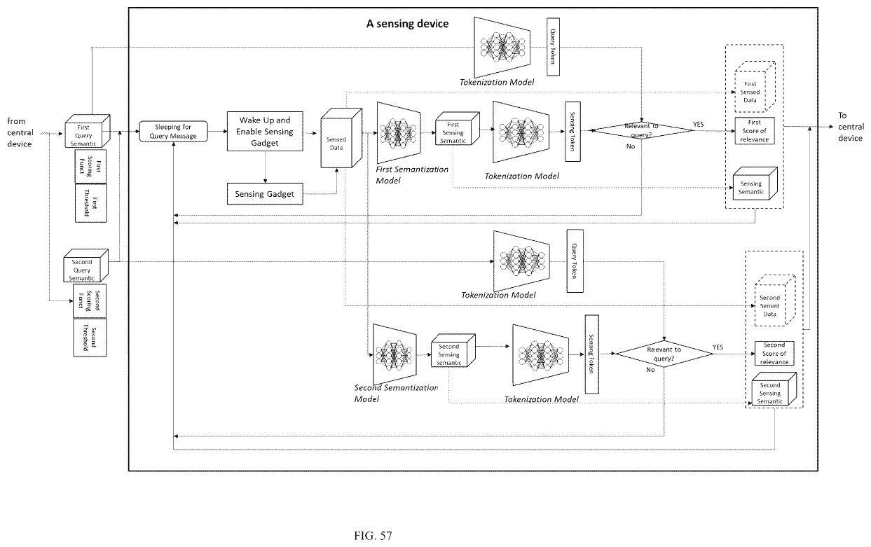

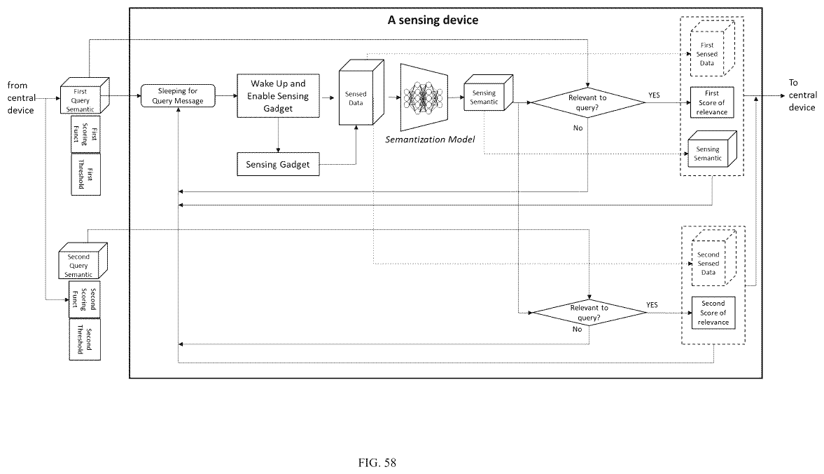

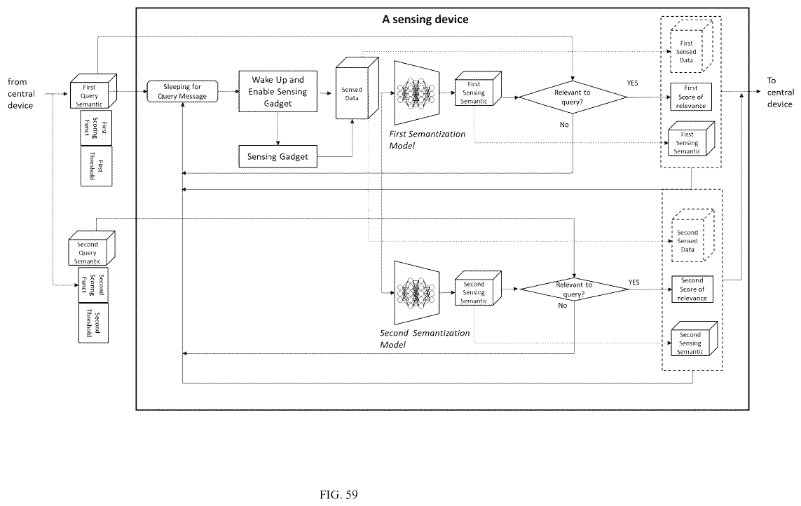

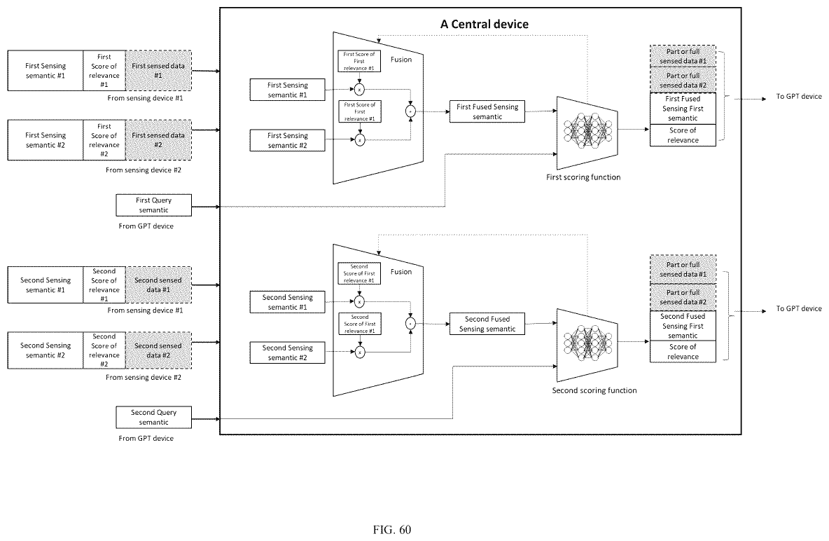

FIG. 54 is a schematic illustration of responding to two query semantics with a common semantization model and two different tokenization models, where a sensing device responds to two query semantics with a common semantization model and two different tokenization models. FIG. 55 is a schematic illustration of responding to two query semantics with a common semantization model and a common tokenization model, where a sensing device responds to two query semantics with a common semantization model and a common tokenization model. FIG. 56 is a schematic illustration of responding to two query semantics with two semantization models and two tokenization models, where a sensing device responds to two query semantics with two semantizations model and two tokenization models. FIG. 57 is a schematic illustration of responding to two query semantics with two semantization models and one tokenization model, where a sensing device responds to two query semantics with two semantizations model and one tokenization model. FIG. 58 is a schematic illustration of responding to two query semantics with one semantization model without tokenization model, where a sensing device responds to two query semantics with one semantization model without tokenization model. FIG. 59 is a schematic illustration of responding to two query semantics with two semantization models without tokenization model, where a sensing device responds to two query semantics with two semantization models without tokenization model.

A sensing device may receive both the first query semantic and the second query semantic and wakes to enable its sensing gadget to sense the physical-world around itself into a sensed data. There are several options shown as follows:
Alternative #1: the sensing device may convert the sensed data into one common sensing semantic by one LLM or LLMs; and then the sensing device may tokenize the sensing semantic into the first sensing token and the first query semantic into the first query token, both tokens of which are with the same first length that the sensing device decides, while the sensing device may tokenize the sensing semantic into the second sensing token and the second query semantic into the second query token, both tokens of which are with the same second length that the sensing device decides, wherein the sensing device may use the first tokenization model to tokenize the sensing semantic into the first sensing token and the second tokenization model to tokenize the sensing semantic into the second sensing token (FIG. 54), or may use a common tokenization model to tokenize the sensing semantic into both the first sensing token and the second sensing token (FIG. 55); the sensing device may score the relevance between the first query token and the first sensing token and the relevance between the second query token and the second sensing token; the sensing device may tell whether or not the sensed data provides an enough relevance to the first query token if the first score of the relevance is greater than or equal to the first threshold, and the sensing device may tell whether or not the sensed data provides an enough relevance to the second query token if the second score of the relevance is greater than or equal to the second threshold; the sensing device may transmit at least one of the sensed data, sensing semantic or the first score of relevance if deciding the first score of relevance is high enough; the sensing device may transmit at least one of the sensed data, sensing semantic or the second score of relevance if deciding the second score of relevance is high enough;
Alternative #2: the sensing device may convert the sensed data into the first sensing semantic by one LLM or LLMs and convert the same sensed data into the second sensing semantic by one LLM or LLMs; and tokenize the first sensing semantic into the first sensing token and the first query semantic into the first query token, both tokens of which are with the same first length that the sensing device decides, while the sensing device may tokenize the second sensing semantic into the second sensing token and the second query semantic into the second query token, both tokens of which are with the same second length that the sensing device decides, where the sensing device may use the first tokenization model to tokenize the first sensing semantic into the first sensing token and the second tokenization model to tokenize the second sensing semantic into the second sensing token (FIG. 56), or may use a common tokenization model (FIG. 57) to tokenize the first and second sensing semantics into both the first sensing token and the second sensing token; the sensing device may score the relevance between the first query token and the first sensing token and the relevance between the second query token and the second sensing token; the sensing device may tell whether or not the sensed data provides an enough relevance to the first query token if the first score of the relevance is greater than or equal to the first threshold, and the sensing device may tell whether or not the sensed data provides an enough relevance to the second query token if the second score of the relevance is greater than or equal to the second threshold; the sensing device may transmit at least one of the sensed data, the first sensing semantic or the first score of relevance if deciding the first score of relevance is high enough; the sensing device may transmit at least one of the sensed data, the second sensing semantic or the second score of relevance if deciding the second score of relevance is high enough;
Alternative #3 (FIG. 58): the sensing device may convert the sensed data into one common sensing semantic by one LLM or LLMs; and then the sensing device may score the relevance between the first query semantic and the sensing semantic and the relevance between the second query semantic and the sensing semantic; the sensing device may tell whether or not the sensed data provides an enough relevance to the first query semantic if the first score of the relevance is greater than or equal to the first threshold, and the sensing device may tell whether or not the sensed data provides an enough relevance to the second query semantic if the second score of the relevance is greater than or equal to the second threshold; the sensing device may transmit at least one of the sensed data, the sensing semantic or the first score of relevance if deciding the first score of relevance is high enough; the sensing device may transmit at least one of the sensed data, the sensing semantic or the second score of relevance if deciding the second score of relevance is high enough;
Alternative #4 (FIG. 59): the sensing device may convert the sensed data into the first sensing semantic by one LLM or LLMs and convert the same sensed data into the second sensing semantic by one LLM or LLMs; and then the sensing device may score the relevance between the first query semantic and the first sensing semantic and the relevance between the second query semantic and the second sensing semantic; the sensing device may tell whether or not the sensed data provides an enough relevance to the first query semantic if the first score of the relevance is greater than or equal to the first threshold, and the sensing device may tell whether or not the sensed data provides an enough relevance to the second query semantic if the second score of the relevance is greater than or equal to the second threshold; the sensing device may transmit at least one of the sensed data, the first sensing semantic or the first score of relevance if deciding the first score of relevance is high enough; the sensing device may transmit at least one of the sensed data, the second sensing semantic or the second score of relevance if deciding the second score of relevance is high enough.

FIG. 60 is a schematic illustration of processing two sensing semantics independently, where a central device processes the two sensing semantics independently.

If the central device receives a number of the first sensing semantics plus the first scores of relevance and a number of the second sensing semantics plus the second scores of relevance, the central device may fuse these first sensing semantics according to their first scores of relevance into the first fused sensing semantic and the central device may fuse these second sensing semantics according to their second scores of relevance into the second fused sensing semantic; the central device may score the first fused sensing semantic by measuring the relevance between the first fused semantic and the first query semantic, and score the second fused sensing semantic by measuring the relevance between the second fused sensing semantic and the second query semantic; the central device may transmit the first fused sensing semantic with the first score of relevance to the first GPT device and transmit the second fused sensing semantic with the second score of relevance to the second GPT device; as shown in FIG. 60.

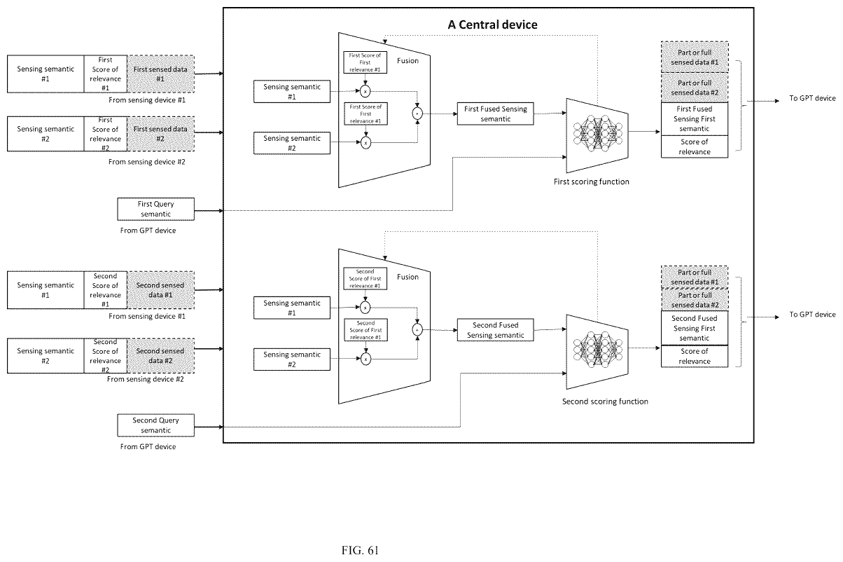

FIG. 61 is a schematic illustration of processing one sensing semantic but with two tasks independently, where a central device processes the one sensing semantics but with two tasks independently.

If the central device receives a number of the sensing semantics plus the first scores of relevance and the second scores of relevance, the central device may fuse these sensing semantics according to their first scores of relevance into the first fused sensing semantic and the central device may fuse the second sensing semantics according to their second scores of relevance into the second fused sensing semantic; the central device may score the first fused sensing semantic by measuring the relevance between the first fused semantic and the first query semantic, and score the second fused sensing semantic by measuring the relevance between the second fused sensing semantic and the second query semantic; the central device may transmit the first fused sensing semantic with the first score of relevance to the first GPT device and transmit the second fused sensing semantic with the second score of relevance to the second GPT device; as shown in FIG. 61.

The first GPT device may receive the first fused sensing semantic and the first score of relevance to the first query semantic; the first GPT device may de-semantize the first fused sensing semantic into the first sensing message; the first GPT device may input the first sensing message into the LLM(s) to inference to generate the next first query message; optionally, the first GPT device may input the first sensing message plus the first score of relevance to the LLM(s).

The second GPT device may receive the second fused sensing semantic and the second score of relevance to the second query semantic; the second GPT device may de-semantize the second fused sensing semantic into the second sensing message; the second GPT device may input the second sensing message into the LLM(s) to inference to generate the next second query message; optionally, the second GPT device may input the second sensing message plus the second score of relevance to the LLM(s).

Next, examples of products related to the sensing communication methods will be described.

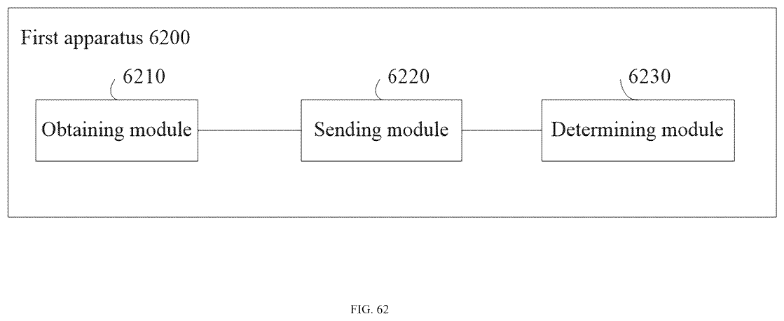

FIG. 62 is a schematic structural diagram of a first apparatus according to one or more example embodiments of the present disclosure.

As shown in FIG. 62, the first apparatus 6200 may include: an obtaining module 6210, configured to obtain at least one first query message based on at least one first level, where each of the at least one first query message corresponds to one of the at least one first level; and a sending module 6220, configured to send a first sensing result, where the first sensing result includes at least one piece of first sensed data and/or at least one first sensing semantic.

In a possible implementation, there is a correspondence between each of the at least one first level and a first piece of query message length information respectively, where the first piece of query message length information includes at least one of a first query message length or a first compression ratio of query message.

In a possible implementation, a correspondence between levels and pieces of query message length information is stored in a table.

In a possible implementation, where the correspondence is predefined in a protocol or is obtained from a second apparatus.

In a possible implementation, each of the at least one first query message corresponds to a task, a modality, or a combination of a task and a modality, and each of the at least one task, each of the at least one modality, or each of at least one combination of the task and the modality has a respective correspondence between levels and pieces of query message length information.

In a possible implementation, the at least one first query message includes multiple first query messages, and first levels for at least two first query messages of the multiple first query messages are different.

In a possible implementation, after the sending a first sensing result, the obtaining module 6210 is further configured to obtain at least one second query message based on at least one second level, where each of the at least one second query message corresponds to one of the at least one second level, and for each of one or more second query messages of the at least one second query message, a second level is higher than a first level for a corresponding first query message in the at least one first query message; and the sending module 6220 is further configured to send a second sensing result, where the second sensing result includes at least one piece of second sensed data and/or at least one second sensing semantic.

In a possible implementation, the each of one or more second query messages is a fine grained query of the corresponding one in the at least one first query message.

In a possible implementation, each of one or more pieces of second sensed data of the at least one piece of second sensed data is a piece of fine grained sensed data of a corresponding piece of first sensed data in the at least one piece of first sensed data or a piece of fine grained sensed data of a corresponding first sensing semantic in the at least one first sensing semantic, and/or each of one or more second sensing semantics of the at least one second sensing semantic is a fine grained sensing semantic of a corresponding piece of first sensed data in the at least one piece of first sensed data or a fine grained sensing semantic of a corresponding first sensing semantic in the at least one first sensing semantic.

In a possible implementation, the method further include: a determining module 6230, configured to determine a respective first level for each of the at least one first query message.

In a possible implementation, the determining module 6230 is further configured to determine, for each of the at least one first query message, according to the respective first level for each of the at least one first query message, a respective first piece of query message length information corresponding to the each of the at least one first query message, where the respective first piece of query message length information includes at least one of a first query message length or a first compression ratio of query message.

In a possible implementation, the obtaining module 6210 is further configured to obtain a correspondence between levels and pieces of query message length information, where each of the pieces of query message length information includes at least one of query message length or the compression ratio of query message and the pieces of query message length information includes the first piece of query message length information; and where the determining module 6230 is further configured to determine, for each of the at least one first query message, according to the respective first level for each of the at least one first query message and the correspondence, the respective first piece of query message length information corresponding to the each of the at least one first query message.

In a possible implementation, the at least one first level includes a first query semantic level and/or a first query token level.

In a possible implementation, when the at least one first query message includes at least one first query semantic, the at least one first level includes at least one first query semantic level.

In a possible implementation, the determining module 6230 is further configured to determine, for each of the at least one first query semantic, according to the respective first query semantic level for each of the at least one first query semantic, a respective first piece of query semantic length information corresponding to the each of the at least one first query semantic, where the respective first piece of query semantic length information includes at least one of a first query semantic length or a first compression ratio of query semantic.

In a possible implementation, the first query semantic length is represented by a value or a range.

In a possible implementation, the obtaining module 6210 is further configured to obtain a correspondence between query semantic levels and pieces of query semantic length information, where each of the pieces of query semantic length information includes at least one of query semantic length or the compression ratio of query semantic, and the pieces of query semantic length information includes the first piece of query semantic length information, and the determining module 6230 is further configured to determine, for each of the at least one first query semantic, according to the respective first query semantic level for each of the at least one first query semantic and the correspondence, the respective first piece of query semantic length information corresponding to the each of the at least one first query semantic.

In a possible implementation, when the at least one first query message includes at least one first query token, the at least one first level includes at least one first query token level.

In a possible implementation, the determining module 6230 is further configured to determine, for each of the at least one first query token, according to the respective first query token level for each of the at least one first query token, a respective first piece of query token length information corresponding to the each of the at least one first query token, where the respective first piece of query token length information includes at least one of a first query token length or a first compression ratio of query token.

In a possible implementation, the first query token length is represented by a value or a range.

In a possible implementation, the obtaining module 6210 is further configured to obtain a correspondence between query token levels and pieces of query token length information, where each of the pieces of query token length information includes at least one of query token length or the compression ratio of query token and the pieces of query token length information includes the first piece of query token length information, and the determining module 6230 is further configured to determine, for each of the at least one first query token, according to the respective first query token level for each of the at least one first query token and the correspondence, the respective first piece of query token length information corresponding to the each of the at least one first query token.

In a possible implementation, the obtaining module 6210 is further configured to obtain the at least one first query message via a broadcast message; obtain the at least one first query message via a multicast message targeted to a group of first apparatuses; or obtain the at least one first query message via a dedicated message to a first apparatus.

In a possible implementation, the at least one piece of first sensed data includes at least one piece of first raw sensed data, first half raw sensed data, or first compressed sensed data.

The first apparatus may be applied to the above first apparatus such as the sensing device as described in the above possible method implementations. It should be understood by a person skilled in the art that, the relevant description of the above modules in these possible implementations of the present disclosure may be understood with reference to the relevant description of the sensing communication method in these possible implementations of the present disclosure. The technical effect achieved by the above first apparatus is similar as that achieved by the above possible method implementation, which is not repeated herein.

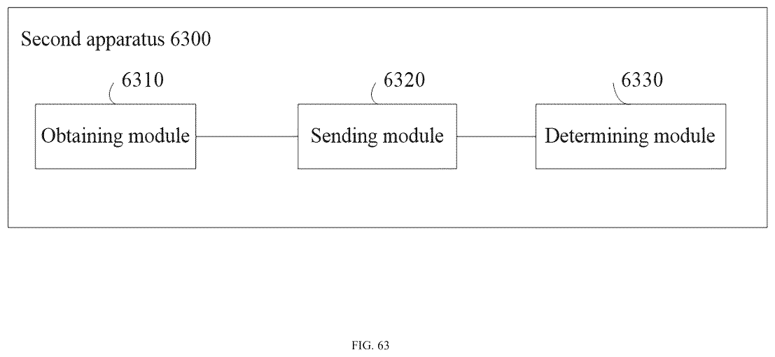

FIG. 63 is a schematic structural diagram of a second apparatus according to one or more example embodiments of the present disclosure.

As shown in FIG. 63, the second apparatus 6300 may include: a sending module 6320, configured to send at least one first query message based on at least one first level, where each of the at least one first query message corresponds to one of the at least one first level; and an obtaining module 6310, configured to obtain one or more first sensing results, where the each of the one or more first sensing results includes at least one piece of first sensed data and/or at least one first sensing semantic.

In a possible implementation, there is a correspondence between each of the at least one first level and a first piece of query message length information respectively, where the first piece of query message length information includes at least one of a first query message length or a first compression ratio of query message.

In a possible implementation, a correspondence between levels and pieces of query message length information is stored in a table.

In a possible implementation, the correspondence is predefined in a protocol or is obtained from a core network, and/or the correspondence is sent to a first apparatus.

In a possible implementation, each of the at least one first query message corresponds to a task, a modality, or a combination of a task and a modality, and each of the at least one task, each of the at least one modality, or each of at least one combination of the task and the modality has a respective correspondence between levels and pieces of query message length information.

In a possible implementation, the at least one first query message includes multiple first query messages, and first levels for at least two first query messages of the multiple first query messages are different.

In a possible implementation, after the obtaining one or more first sensing results, the sending module 6320 is further configured to send at least one second query message based on at least one second level, where each of the at least one second query message corresponds to one of the at least one second level, and for each of one or more second query messages of the at least one second query message, a second level is higher than a first level for a corresponding first query message in the at least one first query message; and the obtaining module 6310 is further configured to obtain one or more second sensing results, where each of the one or more second sensing results includes at least one piece of second sensed data and/or at least one second sensing semantic.

In a possible implementation, the each of one or more second query messages is a fine grained query of the corresponding one in the at least one first query message.

In a possible implementation, each of one or more pieces of second sensed data of the at least one piece of second sensed data is a piece of fine grained sensed data of a corresponding piece of first sensed data in the at least one piece of first sensed data or a piece of fine grained sensed data of a corresponding first sensing semantic in the at least one first sensing semantic, and/or each of one or more second sensing semantics of the at least one second sensing semantic is a fine grained sensing semantic of a corresponding piece of first sensed data in the at least one piece of first sensed data or a fine grained sensing semantic of a corresponding first sensing semantic in the at least one first sensing semantic.

In a possible implementation, the second apparatus further includes: a determining module 6330, configured to determine a respective first level for each of the at least one first query message.

In a possible implementation, the determining module 6330 is further configured to determine, for each of the at least one first query message, according to the respective first level for each of the at least one first query message, a respective first piece of query message length information corresponding to the each of the at least one first query message, where the respective first piece of query message length information includes at least one of a first query message length or a first compression ratio of query message.

In a possible implementation, the obtaining module 6310 is further configured to obtain a correspondence between levels and pieces of query message length information, where each of the pieces of query message length information includes at least one of query message length or the compression ratio of query message and the pieces of query message length information includes the first piece of query message length information; and the determining module 6330 is further configured to determine, for each of the at least one first query message, according to the respective first level for each of the at least one first query message and the correspondence, the respective first piece of query message length information corresponding to the each of the at least one first query message.

In a possible implementation, the at least one first level includes a first query semantic level and/or a first query token level.

In a possible implementation, when the at least one first query message includes at least one first query semantic, the at least one first level includes at least one first query semantic level.

In a possible implementation, the determining module 6330 is further configured to determine, for each of the at least one first query semantic, according to the respective first query semantic level for each of the at least one first query semantic, a respective first piece of query semantic length information corresponding to the each of the at least one first query semantic, where the respective first piece of query semantic length information includes at least one of a first query semantic length or a first compression ratio of query semantic.

In a possible implementation, the first query semantic length is represented by a value or a range.

In a possible implementation, the obtaining module 6310 is further configured to obtain a correspondence between query semantic levels and pieces of query semantic length information, where each of the pieces of query semantic length information includes at least one of query semantic length or the compression ratio of query semantic, and the pieces of query semantic length information includes the first piece of query semantic length information, and the determining module 6330 is further configured to determine, for each of the at least one first query semantic, according to the respective first query semantic level for each of the at least one first query semantic and the correspondence, the respective first piece of query semantic length information corresponding to the each of the at least one first query semantic.

In a possible implementation, when the at least one first query message includes at least one first query token, the at least one first level includes at least one first query token level.

In a possible implementation, the determining module 6330 is further configured to determine, for each of the at least one first query token, according to the respective first query token level for each of the at least one first query token, a respective first piece of query token length information corresponding to the each of the at least one first query token, where the respective first piece of query token length information includes at least one of a first query token length or a first compression ratio of query token.

In a possible implementation, the first query token length is represented by a value or a range.

In a possible implementation, the obtaining is further configured to obtain a correspondence between query token levels and pieces of query token length information, where each of the pieces of query token length information includes at least one of query token length or the compression ratio of query token and the pieces of query token length information includes the first piece of query token length information, and the determining module 6330 is further configured to determine, for each of the at least one first query token, according to the respective first query token level for each of the at least one first query token and the correspondence, the respective first piece of query token length information corresponding to the each of the at least one first query token.

In a possible implementation, the sending module 6320 is further configured to send the at least one first query message via a broadcast message; send the at least one first query message via a multicast message targeted to a group of first apparatuses; or send the at least one first query message via a dedicated message to a first apparatus.

In a possible implementation, the at least one piece of first sensed data includes at least one piece of first raw sensed data, first half raw sensed data, or first compressed sensed data.

The second apparatus may be applied to the above second apparatus such as the central device as described in the above possible method implementations. It should be understood by a person skilled in the art that, the relevant description of the above modules in these possible implementations of the present disclosure may be understood with reference to the relevant description of the sensing communication method in these possible implementations of the present disclosure. The technical effect achieved by the above second apparatus is similar as that achieved by the above possible method implementations, which is not repeated herein.

A possible implementation of the present disclosure provides a third apparatus including processing circuitry for executing any of the above corresponding sensing communication methods at the first apparatus side, which is not repeated herein.

A possible implementation of the present disclosure provides a fourth apparatus including processing circuitry for executing any of the above corresponding sensing communication methods at the second apparatus side, which is not repeated herein.

A possible implementation of the present disclosure provides a wireless communication system, including at least one first apparatus for executing any of the above corresponding sensing communication methods at the first apparatus side or at least one third apparatus for executing any of the above corresponding sensing communication methods at the first apparatus side; at least one second apparatus for executing any of the above corresponding sensing communication methods at the second apparatus side or at least one fourth apparatus for executing any of the above corresponding sensing communication methods at the second apparatus side; and at least one fifth apparatus, where each of the at least one fifth apparatus includes: a sending module, configured to send at least one query message to the at least one second apparatus; and an obtaining module, configured to obtain at least one fused sensing result sent by the at least one second apparatus, where the at least one fused sensing result is generated based on one or more first sensing results. The above method is not repeated herein.

A possible implementation of the present disclosure provides a wireless communication system including: a first processing circuitry for executing any of the above corresponding sensing communication methods at the first apparatus side; a second processing circuitry for executing any of the above corresponding sensing communication methods at the second apparatus side; and a third processing circuitry for executing following steps: sending at least one query message to the second processing circuitry; and obtaining at least one fused sensing result sent by the second processing circuitry, where the at least one fused sensing result is generated based on one or more first sensing results. The above method is not repeated herein.

A possible implementation of the present disclosure provides a computer-readable storage medium storing computer execution instructions which, when executed by a processor, cause the processor to execute any of the above sensing communication methods, which is not repeated herein.

A possible implementation of the present disclosure provides a computer program product including computer execution instructions which, when executed by a processor, causes the processor to execute any of the above sensing communication methods, which is not repeated herein.

A method, apparatus and system for hierarchical semantic/task query and response is provided in the present disclosure.

Some aspects of the present disclosure relate to a scheme of a semantic-based communication to manage and schedule a large number of sensing devices, in which the sensing devices may belong to different types. The query semantics are goal-oriented and only the sensing device whose sensed data has sufficient relevance with the semantic message(s) would response and transmit their sensed data that are preferably in semantic form too.

Some aspects of the present disclosure relate to a scheme of a collective semantic token-based scheduling over a large number of sensing devices rather than one-to-one individual scheduling.

Some aspects of the present disclosure relate to a scheme of using the large-Language-model (LLM) to turn query and sensed data into a common semantic domain on which they can be easily compared to each other and fused.

The above one or more aspects of the present disclosure may have at least one of the following benefits:
scheduling may be task-oriented or goal-oriented; only the sensing devices that has contributions to a scheduled task or goal will response and transmit their sensed data;
privacy may be protected: both the task, goal, or query and sensed data are well protected; no raw data or minimum raw data or message is transmitted over the air;
forward compatible: semantic-based sensing system in this disclosure may be forward compatible in a sense that any new sensing mechanism can be supported.

In some aspects of the present disclosure, there is provided a computer program including instructions. The instructions, when executed by a processor, may cause the processor to implement the method of the present disclosure.

In some aspects of the present disclosure, there is provided a non-transitory computer-readable medium storing instructions, the instructions, when executed by a processor, may cause the processor to implement the method of the present disclosure.

In some aspects of the present disclosure, there is provided an apparatus/chipset system including means to implement the method implemented by the sensing device of the present disclosure.

In some aspects of the present disclosure, there is provided an apparatus/chipset system including means to implement the method implemented by the central device of the present disclosure.

In some aspects of the present disclosure, there is provided an apparatus/chipset system including means to implement the method implemented by the GPT device of the present disclosure.

In some aspects of the present disclosure, there is provided a system including at least two of an apparatus in the sensing device of the present disclosure, an apparatus in the central device of the present disclosure and an apparatus in the GPT device of the present disclosure.

In some aspects of the present disclosure, there is provided an apparatus/chipset system including at least one processor executing instructions stored in a computer-readable medium to implement the method implemented by the sensing device of the present disclosure.

In some aspects of the present disclosure, there is provided an apparatus/chipset system including at least one processor executing instructions stored in a computer-readable medium to implement the method implemented by the central device of the present disclosure.

In some aspects of the present disclosure, there is provided an apparatus/chipset system including at least one processor executing instructions stored in a computer-readable medium to implement the method implemented by the GPT device of the present disclosure.

### Example Concepts of Some Terms

Message: a payload in a natural language, e.g., English, French, or Chinese . . . ;
Query message: a query sentence in a natural language;
Sensing message: a description about an observation or sensed data in a natural language;
Semantic: a vector, a matrix, a tensor of scalars to embed a message;
Query semantic: a semantic that embeds a query message;
Sensing semantic: a semantic that embeds a sensing message;
Token: a vector of scalars encoded from a semantic;
Query token: a token that is encoded from a query semantic;
Sensing token: a token that is encoded from a sensing semantic;
GPT device: a device that runs over generative AI model or models to generate one query message or messages given a sensing message or messages;
Central device: a device as BS that connects a plurality of terminal devices via radio access in DL and UL, and connects with the core network via backbone network;
Sensing device: a device as terminal that connects to one BS or BSs and that is equipped with the sensing gadget to measure data of interest near it.

Please note that the different embodiments may be implemented separately or combined. Although a combination of features is shown in the illustrated embodiments, not all of them need to be combined to realize the benefits of various embodiments of this disclosure. In other words, a system or method designed according to an embodiment of this disclosure will not necessarily include all of the features shown in any one of the Figures or all of the portions schematically shown in the Figures. Moreover, selected features of one example embodiment may be combined with selected features of other example embodiments.

Although this disclosure has been described with reference to illustrative embodiments, this description is not intended to be construed in a limiting sense. Various modifications and combinations of the illustrative embodiments, as well as other embodiments of the disclosure, will be apparent to persons skilled in the art upon reference to the description. It is therefore intended that the appended claims encompass any such modifications or embodiments.

Although the present disclosure describes methods and processes with steps in a certain order, one or more steps of the methods and processes may be omitted or altered as appropriate. One or more steps may take place in an order other than that in which they are described, as appropriate.

Note that the expression “at least one of A or B,” as used herein, is interchangeable with the expression “A and/or B.” It refers to a list in which you may select A or B or both A and B. Similarly, “at least one of A, B, or C,” as used herein, is interchangeable with “A and/or B and/or C” or “A, B, and/or C.” It refers to a list in which you may select: A or B or C, or both A and B, or both A and C, or both B and C, or all of A, B and C. The same principle applies for longer lists having a same format.

Although the present disclosure is described, at least in part, in terms of methods, a person of ordinary skill in the art will understand that the present disclosure is also directed to the various components for performing at least some of the aspects and features of the described methods, be it by way of hardware components, software or any combination of the two. Accordingly, the technical solution of the present disclosure may be embodied in the form of a software product. A suitable software product may be stored in a pre-recorded storage device or other similar non-volatile or non-transitory computer readable storage medium, including DVDs, CD-ROMs, USB flash disk, a removable hard disk, or other storage media, for example. The software product includes instructions tangibly stored thereon that enable a processing device (e.g., a personal computer, a server, or a network device) to execute examples of the methods disclosed herein. The machine-executable instructions may be in the form of code sequences, configuration information, or other data, which, when executed, cause a machine (e.g., a processor or other processing device) to perform steps in a method according to examples of the present disclosure.

All values and sub-ranges within disclosed ranges are also disclosed. Also, although the systems, devices and processes disclosed and shown herein may include a specific number of elements/components, the systems, devices and assemblies could be modified to include additional or fewer of such elements/components. For example, although any of the elements/components disclosed may be referenced as being singular, the possible implementations disclosed herein could be modified to include a plurality of such elements/components. The subject matter described herein intends to cover and embrace all suitable changes in technology.

1. A method, comprising:
obtaining at least one first query message based on at least one first level, wherein each first query message of the at least one first query message corresponds to a corresponding level of the at least one first level; and
sending a first sensing result, wherein the first sensing result comprises at least one of: at least one piece of first sensed data or at least one first sensing semantic.

2. The method according to claim 1, wherein there is a correspondence between each level of the at least one first level and a respective first piece of query message length information, and wherein the respective first piece of query message length information comprises at least one of a first query message length or a first compression ratio of a query message.

3. The method according to claim 1, wherein each first query message of the at least one first query message corresponds to a respective task of at least one task, a respective modality of at least one modality, or a respective combination of a task and a modality of at least one combination, and each of the at least one task, each of the at least one modality, or each of the at least one combination of the task and the modality has a respective correspondence between levels and pieces of query message length information.

4. The method according to claim 1, wherein the at least one first query message comprises multiple first query messages, and first levels for at least two first query messages of the multiple first query messages are different.

5. The method according to claim 1, wherein the method further comprises:
obtaining at least one second query message based on at least one second level, wherein each second query message of the at least one second query message corresponds to one of the at least one second level, and for each of one or more second query messages of the at least one second query message, a second level is higher than a first level for a corresponding first query message in the at least one first query message; and
sending a second sensing result, wherein the second sensing result comprises at least one of: at least one piece of second sensed data or at least one second sensing semantic.

6. A method, comprising:
sending at least one first query message based on at least one first level, wherein each first query message of the at least one first query message corresponds to a corresponding level of the at least one first level; and
obtaining one or more first sensing results, wherein each sensing result of the one or more first sensing results comprises at least one of: at least one piece of first sensed data or at least one first sensing semantic.

7. The method according to claim 6, wherein there is a correspondence between each level of the at least one first level and a respective first piece of query message length information, and wherein the respective first piece of query message length information comprises at least one of a first query message length or a first compression ratio of a query message.

8. The method according to claim 6, wherein each first query message of the at least one first query message corresponds to a respective task of at least one task, a respective modality of at least one modality, or a respective combination of a task and a modality of at least one combination, and each of the at least one task, each of the at least one modality, or each of the at least one combination of the task and the modality has a respective correspondence between levels and pieces of query message length information.

9. The method according to claim 6, wherein the at least one first query message comprises multiple first query messages, and first levels for at least two first query messages of the multiple first query messages are different.

10. The method according to claim 6, wherein the method further comprises:
sending at least one second query message based on at least one second level, wherein each second query message of the at least one second query message corresponds to one of the at least one second level, and for each of one or more second query messages of the at least one second query message, a second level is higher than a first level for a corresponding first query message in the at least one first query message; and
obtaining one or more second sensing results, wherein each of the one or more second sensing results comprises at least one of: at least one piece of second sensed data or at least one second sensing semantic.

11. A first apparatus, comprising:
at least one processor coupled with a memory storing instructions that, when executed by the at least one processor, cause the first apparatus to perform operations including:
obtaining at least one first query message based on at least one first level, wherein each first query message of the at least one first query message corresponds to a corresponding level of the at least one first level; and
sending a first sensing result, wherein the first sensing result comprises at least one of: at least one piece of first sensed data or at least one first sensing semantic.

12. The first apparatus according to claim 11, wherein there is a correspondence between each level of the at least one first level and a respective first piece of query message length information, and wherein the respective first piece of query message length information comprises at least one of a first query message length or a first compression ratio of a query message.

13. The first apparatus according to claim 11, wherein each first query message of the at least one first query message corresponds to a respective task of at least one task, a respective modality of at least one modality, or a respective combination of a task and a modality of at least one combination, and each of the at least one task, each of the at least one modality, or each of the at least one combination of the task and the modality has a respective correspondence between levels and pieces of query message length information.

14. The first apparatus according to claim 11, wherein the at least one first query message comprises multiple first query messages, and first levels for at least two first query messages of the multiple first query messages are different.

15. The first apparatus according to claim 11, the operations further comprising:
obtaining at least one second query message based on at least one second level, wherein each second query message of the at least one second query message corresponds to one of the at least one second level, and for each of one or more second query messages of the at least one second query message, a second level is higher than a first level for a corresponding first query message in the at least one first query message; and
sending a second sensing result, wherein the second sensing result comprises at least one of: at least one piece of second sensed data or at least one second sensing semantic.

16. A second apparatus, comprising:
at least one processor coupled with a memory storing instructions that, when executed by the at least one processor, cause the second apparatus to perform operations including:
sending at least one first query message based on at least one first level, wherein each first query message of the at least one first query message corresponds to a corresponding level of the at least one first level; and
obtaining one or more first sensing results, wherein each sensing result of the one or more first sensing results comprises at least one of: at least one piece of first sensed data or at least one first sensing semantic.

17. The second apparatus according to claim 16, wherein there is a correspondence between each level of the at least one first level and a respective first piece of query message length information, and wherein the respective first piece of query message length information comprises at least one of a first query message length or a first compression ratio of a query message.

18. The second apparatus according to claim 16, wherein each first query message of the at least one first query message corresponds to a respective task of at least one task, a respective modality of at least one modality, or a respective combination of a task and a modality of at least one combination, and each of the at least one task, each of the at least one modality, or each of the at least one combination of the task and the modality has a respective correspondence between levels and pieces of query message length information.

19. The second apparatus according to claim 16, wherein the at least one first query message comprises multiple first query messages, and first levels for at least two first query messages of the multiple first query messages are different.

20. The second apparatus according to claim 16, the operations further comprising:
sending at least one second query message based on at least one second level, wherein each second query message of the at least one second query message corresponds to one of the at least one second level, and for each of one or more second query messages of the at least one second query message, a second level is higher than a first level for a corresponding first query message in the at least one first query message; and
obtaining one or more second sensing results, wherein each of the one or more second sensing results comprises at least one of: at least one piece of second sensed data or at least one second sensing semantic.
